(19) United States
(12) Patent Application Publication
(10) Pub. No.: US 2026/0329059 A1
(43) Pub. Date: Oct. 22, 2026

(54) VARIABLE MAGNIFICATION OPTICAL SYSTEM AND IMAGING APPARATUS

(71) Applicant: FUJIFILM Corporation, Tokyo (JP)

(72) Inventor: Masato KONDO, Saitama (JP)

(73) Assignee: FUJIFILM Corporation, Tokyo (JP)

(21) Appl. No.: 19/642,969

(22) Filed: Apr. 9, 2026

(30) Foreign Application Priority Data
Apr. 16, 2025 (JP) 2025-067546

(51) Int. Cl. G02B 15/14

(52) U.S. Cl. CPC G02B 15/144107

(57) ABSTRACT

A variable magnification optical system consists of, in order from an object side to an image side, a first lens group having a positive refractive power, a front group consisting of two or fewer lens groups having a negative refractive power, an intermediate group including a plurality of lens groups, and a final lens group. A lens group closest to the object side in the intermediate group is a first intermediate lens group having a positive refractive power. The intermediate group includes an aperture stop. In a case where a focal length of the front group in a state where an infinite distance object is in focus at a wide angle end is denoted by fF, and a focal length of the first lens group is denoted by f1, the variable magnification optical system satisfies 0.04<(−fF)/f1<0.4.

### CROSS-REFERENCE TO RELATED APPLICATIONS

This application claims priority from Japanese Patent Application No. 2025-067546, filed on Apr. 16, 2025, the entire disclosure of which is incorporated herein by reference.

### BACKGROUND

### Technical Field

The technology of the present disclosure relates to a variable magnification optical system and an imaging apparatus.

### Related Art

In the related art, a zoom lens described in JP2017-078770A has been suggested as an optical system applicable to an imaging apparatus such as a digital camera and a television camera.

### SUMMARY

A variable magnification optical system that is configured to have a small size and that maintains favorable optical performance throughout an entire magnification range is desired. The levels of these requirements have been increasing year by year.

The present disclosure provides a variable magnification optical system that is configured to have a small size and that maintains favorable optical performance throughout an entire magnification range, and an imaging apparatus comprising the variable magnification optical system.

According to an aspect of the present disclosure, there is provided a variable magnification optical system consisting of, in order from a position closest to an object side to an image side, a first lens group having a positive refractive power, a front group consisting of two or fewer lens groups having a negative refractive power, an intermediate group including a plurality of lens groups, and a final lens group, in which a lens group closest to the object side in the intermediate group is a first intermediate lens group having a positive refractive power, the intermediate group includes an aperture stop, during changing magnification, all spacings between adjacent lens groups change, and

Conditional Expression (1) is satisfied, which is represented by 0.04<(−fF)/f1<0.4 (1).

Here, a focal length of the front group in a state where an infinite distance object is in focus at a wide angle end is denoted by fF, and a focal length of the first lens group is denoted by f1.

In the variable magnification optical system according to the above-described aspect, it is preferable that in a case where a focal length of the first intermediate lens group is denoted by fM1,

Conditional Expression (2) is satisfied, which is represented by 0.1<fM1/f1<0.8 (2).

In the variable magnification optical system according to the above-described aspect, it is preferable that in a case where a focal length of the variable magnification optical system in a state where the infinite distance object is in focus at the wide angle end is denoted by fw,

Conditional Expression (3) is satisfied, which is represented by 0.05<fw/f1<0.5 (3).

In the variable magnification optical system according to the above-described aspect, it is preferable that in a case where a focal length of the variable magnification optical system in a state where the infinite distance object is in focus at the wide angle end is denoted by fw,

Conditional Expression (4) is satisfied, which is represented by 0.4<fw/(−fF)<2 (4).

In the variable magnification optical system according to the aspect, in a configuration in which the intermediate group includes at least one lens group having a negative refractive power, and in a case where a focal length of the variable magnification optical system in a state where the infinite distance object is in focus at the wide angle end is denoted by fw, and a focal length of a lens group closest to the image side among the lens groups having a negative refractive power included in the intermediate group is denoted by fMn,

Conditional Expression (5) is satisfied, which is represented by 0.05<fw/(−fMn)<1.5 (5).

It is preferable that the number of lenses included in the variable magnification optical system according to the aspect is 13 or more and 17 or less.

It is preferable that in a case where a refractive index of a positive lens of the first lens group at a d line is denoted by Nd1p,

Conditional Expression (6) is satisfied, which is represented by 1.4<Nd1p<1.62 (6),

by all positive lenses of the first lens group.

In the variable magnification optical system according to the aspect, in a configuration in which the intermediate group includes at least one lens group having a negative refractive power, and in a case where a focal length of a lens group closest to the image side among lens groups having a negative refractive power included in the intermediate group is denoted by fMn,

Conditional Expression (7) is satisfied, which is represented by 0.1<(−fF)/(−fMn)<2 (7).

In the variable magnification optical system according to the aspect, in a case where a focal length of the variable magnification optical system in a state where the infinite distance object is in focus at a telephoto end is denoted by ft, and a focal length of the variable magnification optical system in a state where the infinite distance object is in focus at the wide angle end is denoted by fw,

Conditional Expression (8) is satisfied, which is represented by 2<ft/fw<20 (8).

In the variable magnification optical system according to the above-described aspect, it is preferable that in a case where a focal length of the first intermediate lens group is denoted by fM1,

Conditional Expression (9) is satisfied, which is represented by 0.05<(−fF)/fM1<2 (9).

In the variable magnification optical system according to the above-described aspect, it is preferable that in a case where a focal length of the variable magnification optical system in a state where the infinite distance object is in focus at the wide angle end is denoted by fw, and a focal length of the final lens group is denoted by fE,

Conditional Expression (10) is satisfied, which is represented by −1.5<fw/fE<1.5 (10).

At least one lens group included in the intermediate group and the final lens group may be configured to move along the same trajectory along the optical axis during changing magnification from the wide angle end to a telephoto end, and the lens groups moving along the same trajectory may not configured to be arranged adjacent to each other.

Two lens groups included in the intermediate group and the final lens group may be configured to move along the same trajectory along the optical axis during changing magnification from the wide angle end to the telephoto end, and the lens groups moving along the same trajectory may not configured to be arranged adjacent to each other.

A second intermediate lens group having a positive refractive power may be configured to be arranged adjacent to the image side of the first intermediate lens group in the intermediate group. With such a configuration, in the variable magnification optical system according to the above-described aspect, it is preferable that in a case where a focal length of the first intermediate lens group is denoted by fM1, and a focal length of the second intermediate lens group is denoted by fM2p,

Conditional Expression (11) is satisfied, which is represented by 0.1<fM1/fM2p<4 (11).

A third intermediate lens group having a positive refractive power may be configured to be arranged adjacent to the image side of the second intermediate lens group having a positive refractive power in the intermediate group. With such a configuration, in the variable magnification optical system according to the above-described aspect, it is preferable that in a case where a focal length of the second intermediate lens group is denoted by fM2p, and a focal length of the third intermediate lens group is denoted by fM3p,

Conditional Expression (12) is satisfied, which is represented by 1<fM2p/fM3p<15 (12).

A third intermediate lens group having a negative refractive power may be configured to be arranged adjacent to the image side of the second intermediate lens group having a positive refractive power in the intermediate group. With such a configuration, in the variable magnification optical system according to the above-described aspect, it is preferable that in a case where the focal length of the second intermediate lens group is denoted by fM2p, and a focal length of the third intermediate lens group is denoted by fM3n,

Conditional Expression (13) is satisfied, which is represented by 0.1<fM2p/(−fM3n)<1 (13).

A second intermediate lens group having a negative refractive power may be configured to be arranged adjacent to the image side of the first intermediate lens group in the intermediate group. With such a configuration, in the variable magnification optical system according to the above-described aspect, it is preferable that in a case where a focal length of the first intermediate lens group is denoted by fM1, and a focal length of the second intermediate lens group is denoted by fM2n,

Conditional Expression (14) is satisfied, which is represented by 0.1<fM1/(−fM2n)<2 (14).

A third intermediate lens group having a positive refractive power may be configured to be arranged adjacent to the image side of the second intermediate lens group having a negative refractive power in the intermediate group. With such a configuration, in the variable magnification optical system according to the above-described aspect, it is preferable that in a case where the focal length of the second intermediate lens group is denoted by fM2n, and a focal length of the third intermediate lens group is denoted by fM3p,

Conditional Expression (15) is satisfied, which is represented by 1<(−fM2n)/fM3p<15 (15).

A third intermediate lens group having a negative refractive power may be configured to be arranged adjacent to the image side of the second intermediate lens group having a negative refractive power in the intermediate group. With such a configuration, it is preferable that in a case where the focal length of the second intermediate lens group is denoted by fM2n, and a focal length of the third intermediate lens group is denoted by fM3n,

Conditional Expression (16) is satisfied, which is represented by 0.3<(−fM2n)/(−fM3n)<3 (16).

According to another aspect of the present disclosure, there is provided an imaging apparatus comprising the variable magnification optical system according to the above-described aspect.

It should be noted that the terms “consisting of” and “consists of” in the present specification mean that the lens may include not only the above-mentioned elements but also lenses substantially having no refractive powers, optical elements, which are not lenses, such as a stop, a filter, and a cover glass, and mechanism parts such as a lens flange, a lens barrel, an imaging element, and a camera shaking correction mechanism.

The expression “ . . . group having positive refractive power” in the present specification means that the group has a positive refractive power as a whole. Similarly, the expression “ . . . group having a negative refractive power” means that the group has a negative refractive power as a whole. The expressions “lens having positive refractive power” and “positive lens” are synonymous. The expressions “lens having negative refractive power” and “negative lens” are synonymous. The expression “ . . . group” in the present specification is not limited to a configuration consisting of a plurality of lenses, and may have a configuration consisting of only one lens.

The number of lenses in the present specification is the number of lenses that are components. For example, it is assumed that the number of lenses in a cemented lens in which a plurality of single lenses made of different materials are cemented is represented by the number of single lenses constituting the cemented lens. Here, a compound aspherical lens (a lens (for example, a spherical lens) and a film of an aspherical shape formed on the lens are integrally formed, and the lens functions as one aspherical lens as a whole) is not regarded as a cemented lens, but the compound aspherical lens is regarded as one lens. The sign of the refractive power, and the surface shape of the lens including the aspherical surface will be used in terms of the paraxial region unless otherwise specified.

The term “focal length” used in the conditional expressions means a paraxial focal length. Unless otherwise specified, values used in the conditional expressions are values based on the d line in the state where the infinite distance object is in focus.

According to the present disclosure, it is possible to provide a variable magnification optical system that is configured to have a small size and that maintains favorable optical performance throughout an entire magnification range, and an imaging apparatus comprising the variable magnification optical system.

### BRIEF DESCRIPTION OF THE DRAWINGS

FIG. 1 is a diagram showing a cross-sectional view of a configuration and a movement trajectory of a variable magnification optical system according to one embodiment, which corresponds to a variable magnification optical system according to Example 1.

FIG. 2 is a cross-sectional view of a configuration of the variable magnification optical system of FIG. 1 at a wide angle end.

FIG. 3 is each aberration diagram of the variable magnification optical system according to Example 1.

FIG. 4 is a diagram showing a cross-sectional view of a configuration and a movement trajectory of a variable magnification optical system according to Example 2.

FIG. 5 is each aberration diagram of the variable magnification optical system according to Example 2.

FIG. 6 is a diagram showing a cross-sectional view of a configuration and a movement trajectory of a variable magnification optical system according to Example 3.

FIG. 7 is each aberration diagram of the variable magnification optical system according to Example 3.

FIG. 8 is a diagram showing a cross-sectional view of a configuration and a movement trajectory of a variable magnification optical system according to Example 4.

FIG. 9 is each aberration diagram of the variable magnification optical system according to Example 4.

FIG. 10 is a diagram showing a cross-sectional view of a configuration and a movement trajectory of a variable magnification optical system according to Example 5.

FIG. 11 is each aberration diagram of the variable magnification optical system according to Example 5.

FIG. 12 is a diagram showing a cross-sectional view of a configuration and a movement trajectory of a variable magnification optical system according to Example 6.

FIG. 13 is each aberration diagram of the variable magnification optical system according to Example 6.

FIG. 14 is a diagram showing a cross-sectional view of a configuration and a movement trajectory of a variable magnification optical system according to Example 7.

FIG. 15 is each aberration diagram of the variable magnification optical system according to Example 7.

FIG. 16 is a diagram showing a cross-sectional view of a configuration and a movement trajectory of a variable magnification optical system according to Example 8.

FIG. 17 is each aberration diagram of the variable magnification optical system according to Example 8.

FIG. 18 is a diagram showing a cross-sectional view of a configuration and a movement trajectory of a variable magnification optical system according to Example 9.

FIG. 19 is each aberration diagram of the variable magnification optical system according to Example 9.

FIG. 20 is a diagram showing a cross-sectional view of a configuration and a movement trajectory of a variable magnification optical system according to Example 10.

FIG. 21 is each aberration diagram of the variable magnification optical system according to Example 10.

FIG. 22 is a diagram showing a cross-sectional view of a configuration and a movement trajectory of a variable magnification optical system according to Example 11.

FIG. 23 is each aberration diagram of the variable magnification optical system according to Example 11.

FIG. 24 is a diagram showing a cross-sectional view of a configuration and a movement trajectory of a variable magnification optical system according to Example 12.

FIG. 25 is each aberration diagram of the variable magnification optical system according to Example 12.

FIG. 26 is a diagram showing a cross-sectional view of a configuration and a movement trajectory of a variable magnification optical system according to Example 13.

FIG. 27 is each aberration diagram of the variable magnification optical system according to Example 13.

FIG. 28 is a diagram showing a cross-sectional view of a configuration and a movement trajectory of a variable magnification optical system according to Example 14.

FIG. 29 is each aberration diagram of the variable magnification optical system according to Example 14.

FIG. 30 is a diagram showing a cross-sectional view of a configuration and a movement trajectory of a variable magnification optical system according to Example 15.

FIG. 31 is each aberration diagram of the variable magnification optical system according to Example 15.

FIG. 32 is a diagram showing a cross-sectional view of a configuration and a movement trajectory of a variable magnification optical system according to Example 16.

FIG. 33 is each aberration diagram of the variable magnification optical system according to Example 16.

FIG. 34 is a diagram showing a cross-sectional view of a configuration and a movement trajectory of a variable magnification optical system according to Example 17.

FIG. 35 is each aberration diagram of the variable magnification optical system according to Example 17.

FIG. 36 is a diagram showing a cross-sectional view of a configuration and a movement trajectory of a variable magnification optical system according to Example 18.

FIG. 37 is each aberration diagram of the variable magnification optical system according to Example 18.

FIG. 38 is a diagram showing a cross-sectional view of a configuration and a movement trajectory of a variable magnification optical system according to Example 19.

FIG. 39 is each aberration diagram of the variable magnification optical system according to Example 19.

FIG. 40 is a diagram showing a cross-sectional view of a configuration and a movement trajectory of a variable magnification optical system according to Example 20.

FIG. 41 is each aberration diagram of the variable magnification optical system according to Example 20.

FIG. 42 is a diagram showing a cross-sectional view of a configuration and a movement trajectory of a variable magnification optical system according to Example 21.

FIG. 43 is each aberration diagram of the variable magnification optical system according to Example 21.

FIG. 44 is a diagram showing a cross-sectional view of a configuration and a movement trajectory of a variable magnification optical system according to Example 22.

FIG. 45 is each aberration diagram of the variable magnification optical system according to Example 22.

FIG. 46 is a diagram showing a cross-sectional view of a configuration and a movement trajectory of a variable magnification optical system according to Example 23.

FIG. 47 is each aberration diagram of the variable magnification optical system according to Example 23.

FIG. 48 is a diagram showing a cross-sectional view of a configuration and a movement trajectory of a variable magnification optical system according to Example 24.

FIG. 49 is each aberration diagram of the variable magnification optical system according to Example 24.

FIG. 50 is a perspective view of a front surface side of an imaging apparatus according to one embodiment.

FIG. 51 is a perspective view of a rear surface side of the imaging apparatus according to one embodiment.

### DETAILED DESCRIPTION

Hereinafter, an embodiment of the present disclosure will be described with reference to the drawings.

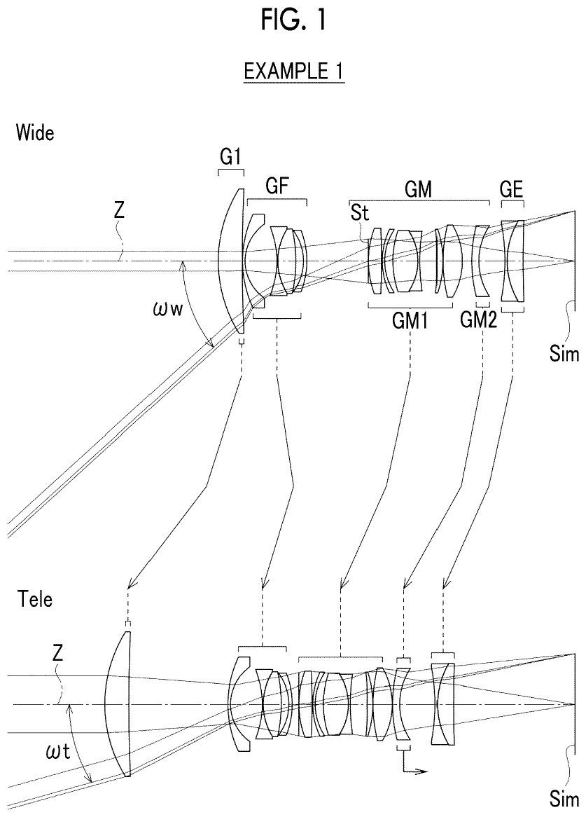

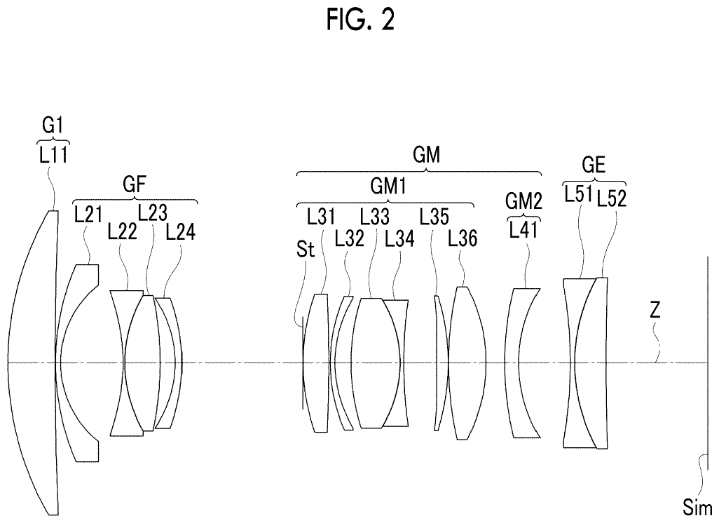

FIG. 1 shows a cross-sectional view of a configuration and luminous fluxes of a variable magnification optical system according to one embodiment of the present disclosure and a movement trajectory. FIG. 1 shows a wide angle end state in an upper part labeled “Wide”, and a telephoto end state in a lower part labeled “Tele”. As the luminous fluxes, FIG. 1 shows an on-axis luminous flux and a luminous flux having a maximum half angle of view ow at the wide angle end and an on-axis luminous flux and a luminous flux having a maximum half angle of view ωt at the telephoto end. FIG. 2 shows a cross-sectional view of the configuration at the wide angle end of the variable magnification optical system in FIG. 1. FIGS. 1 and 2 show a state where the infinite distance object is in focus, the left side thereof is an object side, and the right side thereof is an image side. The examples shown in FIGS. 1 and 2 correspond to a variable magnification optical system according to Example 1 described below. The following description will be mainly provided with reference to FIG. 1, and FIG. 2 will be referred to, as necessary.

The variable magnification optical system according to the embodiment of the present disclosure consists of, in order from a position closest to the object side to the image side along an optical axis Z, a first lens group G1 having a positive refractive power, a front group GF consisting of two or fewer lens groups having a negative refractive power, an intermediate group GM including a plurality of lens groups, and a final lens group GE. A lens group closest to the object side in the intermediate group GM is a first intermediate lens group GM1 having a positive refractive power. The intermediate group GM includes an aperture stop St. During changing magnification, all spacings between adjacent lens groups change. With the above-described configuration, it is advantageous for favorably correcting various aberrations throughout the entire magnification range while achieving reduction in size.

In the present specification, a group, in which a spacing between the group and an adjacent group thereof changes in the optical axis direction during changing magnification, is set as one lens group. During changing magnification, a spacing between adjacent lenses does not change in one lens group. That is, the term “lens group” means a portion that constitutes the variable magnification optical system and that includes at least one lens divided by an air spacing that is changed during changing magnification. During changing magnification, each lens group is moved or fixed in lens group units. The term “lens group” may include a constituent having no refractive power other than a lens, for example, an aperture stop St.

For example, each group of the variable magnification optical system of FIG. 1 is configured as follows as shown in a detailed configuration thereof in FIG. 2. The first lens group G1 consists of one lens, that is, a lens L11. The front group GF consists of one lens group. The lens group constituting the front group GF consists of four lenses L21 to L24 in order from the object side to the image side. The intermediate group GM consists of, in order from the object side to the image side, two lens groups including a first intermediate lens group GM1 and a second intermediate lens group GM2. The first intermediate lens group GM1 consists of the aperture stop St and six lenses L31 to L36 in order from the object side to the image side. The second intermediate lens group GM2 consists of one lens, that is, a lens L41. The final lens group GE consists of two lenses L51 and L52 in order from the object side to the image side. The aperture stop St shown in FIGS. 1 and 2 does not show the size or the shape thereof, but shows a position thereof in the optical axis direction.

In the example of FIG. 1, during changing magnification, all the lens groups move along the optical axis Z by changing the spacings between the adjacent lens groups. In FIG. 1, a solid line arrow indicates a schematic movement trajectory during changing magnification from the wide angle end to the telephoto end for each lens group that moves during changing magnification between the upper part and the lower part.

In addition, in the example of FIG. 1, the first intermediate lens group GM1 and the final lens group GE move along the same trajectory along the optical axis Z during changing magnification from the wide angle end to the telephoto end. As described above, in the variable magnification optical system according to the embodiment of the present disclosure, at least one lens group included in the intermediate group GM and the final lens group GE may be configured to move along the same trajectory along the optical axis Z during changing magnification from the wide angle end to the telephoto end. By configuring a plurality of lens groups to move along the same trajectory during changing magnification, a moving mechanism can be simplified. In a more preferable configuration, two lens groups included in the intermediate group GM and the final lens group GE move along the same trajectory along the optical axis Z during changing magnification from the wide angle end to the telephoto end. In such a case, the configuration is advantageous in further simplifying the moving mechanism. The lens groups that move along the same trajectory are not arranged adjacent to each other. In addition, the term “same” includes an error allowed in the technical field.

The first lens group G1 may be configured to consist of one lens or one cemented lens. In such a case, it is advantageous for the reduction in size.

The intermediate group GM may be configured to include at least one lens group having a negative refractive power. The inclusion of at least one lens group having a negative refractive power in the intermediate group GM, in addition to the first intermediate lens group GM1 having a positive refractive power, is advantageous for favorably correcting various aberrations throughout the entire magnification range.

The final lens group GE may be configured to consist of one cemented lens or one lens. In such a case, it is advantageous for the reduction in size.

The disclosed technology may be configured such that at least one focusing group that moves during focusing is disposed in the variable magnification optical system. For example, at least one focusing group may be disposed in the intermediate group GM. By disposing the focusing group in the intermediate group GM having a relatively low ray height, it is advantageous for reducing the size and weight of the focusing group. More specifically, a lens group closest to the image side among the lens groups having a negative refractive power in the intermediate group GM may be configured as the focusing group. In such a case, it is advantageous for suppressing focus breathing. The focusing group may be configured to consist of one lens. In such a case, it is advantageous for reducing the size and weight of the focusing group.

In the example of FIG. 1, the focusing group consists of the second intermediate lens group GM2. The parentheses and the rightward arrow provided to the second intermediate lens group GM2 in the lower part of FIG. 1 indicate that the lens group is the focusing group and indicate a direction in which the focusing group moves during the focusing from the infinite distance object to a nearest object. The focusing group functions throughout the entire magnification range including the wide angle end state, but in FIG. 1, the arrows are noted only in the lower part of the drawing in order to avoid complication of the drawing. The above-described method of showing the focusing group is also applied to the drawings of other examples.

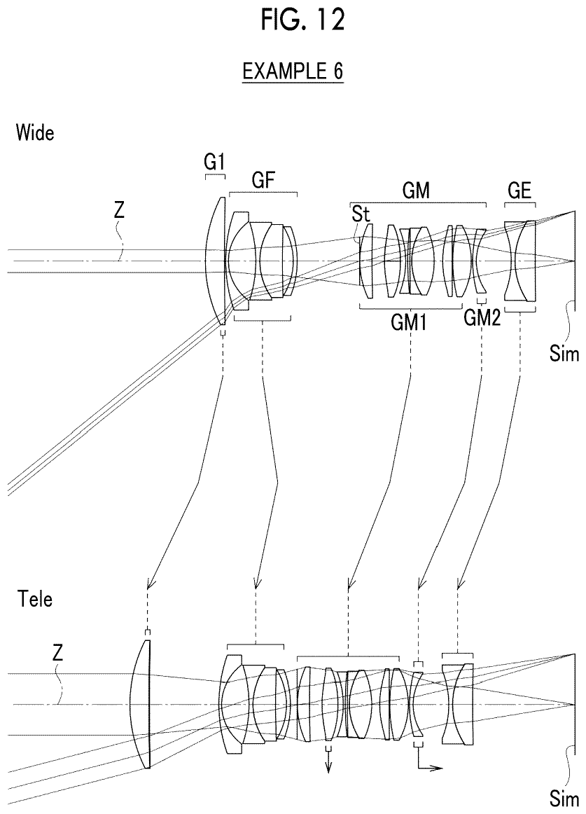

Further, in the disclosed technology, as in Example 6 described below shown in FIG. 12, an anti-vibration group that moves in a direction intersecting with the optical axis Z during image shake correction may be disposed in the variable magnification optical system. In this case, the anti-vibration group may be disposed in the intermediate group GM. By disposing the anti-vibration group in the intermediate group GM having a relatively low ray height, it is advantageous for reducing the size and weight of the anti-vibration group.

In the example of FIG. 12, the anti-vibration group consists of a second lens from the object side in the first intermediate lens group GM1. A downward arrow provided to the lens in the lower part of FIG. 12 indicates that the lens is the anti-vibration group. The anti-vibration group functions throughout the entire magnification range including the wide angle end state, but in FIG. 12, the arrows are noted only in the lower part to avoid complication of the drawing. The above-described method of showing the anti-vibration group is also applied to the drawings of other examples.

In the disclosed technology, the number of lenses included in the variable magnification optical system may be 13 or more and 17 or less. In such a case, it is advantageous for both correcting of various aberrations and reducing the size.

Next, preferable configurations and available configurations related to conditional expressions of the variable magnification optical system according to the embodiment of the present disclosure will be described. In the description of the following conditional expressions, in order to avoid redundant description, the same symbols will be used for terms having the same definition and repeated description of the symbols will be partially omitted. Hereinafter, the “variable magnification optical system according to the embodiment of the present disclosure” will be simply referred to as the “variable magnification optical system” in order to avoid redundant description.

It is preferable that the variable magnification optical system satisfies Conditional Expression (1). Here, a focal length of the front group GF in a state where the infinite distance object is in focus at the wide angle end is denoted by fF. A focal length of the first lens group G1 is denoted by f1. By not allowing a corresponding value of Conditional Expression (1) to be equal to or less than the lower limit value, the refractive power of the first lens group G1 can be increased. As a result, it is advantageous for reducing the optical total length. By not allowing the corresponding value of Conditional Expression (1) to be equal to or greater than the upper limit value, it is advantageous for maintaining the variable magnification effect of the front group GF. In addition, since the amount of movement of the front group GF during changing magnification can be reduced, it is advantageous for size reduction.

0.04<(−fF)/f1<0.4 (1)

In order to obtain more favorable characteristics, the lower limit value of Conditional Expression (1) is more preferably 0.08, still more preferably 0.1, still more preferably 0.12, still more preferably 0.125, still more preferably 0.13, still more preferably 0.135, still more preferably 0.14, and still more preferably 0.143. In order to obtain more favorable characteristics, the upper limit value of Conditional Expression (1) is more preferably 0.35, still more preferably 0.3, still more preferably 0.28, still more preferably 0.26, still more preferably 0.24, still more preferably 0.22, still more preferably 0.2, and still more preferably 0.19.

It is preferable that the variable magnification optical system satisfies Conditional Expression (2). Here, a focal length of the first intermediate lens group GM1 is denoted by fM1. By not allowing a corresponding value of Conditional Expression (2) to be equal to or less than lower limit value, the refractive power of the first lens group G1 is not excessively weakened. As a result, it is advantageous for reducing the optical total length. By not allowing the corresponding value of Conditional Expression (2) to be equal to or greater than the upper limit value, the refractive power of the first lens group G1 is not excessively increased. As a result, it is advantageous for suppressing fluctuations of the aberrations during changing magnification.

0.1<fM1/f1<0.8 (2)

In order to obtain more favorable characteristics, the lower limit value of Conditional Expression (2) is more preferably 0.12, still more preferably 0.14, still more preferably 0.17, still more preferably 0.2, still more preferably 0.22, still more preferably 0.24, still more preferably 0.26, and still more preferably 0.28. In order to obtain more favorable characteristics, the upper limit value of Conditional Expression (2) is more preferably 0.6, still more preferably 0.5, still more preferably 0.45, still more preferably 0.4, still more preferably 0.39, still more preferably 0.38, still more preferably 0.37, and still more preferably 0.36.

It is preferable that the variable magnification optical system satisfies Conditional Expression (3). Here, a focal length of the variable magnification optical system in a state where the infinite distance object is in focus at the wide angle end is denoted by fw. By not allowing a corresponding value of Conditional Expression (3) to be equal to or less than the lower limit value, the refractive power of the first lens group G1 is not excessively weakened. As a result, it is advantageous for reducing the optical total length. By not allowing the corresponding value of Conditional Expression (3) to be equal to or greater than the upper limit value, it is advantageous for ensuring the angle of view at the wide angle end.

0.05<fw/f1<0.5 (3)

In order to obtain more favorable characteristics, the lower limit value of Conditional Expression (3) is more preferably 0.08, still more preferably 0.1, still more preferably 0.11, still more preferably 0.115, still more preferably 0.118, still more preferably 0.12, still more preferably 0.122, and still more preferably 0.124. In order to obtain more favorable characteristics, the upper limit value of Conditional Expression (3) is more preferably 0.4, still more preferably 0.35, still more preferably 0.3, still more preferably 0.26, still more preferably 0.24, still more preferably 0.22, still more preferably 0.21, and still more preferably 0.205.

It is preferable that the variable magnification optical system satisfies Conditional Expression (4). By not allowing a corresponding value of Conditional Expression (4) to be equal to or less than the lower limit value, it is advantageous for increasing the zoom ratio. By not allowing the corresponding value of Conditional Expression (4) to be equal to or greater than the upper limit value, it is advantageous for suppressing the field curvature.

0.4<fw/(−fF)<2 (4)

In order to obtain more favorable characteristics, the lower limit value of Conditional Expression (4) is more preferably 0.6, still more preferably 0.7, still more preferably 0.75, still more preferably 0.8, still more preferably 0.85, still more preferably 0.875, still more preferably 0.9, and still more preferably 0.92. In order to obtain more favorable characteristics, the upper limit value of Conditional Expression (4) is more preferably 1.8, still more preferably 1.6, still more preferably 1.4, still more preferably 1.3, still more preferably 1.25, still more preferably 1.2, still more preferably 1.16, and still more preferably 1.13.

It is preferable that the variable magnification optical system satisfies Conditional Expression (9). By not allowing a corresponding value of Conditional Expression (9) to be equal to or less than the lower limit value, the negative refractive power of the front group GF is not excessively increased. As a result, it is advantageous for suppressing fluctuations of the spherical aberration during changing magnification. By not allowing the corresponding value of Conditional Expression (9) to be equal to or greater than the upper limit value, it is advantageous for suppressing fluctuations of the distortion during changing magnification.

0.05<(−fF)/fM1<2 (9)

In order to obtain more favorable characteristics, the lower limit value of Conditional Expression (9) is more preferably 0.1, still more preferably 0.15, still more preferably 0.2, still more preferably 0.25, still more preferably 0.3, still more preferably 0.33, still more preferably 0.35, and still more preferably 0.37. In order to obtain more favorable characteristics, the upper limit value of Conditional Expression (9) is more preferably 1.6, still more preferably 1.2, still more preferably 1, still more preferably 0.9, still more preferably 0.8, still more preferably 0.7, still more preferably 0.6, and still more preferably 0.5.

It is preferable that the variable magnification optical system satisfies Conditional Expression (10). Here, a focal length of the final lens group GE is denoted by fE. By not allowing a corresponding value of Conditional Expression (10) to be equal to or less than the lower limit value in a range where the corresponding value is negative, the reduction of the optical total length at the wide angle end is facilitated. As a result, it is advantageous for size reduction. By not allowing the corresponding value of Conditional Expression (10) to be equal to or greater than the upper limit value in a range where the corresponding value is positive, it is advantageous for suppressing the spherical aberration at the wide angle end.

−1.5<fw/fE<1.5 (10)

In order to obtain more favorable characteristics, the lower limit value of Conditional Expression (10) is more preferably −1, still more preferably −0.8, still more preferably −0.6, still more preferably −0.4, still more preferably −0.3, still more preferably −0.2, still more preferably −0.13, and still more preferably −0.09. In order to obtain more favorable characteristics, the upper limit value of Conditional Expression (10) is more preferably 1, still more preferably 0.8, still more preferably 0.6, still more preferably 0.4, still more preferably 0.3, still more preferably 0.2, still more preferably 0.13, and still more preferably 0.09.

In a configuration where the intermediate group GM includes at least one lens group having a negative refractive power, it is preferable that the variable magnification optical system satisfies Conditional Expression (5). Here, a focal length of a lens group closest to the image side among the lens groups having a negative refractive power included in the intermediate group GM is denoted by fMn. By not allowing a corresponding value of Conditional Expression (5) to be equal to or less than the lower limit value, the refractive power of the lens group closest to the image side among the lens groups having a negative refractive power in the intermediate group GM is not excessively weakened. As a result, the amount of movement during changing magnification can be suppressed. Accordingly, since the optical total length is not excessively increased, it is advantageous for size reduction. By not allowing the corresponding value of Conditional Expression (5) to be equal to or greater than the upper limit value, the refractive power of the lens group closest to the image side among the lens groups having a negative refractive power in the intermediate group GM is not excessively increased. As a result, it is advantageous for suppressing an excessive increase in the diameter of the on-axis luminous flux, particularly at the telephoto end.

0.05<fw/(−fMn)<1.5 (5)

In order to obtain more favorable characteristics, the lower limit value of Conditional Expression (5) is more preferably 0.12, still more preferably 0.15, still more preferably 0.18, still more preferably 0.2, still more preferably 0.22, still more preferably 0.24, still more preferably 0.27, and still more preferably 0.3. In order to obtain more favorable characteristics, the upper limit value of Conditional Expression (5) is more preferably 0.9, still more preferably 0.5, still more preferably 0.49, still more preferably 0.48, still more preferably 0.47, still more preferably 0.46, still more preferably 0.45, and still more preferably 0.44.

In a configuration where the intermediate group GM includes at least one lens group having a negative refractive power, it is preferable that the variable magnification optical system satisfies Conditional Expression (7). By not allowing a corresponding value of Conditional Expression (7) to be equal to or less than the lower limit value, the refractive power of the lens group closest to the image side among the lens groups having a negative refractive power in the intermediate group GM is not excessively weakened. As a result, the amount of movement during changing magnification can be suppressed. Accordingly, since the optical total length is not excessively increased, it is advantageous for size reduction. By not allowing the corresponding value of Conditional Expression (7) to be equal to or greater than the upper limit value, it is advantageous for maintaining the variable magnification effect of the front group GF. In addition, since the amount of movement of the front group GF during changing magnification can be reduced, it is advantageous for size reduction.

0.1<(−fF)/(−fMn)<2 (7)

In order to obtain more favorable characteristics, the lower limit value of Conditional Expression (7) is more preferably 0.15, still more preferably 0.2, still more preferably 0.24, still more preferably 0.27, still more preferably 0.3, still more preferably 0.31, still more preferably 0.32, and still more preferably 0.33. In order to obtain more favorable characteristics, the upper limit value of Conditional Expression (7) is more preferably 1.5, still more preferably 1, still more preferably 0.8, still more preferably 0.6, still more preferably 0.55, still more preferably 0.5, still more preferably 0.48, and still more preferably 0.45.

In a configuration where the intermediate group GM includes at least one lens group having a negative refractive power, it is preferable that the variable magnification optical system satisfies Conditional Expression (18). By not allowing a corresponding value of Conditional Expression (18) to be equal to or less than the lower limit value, the refractive power of the first lens group G1 is not excessively weakened. As a result, it is advantageous for reducing the optical total length. By not allowing the corresponding value of Conditional Expression (18) to be equal to or greater than the upper limit value, the refractive power of the first lens group G1 is not excessively increased. As a result, preventing excessive correction of the spherical aberration at the telephoto end is facilitated.

0.1<(−fMn)/f1<1.5 (18)

In order to obtain more favorable characteristics, the lower limit value of Conditional Expression (18) is more preferably 0.14, still more preferably 0.17, still more preferably 0.2, still more preferably 0.22, still more preferably 0.24, still more preferably 0.26, still more preferably 0.28, and still more preferably 0.3. In order to obtain more favorable characteristics, the upper limit value of Conditional Expression (18) is more preferably 1, still more preferably 0.8, still more preferably 0.75, still more preferably 0.7, still more preferably 0.65, still more preferably 0.6, still more preferably 0.55, and still more preferably 0.5.

It is preferable that the intermediate group GM includes at least one lens satisfying Conditional Expressions (24) and (25). Here, a refractive index with respect to a d line for the lens included in the intermediate group GM is denoted by NdM. An Abbe number based on the d line for the lens included in the intermediate group GM is denoted by νdM.

1.8<NdM+0.01×νdM<2.14 (24)

49<νdM<59 (25)

By not allowing a corresponding value of Conditional Expression (24) to be equal to or less than the lower limit value, a material other than a material having a low refractive index and a small Abbe number can be selected. As a result, the correction of a lateral chromatic aberration is facilitated. By not allowing the corresponding value of Conditional Expression (24) to be equal to or greater than the upper limit value, a material other than a material having a high refractive index and a large Abbe number can be selected. As a result, a material having a specific gravity that is not large can be selected and reduction in weight is facilitated.

In order to obtain more favorable characteristics, the lower limit value of Conditional Expression (24) is more preferably 1.85, still more preferably 1.9, and still more preferably 1.95. In order to obtain more favorable characteristics, the upper limit value of Conditional Expression (24) is more preferably 2.13, still more preferably 2.12, and still more preferably 2.11.

By not allowing the corresponding value of Conditional Expression (25) to be equal to or less than the lower limit value, it is advantageous for suppressing chromatic aberration. By not allowing the corresponding value of Conditional Expression (25) to be equal to or greater than the upper limit value, a material that is easily obtainable can be used. As a result, it is advantageous for implementing a variable magnification optical system in which the spherical aberration and the astigmatism are suppressed.

In order to obtain more favorable characteristics, the lower limit value of Conditional Expression (25) is more preferably 50, still more preferably 51, and still more preferably 52. In order to obtain more favorable characteristics, the upper limit value of Conditional Expression (25) is more preferably 58, still more preferably 57, and still more preferably 56.5.

In a case where a refractive index with respect to a d line for the positive lens of the first lens group G1 is denoted by Nd1p, it is preferable that all positive lenses of the first lens group G1 satisfy Conditional Expression (6). By not allowing a corresponding value of Conditional Expression (6) to be equal to or less than the lower limit value, it is advantageous for correcting spherical aberration, particularly at the telephoto end. By not allowing the corresponding value of Conditional Expression (6) to be equal to or greater than the upper limit value, suppression of a weight of the first lens group G1 is facilitated.

1.4<Nd1p<1.62 (6)

In order to obtain more favorable characteristics, the lower limit value of Conditional Expression (6) is more preferably 1.41, still more preferably 1.42, still more preferably 1.43, still more preferably 1.44, still more preferably 1.45, still more preferably 1.46, still more preferably 1.47, and still more preferably 1.48. In order to obtain more favorable characteristics, the upper limit value of Conditional Expression (6) is more preferably 1.59, still more preferably 1.585, still more preferably 1.58, still more preferably 1.575, still more preferably 1.57, still more preferably 1.565, still more preferably 1.56, and still more preferably 1.555.

It is preferable that the variable magnification optical system includes at least one specific lens described below. The specific lens is defined as a lens satisfying Conditional Expressions (19) and (20). Here, a refractive index with respect to a d line for a lens included in the variable magnification optical system is denoted by Nd. An Abbe number based on the d line for the lens included in the variable magnification optical system is denoted by νd. For example, in the example of FIG. 2, the lens L21 and the lens L41 are the specific lenses.

2.435<Nd+0.01425×νd<2.75 (19)

15<νd<39 (20)

A material of the specific lens may be, for example, glass. The Proceedings of 49th Optical Symposium (Dates: June 20 to 21, 2024, Organizer: The Optical Society of Japan), pp. 40 to 42, describe optical glass satisfying Conditional Expressions (19) and (20) and a manufacturing method thereof.

By not allowing a corresponding value of Conditional Expression (19) to be equal to or less than the lower limit value, it is advantageous for favorably correcting the spherical aberration and the chromatic aberration. By not allowing the corresponding value of Conditional Expression (19) to be equal to or greater than the upper limit value, an increase in difficulty of correcting the field curvature can be suppressed.

In order to obtain more favorable characteristics, the lower limit value of Conditional Expression (19) is more preferably 2.445 and still more preferably 2.45. In order to obtain more favorable characteristics, the upper limit value of Conditional Expression (19) is more preferably 2.74 and still more preferably 2.73.

By not allowing a corresponding value of Conditional Expression (20) to be equal to or less than the lower limit value, it is possible to favorably correct the secondary spectrum in addition to the first-order chromatic aberration in the correction of the chromatic aberration. By not allowing the corresponding value of Conditional Expression (20) to be equal to or greater than the upper limit value, it is possible to more reliably favorably correct the secondary spectrum.

In order to obtain more favorable characteristics, the lower limit value of Conditional Expression (20) is more preferably 15.5, still more preferably 16, still more preferably 16.5, still more preferably 16.8, still more preferably 17.1, and still more preferably 17.3. In order to obtain more favorable characteristics, the upper limit value of Conditional Expression (20) is more preferably 36, still more preferably 34, still more preferably 33.5, still more preferably 33, still more preferably 32.5, and still more preferably 32.

In a configuration in which at least one focusing group that moves during focusing is disposed in the variable magnification optical system and the focusing group consists of one lens, it is preferable that the variable magnification optical system satisfies Conditional Expression (21). An Abbe number based on a d line for the lens constituting the focusing group is denoted by νdfoc. By not allowing a corresponding value of Conditional Expression (21) to be equal to or less than the lower limit value, it is advantageous for suppressing fluctuations of the chromatic aberration during the focusing. By not allowing the corresponding value of Conditional Expression (21) to be equal to or greater than the upper limit value, a material that is easily obtainable can be used. As a result, it is advantageous for implementing a variable magnification optical system in which the spherical aberration and the astigmatism are suppressed.

30<νdfoc<90 (21)

In order to obtain more favorable characteristics, the lower limit value of Conditional Expression (21) is more preferably 34, still more preferably 38, still more preferably 42, still more preferably 46, still more preferably 50, and still more preferably 53. In order to obtain more favorable characteristics, the upper limit value of Conditional Expression (21) is more preferably 80, still more preferably 70, still more preferably 65, still more preferably 63, still more preferably 62, and still more preferably 61.

In a configuration in which at least one focusing group that moves during focusing is disposed in the intermediate group GM, it is preferable that the variable magnification optical system satisfies Conditional Expression (23). A focal length of a focusing group having a strongest refractive power among the focusing groups in the intermediate group GM is denoted by ffocmax. By not allowing a corresponding value of Conditional Expression (23) to be equal to or less than the lower limit value, it is advantageous for suppressing fluctuations of the aberrations during focusing. By not allowing the corresponding value of Conditional Expression (23) to be equal to or greater than the upper limit value, the refractive power of the focusing group can be ensured. As a result, suppression of the amount of movement of the focusing group during focusing is facilitated, which is advantageous for size reduction.

1.2<|ffoc max/fw|<5 (23)

In order to obtain more favorable characteristics, the lower limit value of Conditional Expression (23) is more preferably 1.3, still more preferably 1.4, still more preferably 1.5, still more preferably 1.6, still more preferably 1.7, still more preferably 1.8, still more preferably 1.9, and still more preferably 2. In order to obtain more favorable characteristics, the upper limit value of Conditional Expression (23) is more preferably 4.5, still more preferably 4, still more preferably 3.7, still more preferably 3.4, still more preferably 3.3, still more preferably 3.2, still more preferably 3.1, and still more preferably 3.

In a configuration in which the anti-vibration group that moves in a direction intersecting with the optical axis Z during image shake correction is disposed in the intermediate group GM, it is preferable that the variable magnification optical system satisfies Conditional Expression (17). Here, a focal length of the anti-vibration group is denoted by fIS. By not allowing a corresponding value of Conditional Expression (17) to be equal to or less than the lower limit value, it is advantageous for suppressing fluctuations of the aberrations during image shake correction. By not allowing the corresponding value of Conditional Expression (17) to be equal to or greater than the upper limit value, the refractive power of the anti-vibration group can be ensured. As a result, suppression of the amount of movement of the anti-vibration group during the image shake correction is facilitated, which is advantageous for size reduction.

0.4<|fIS/ft|<5 (17)

In order to obtain more favorable characteristics, the lower limit value of Conditional Expression (17) is more preferably 0.5, still more preferably 0.6, still more preferably 0.7, still more preferably 0.8, still more preferably 0.85, still more preferably 0.9, still more preferably 0.95, and still more preferably 1. In order to obtain more favorable characteristics, the upper limit value of Conditional Expression (17) is more preferably 4, still more preferably 3, still more preferably 2, still more preferably 1.7, still more preferably 1.5, still more preferably 1.4, still more preferably 1.3, and still more preferably 1.25.

It is preferable that the variable magnification optical system satisfies Conditional Expression (8). A focal length of the variable magnification optical system in a state where the infinite distance object is in focus at the telephoto end is denoted by ft. By not allowing a corresponding value of Conditional Expression (8) to be equal to or less than the lower limit value, a high zoom ratio as the variable magnification optical system can be ensured. By not allowing the corresponding value of Conditional Expression (8) to be equal to or greater than the upper limit value, correction of various aberrations throughout the entire magnification range is facilitated.

2<ft/fw<20 (8)

In order to obtain more favorable characteristics, the lower limit value of Conditional Expression (8) is more preferably 2.1, still more preferably 2.2, still more preferably 2.3, still more preferably 2.4, still more preferably 2.5, still more preferably 2.55, still more preferably 2.6, and still more preferably 2.65. In order to obtain more favorable characteristics, the upper limit value of Conditional Expression (8) is more preferably 15, still more preferably 10, still more preferably 8, still more preferably 7, still more preferably 6, still more preferably 5, still more preferably 4, and still more preferably 3.5.

It is preferable that the variable magnification optical system satisfies Conditional Expression (22). A maximum half angle of view in a state where the infinite distance object is in focus at the wide angle end is denoted by ow. The unit of ow is degree. By not allowing a corresponding value of Conditional Expression (22) to be equal to or less than the lower limit value, it is advantageous for increasing the angle of view. By not allowing the corresponding value of Conditional Expression (22) to be equal to or greater than the upper limit value, it is advantageous for size reduction.

35<ωw<55 (22)

In order to obtain more favorable characteristics, the lower limit value of Conditional Expression (22) is more preferably set to 40, still more preferably 42, and still more preferably 43. In order to obtain more favorable characteristics, the upper limit value of Conditional Expression (22) is more preferably 50, still more preferably 48, and still more preferably 47.

The example shown in FIG. 1 is merely an example, and various modifications can be made to the variable magnification optical system according to the embodiment of the present disclosure without departing from the gist of the disclosed technology. For example, the number of lens groups included in the front group GF, the number of lens groups included in the intermediate group GM, the number of lenses included in each lens group, the number of lenses included in the focusing group, and the number of lenses included in the anti-vibration group may be different from the numbers in the example of FIG. 1. In addition, FIG. 1 shows an example in which the variable magnification optical system is a zoom lens. However, the variable magnification optical system according to the embodiment of the present disclosure may be a varifocal lens.

A configuration example related to the intermediate group GM will be described below. A second intermediate lens group having a positive refractive power may be disposed adjacent to the image side of the first intermediate lens group GM1 in the intermediate group GM. In this configuration, it is preferable that the variable magnification optical system satisfies Conditional Expression (11). Here, a focal length of the second intermediate lens group having a positive refractive power is denoted by fM2p. By not allowing a corresponding value of Conditional Expression (11) to be equal to or less than the lower limit value, the positive refractive power of the second intermediate lens group is not excessively weakened. As a result, it is advantageous for correcting the spherical aberration at the telephoto end. By not allowing the corresponding value of Conditional Expression (11) to be equal to or greater than the upper limit value, the refractive power of the second intermediate lens group is not excessively increased. As a result, it is advantageous for suppressing fluctuations of the aberrations during changing magnification.

0.1<fM1/fM2p<4 (11)

In order to obtain more favorable characteristics, the lower limit value of Conditional Expression (11) is more preferably 0.4, still more preferably 0.7, still more preferably 1, still more preferably 1.3, still more preferably 1.6, and still more preferably 1.9. In order to obtain more favorable characteristics, the upper limit value of Conditional Expression (11) is more preferably 3, still more preferably 2.9, still more preferably 2.8, still more preferably 2.7, still more preferably 2.6, and still more preferably 2.5.

A second intermediate lens group having a positive refractive power may be disposed adjacent to the image side of the first intermediate lens group GM1 in the intermediate group GM, and a third intermediate lens group having a positive refractive power may be disposed adjacent to the image side of the second intermediate lens group. In this configuration, it is preferable that the variable magnification optical system satisfies Conditional Expression (12). Here, a focal length of the second intermediate lens group having a positive refractive power is denoted by fM2p. A focal length of the third intermediate lens group having a positive refractive power is denoted by fM3p. By not allowing a corresponding value of Conditional Expression (12) to be equal to or less than the lower limit value, the positive refractive power of the third intermediate lens group is not excessively weakened. As a result, reduction of the incidence angle of the off-axis principal ray on the image plane Sim is facilitated. By not allowing the corresponding value of Conditional Expression (12) to be equal to or greater than the upper limit value, the positive refractive power of the second intermediate lens group is not excessively weakened. As a result, it is advantageous for correcting the spherical aberration at the telephoto end.

1<fM2p/fM3p<15 (12)

In order to obtain more favorable characteristics, the lower limit value of Conditional Expression (12) is more preferably 3, still more preferably 4, still more preferably 5, still more preferably 5.5, still more preferably 6, and still more preferably 6.5. In order to obtain more favorable characteristics, the upper limit value of Conditional Expression (12) is more preferably 13, still more preferably 11.5, still more preferably 10.5, still more preferably 9.5, still more preferably 8.5, and still more preferably 7.5.

The second intermediate lens group having a positive refractive power may be disposed adjacent to the image side of the first intermediate lens group GM1 in the intermediate group GM and the third intermediate lens group having a negative refractive power may be disposed adjacent to the image side of the second intermediate lens group. In this configuration, it is preferable that the variable magnification optical system satisfies Conditional Expression (13). Here, a focal length of the second intermediate lens group having a positive refractive power is denoted by fM2p. A focal length of the third intermediate lens group having a negative refractive power is denoted by fM3n. By not allowing a corresponding value of Conditional Expression (13) to be equal to or less than the lower limit value, the refractive power of the second intermediate lens group is not excessively increased. As a result, it is advantageous for suppressing fluctuations of the aberrations during changing magnification. By not allowing the corresponding value of Conditional Expression (13) to be equal to or greater than the upper limit value, the positive refractive power of the second intermediate lens group is not excessively weakened. As a result, it is advantageous for suppressing the spherical aberration at the telephoto end.

0.1<fM2p/(−fM3n)<1 (13)

In order to obtain more favorable characteristics, the lower limit value of Conditional Expression (13) is more preferably 0.15, still more preferably 0.2, still more preferably 0.25, still more preferably 0.3, still more preferably 0.35, and still more preferably 0.38. In order to obtain more favorable characteristics, the upper limit value of Conditional Expression (13) is more preferably 0.9, still more preferably 0.8, still more preferably 0.7, still more preferably 0.6, still more preferably 0.55, and still more preferably 0.52.

Alternatively, a second intermediate lens group having a negative refractive power may be disposed adjacent to the image side of the first intermediate lens group GM1 in the intermediate group GM. In this configuration, it is preferable that the variable magnification optical system satisfies Conditional Expression (14). A focal length of the second intermediate lens group having a negative refractive power is denoted by fM2n. By not allowing a corresponding value of Conditional Expression (14) to be equal to or less than the lower limit value, the refractive power of the first intermediate lens group GM1 is not excessively increased. As a result, it is advantageous for suppressing fluctuations of the aberrations during changing magnification. By not allowing the corresponding value of Conditional Expression (14) to be equal to or greater than the upper limit value, the refractive power of the first intermediate lens group GM1 is not excessively weakened. As a result, it is advantageous for suppressing the spherical aberration at the telephoto end.

0.1<fM1/(−fM2n)<2 (14)

In order to obtain more favorable characteristics, the lower limit value of Conditional Expression (14) is more preferably 0.12, still more preferably 0.14, still more preferably 0.16, still more preferably 0.18, still more preferably 0.2, and still more preferably 0.21. In order to obtain more favorable characteristics, the upper limit value of Conditional Expression (14) is more preferably 1.5, still more preferably 1.2, still more preferably 1, still more preferably 0.8, still more preferably 0.7, and still more preferably 0.6.

The second intermediate lens group having a negative refractive power may be disposed adjacent to the image side of the first intermediate lens group GM1 in the intermediate group GM and the third intermediate lens group having a positive refractive power may be disposed adjacent to the image side of the second intermediate lens group. In this configuration, it is preferable that the variable magnification optical system satisfies Conditional Expression (15). A focal length of the second intermediate lens group having a negative refractive power is denoted by fM2n. A focal length of the third intermediate lens group having a positive refractive power is denoted by fM3p. By not allowing a corresponding value of Conditional Expression (15) to be equal to or less than the lower limit value, the positive refractive power of the third intermediate lens group is not excessively weakened. As a result, reduction of the incidence angle of the off-axis principal ray on the image plane Sim is facilitated. By not allowing the corresponding value of Conditional Expression (15) to be equal to or greater than the upper limit value, the refractive power of the third intermediate lens group is not excessively increased. As a result, it is advantageous for suppressing fluctuations in aberrations during changing magnification.

1<(−fM2n)/fM3p<15 (15)

In order to obtain more favorable characteristics, the lower limit value of Conditional Expression (15) is more preferably 2, still more preferably 3, still more preferably 3.5, still more preferably 4, still more preferably 4.5, and still more preferably 5. In order to obtain more favorable characteristics, the upper limit value of Conditional Expression (15) is more preferably 13, still more preferably 12, still more preferably 11, still more preferably 10, still more preferably 9, and still more preferably 8.

The second intermediate lens group having a negative refractive power may be disposed adjacent to the image side of the first intermediate lens group GM1 in the intermediate group GM, and the third intermediate lens group having a negative refractive power may be disposed adjacent to the image side of the second intermediate lens group. In this configuration, it is preferable that the variable magnification optical system satisfies Conditional Expression (16). Here, a focal length of the second intermediate lens group having a negative refractive power is denoted by fM2n. A focal length of the third intermediate lens group having a negative refractive power is denoted by fM3n. By not allowing a corresponding value of Conditional Expression (16) to be equal to or less than the lower limit value, the negative refractive power of the second intermediate lens group is not excessively increased. As a result, it is advantageous for suppressing the spherical aberration at the telephoto end. By not allowing the corresponding value of Conditional Expression (16) to be equal to or greater than the upper limit value, the negative refractive power of the third intermediate lens group is not excessively increased. As a result, it is advantageous for reducing the incidence angle of the off-axis principal ray on the image plane Sim.

0.3<(−fM2n)/(−fM3n)<3 (16)

In order to obtain more favorable characteristics, the lower limit value of Conditional Expression (16) is more preferably 0.5, still more preferably 0.6, still more preferably 0.7, still more preferably 0.75, still more preferably 0.8, and still more preferably 0.85. In order to obtain more favorable characteristics, the upper limit value of Conditional Expression (16) is more preferably 2.5, still more preferably 2, still more preferably 1.6, still more preferably 1.5, still more preferably 1.4, and still more preferably 1.3.

The preferred configurations and available configurations described above can be combined in any manner without inconsistency, and it is preferable that the preferred configurations and available configurations described above are selectively adopted as appropriate in accordance with required specifications.

For example, according to one preferable aspect of the present disclosure, in a variable magnification optical system consisting of, in order from the position closest to an object side to an image side, a first lens group G1 having a positive refractive power, a front group GF consisting of one or two lens groups having a negative refractive power, an intermediate group GM including a plurality of lens groups, and a final lens group GE, a lens group closest to the object side in the intermediate group GM is a first intermediate lens group GM1 having a positive refractive power, the intermediate group GM includes an aperture stop St, all spacings between adjacent lens groups change during changing magnification, and Conditional Expression (1) is satisfied.

Next, examples of the variable magnification optical system according to the embodiment of the present disclosure will be described, with reference to the drawings. Reference numerals provided to the groups in the cross-sectional view of each example are independently used for each example in order to avoid complication of description and the drawings caused by an increase in the number of digits of the reference numerals. Accordingly, a common reference numeral provided in the drawings of different examples does not necessarily indicate a common configuration.

### Example 1

A configuration and a movement trajectory of the variable magnification optical system according to Example 1 are shown in FIG. 1, and its showing method and configuration are described above. Thus, repeated descriptions will be partially omitted. The variable magnification optical system according to Example 1 consists of, in order from the object side to the image side, the first lens group G1 having a positive refractive power, the front group GF, the intermediate group GM, and the final lens group GE having a positive refractive power. The front group GF consists of one lens group having a negative refractive power. The intermediate group GM consists of, in order from the object side to the image side, two lens groups including a first intermediate lens group GM1 having a positive refractive power and a second intermediate lens group GM2 having a negative refractive power.

During changing magnification from the wide angle end to the telephoto end, all lens groups move along the optical axis Z by changing the spacings between the adjacent lens groups. In addition, the first intermediate lens group GM1 and the final lens group GE move on the same trajectory during changing magnification from the wide angle end to the telephoto end. The focusing group consists of the second intermediate lens group GM2. During focusing from the infinite distance object to the nearest object, the focusing group moves to the image side.

For the variable magnification optical system according to Example 1, basic lens data is shown in Table 1, specifications and variable surface spacings are shown in Table 2, and aspherical coefficients are shown in Table 3.

The table of the basic lens data is described as below. The column of “Sn” indicates surface numbers in a case where the number is increased by one at a time toward the image side from the extreme object-side surface as a first surface. The column of “R” indicates a curvature radius of each surface. The column of “D” indicates a surface spacing on the optical axis between each surface and the surface adjacent to the image side. The column of “Nd” indicates a refractive index of each lens at the d line. The column of “νd” indicates an Abbe number of each lens based on the d line. The column of “ED” indicates an effective diameter of each surface.

A column of “Material” in the table of the basic lens data, including the tables of the examples described later, is described as follows. For the specific lens described above, any one of “N200.GLASS” or “N216.GLASS” is described in the column of “Material”. As “N200.GLASS” and “N216.GLASS”, glasses described on pp. 40 to 42 of the proceedings of the 49th Optical Symposium (Dates: June 20 to 21, 2024, Organizer: The Optical Society of Japan) can be used.

For lenses other than the specific lens, in the column of “Material”, the resin lens is described as “plastic”, and for other lenses, the material name is described before “.”, and the manufacturing company name is described after “.”. In the table, the manufacturing company name is schematically shown as follows. “OHARA” indicates OHARA INC. “HOYA” indicates HOYA Corporation. “CDGM” indicates CDGM Glass CO., Ltd.

In the table of the basic lens data, a sign of a curvature radius of a surface convex toward the object side is defined as positive, and a sign of a curvature radius of a surface convex toward the image side is defined as negative. In table 1, a field of the surface number of the surface corresponding to the aperture stop St has a surface number and a text (St). A value in the lowermost field of the column of D in the table indicates a spacing between a surface closest to the image side in the table and the image plane Sim. The symbol DD[ ] is used for the variable surface spacing during changing magnification, and the surface number on the object side of the spacing is given in [ ] in the column of surface spacing.

Table 2 shows a zoom ratio Zr, a focal length f, a back focus Bf, an open F-number FNo., a maximum full angle of view 2ω, and variable surface spacings based on the d line. In a case where the variable magnification optical system is a zoom lens, the zoom ratio is synonymous with the zoom magnification. In the field of 2ω, [° ] indicates a degree unit. In Table 2, the values in the wide angle end state, the middle focal length state, and the telephoto end state are respectively shown in the columns labeled with “Wide”, “Middle”, and “Tele”.

In the table of the basic lens data, the surface number of the aspherical surface is marked with *, and the field of the curvature radius of the aspherical surface shows a value of the paraxial curvature radius. In Table 3, the row of Sn shows the surface numbers of the aspherical surfaces, and the rows of KA and Am show numerical values of the aspherical coefficients for each aspherical surface. It should be noted that m of Am is an integer equal to or more than 3, and varies depending on the surface. For example, in the fifth surface of Example 1, m=3, 4, 5, 6, 7, 8, 9, 10, 11, and 12. The “E±n” (n: integer) in numerical values of the aspherical coefficients in Table 3 indicates “×10^{±n}”. KA and Am are the aspherical coefficients in an aspheric equation represented by the following expression.

Zd=C×h²/{1+(1−KA×C²×h²)^{1/2}}+ΣAm×h^{m}
where,
Zd: an aspherical surface depth (a length of a perpendicular from a point on an aspherical surface at a height h to a plane that is perpendicular to the optical axis Z and that is in contact with the vertex of the aspherical surface),
h: a height (a distance from the optical axis Z to the lens surface),
C: a reciprocal of the paraxial curvature radius,
KA and Am: aspherical coefficients, and
Σ in the aspheric equation means a sum related to m.

Although, in the data of each table, a degree unit is used for angles, and a millimeter unit is used for lengths, since the optical system can also be proportionally enlarged or proportionally reduced to be used, other appropriate units can also be used. In addition, the numerical values rounded to predetermined digits are described in each table shown below.

TABLE 1
Example 1

| Sn | R | D | Nd | νd | Material | ED |
|---|---|---|---|---|---|---|
| 1 | 40.9462 | 6.3013 | 1.43875 | 94.66 | S-FPL55.OHARA | 40.80 |
| 2 | 486.8383 | DD[2] | | | | 40.00 |
| 3 | 33.3038 | 0.6608 | 2.00266 | 31.67 | N200.GLASS | 26.44 |
| 4 | 13.4014 | 8.3557 | | | | 21.00 |
| *5 | −24.9303 | 0.2378 | 1.58913 | 61.15 | L-BAL35.OHARA | 19.51 |
| 6 | 18.1982 | 4.7139 | 1.74000 | 28.30 | S-TIH3.OHARA | 18.16 |
| 7 | −43.8403 | 1.9999 | | | | 17.63 |
| 8 | −15.3576 | 0.8748 | 1.48749 | 70.24 | S-FSL5.OHARA | 17.43 |
| 9 | −25.4398 | DD[9] | | | | 17.40 |
| 10(St) | ∞ | 0.0501 | | | | 17.82 |
| *11 | 28.4447 | 3.4328 | 1.85135 | 40.10 | M-TAFD305.HOYA | 18.53 |
| *12 | −182.1560 | 0.2000 | | | | 18.42 |
| 13 | 22.4439 | 0.6228 | 1.48749 | 70.24 | S-FSL5.OHARA | 17.96 |
| 14 | 16.9119 | 2.1534 | | | | 17.47 |
| 15 | 28.7426 | 6.5497 | 1.43875 | 94.66 | S-FPL55.OHARA | 17.42 |
| 16 | −16.4431 | 0.4918 | 1.75520 | 27.51 | S-TIH4.OHARA | 16.76 |
| 17 | 59.1615 | 4.3998 | | | | 16.88 |
| *18 | 565.5581 | 1.5292 | 1.53409 | 55.87 | plastic | 17.87 |
| *19 | −30.5942 | 0.0498 | | | | 18.00 |
| 20 | 45.4735 | 5.0307 | 1.59522 | 67.73 | S-FPM2.OHARA | 20.00 |
| 21 | −21.7765 | DD[21] | | | | 20.44 |
| 22 | 43.0670 | 1.8477 | 2.00266 | 31.67 | N200.GLASS | 19.63 |
| 23 | 19.2900 | DD[23] | | | | 18.74 |
| 24 | −60.3850 | 0.5912 | 1.65160 | 58.54 | S-LAL7Q.OHARA | 20.63 |
| 25 | 23.7531 | 4.2005 | 2.00266 | 31.67 | N200.GLASS | 22.69 |
| 26 | 384.8422 | DD[26] | | | | 22.94 |

TABLE 2
Example 1

| | Wide | Middle | Tele |
|---|---|---|---|
| Zr | 1.0 | 1.7 | 2.8 |
| f | 16.50 | 28.10 | 46.19 |
| Bf | 13.58 | 19.85 | 31.81 |
| FNo. | 2.89 | 2.88 | 2.89 |
| 2ω[°] | 88.8 | 53.2 | 33.2 |
| DD[2] | 0.069 | 13.589 | 25.849 |
| DD[9] | 16.119 | 5.497 | 1.719 |
| DD[21] | 2.490 | 3.094 | 0.094 |
| DD[23] | 6.841 | 6.237 | 9.237 |
| DD[26] | 13.583 | 19.854 | 31.811 |

TABLE 3
Example 1

| Sn | 5 |
|---|---|
| KA | −5.5583390E+00 |
| A3 | 2.3519221E−17 |
| A4 | 1.7341020E−05 |
| A5 | −3.1739628E−05 |
| A6 | 7.6524949E−06 |
| A7 | −7.9796249E−07 |
| A8 | 8.4807499E−08 |
| A9 | −2.3150858E−08 |
| A10 | 3.9551588E−09 |
| A11 | −3.0422265E−10 |
| A12 | 8.7426539E−12 |

| Sn | 11 | 12 | 18 | 19 |
|---|---|---|---|---|
| KA | 1.0000000E+00 | 1.0000000E+00 | 1.0000000E+00 | 1.0000000E+00 |
| A3 | −1.7763568E−19 | −1.1102230E−19 | 5.2968080E−04 | 1.0705423E−04 |
| A4 | −5.0423799E−06 | 3.3425288E−06 | −1.0974497E−03 | −2.2178314E−04 |
| A5 | 2.0152770E−06 | 7.6766191E−07 | 8.3249786E−04 | 1.9360665E−04 |
| A6 | −3.1653302E−07 | −1.5608708E−07 | −3.5929510E−04 | −8.9437877E−05 |
| A7 | 7.6120349E−09 | −1.9232139E−10 | 9.2427903E−05 | 2.4394046E−05 |
| A8 | 1.1836783E−09 | 7.0139826E−10 | −1.4607424E−05 | −4.0658883E−06 |
| A9 | −3.6542252E−11 | 7.1244712E−12 | 1.3919153E−06 | 4.0742991E−07 |
| A10 | −1.1535060E−12 | −7.7888123E−13 | −7.3534343E−08 | −2.2669510E−08 |
| A11 | 3.2389642E−14 | −6.1772606E−15 | 1.6599794E−09 | 5.4290752E−10 |

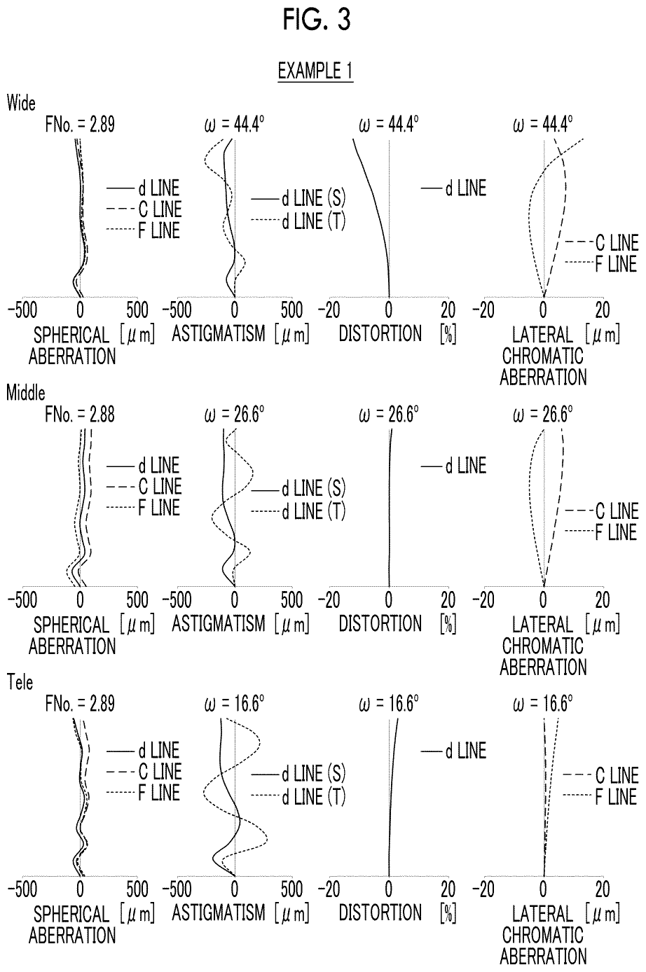

FIG. 3 shows each aberration diagram of the variable magnification optical system according to Example 1 in a state where the infinite distance object is in focus. FIG. 3 shows, in order from the left, a spherical aberration, an astigmatism, a distortion, and a lateral chromatic aberration. In FIG. 3, the aberrations in the wide angle end state are shown in an upper part labeled “Wide”, the aberrations in the middle focal length state are shown in a middle part labeled “Middle”, and the aberrations in the telephoto end state are shown in a lower part labeled “Tele”. In the spherical aberration diagram, aberrations at a d line, a C line, and an F line are indicated by a solid line, a long broken line, and a short broken line, respectively. In the astigmatism diagram, the aberration at the d line in a sagittal direction is indicated by a solid line, and the aberration at the d line in a tangential direction is indicated by a short broken line. In the distortion diagram, the aberration at the d line is indicated by a solid line. In the lateral chromatic aberration diagram, aberrations at the C line and the F line are indicated by a long broken line and a short broken line, respectively. In the spherical aberration diagram, a value of the open F-number is shown after “FNo.=”. In other aberration diagrams, a value of the maximum half angle of view is shown after ω=.

Symbols, meanings, description methods, and showing methods of the respective data pieces according to Example 1 are basically similar to those in the following examples unless otherwise specified. Therefore, hereinafter, repeated description will not be given.

### Example 2

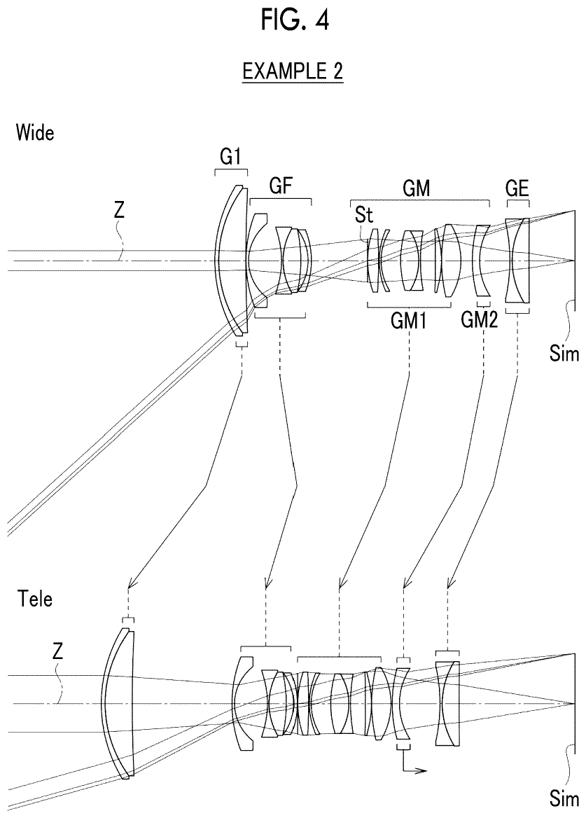

A configuration and a movement trajectory of a variable magnification optical system according to Example 2 are shown in FIG. 4. The variable magnification optical system according to Example 2 consists of, in order from the object side to the image side, a first lens group G1 having a positive refractive power, a front group GF, an intermediate group GM, and a final lens group GE having a positive refractive power. The front group GF consists of one lens group having a negative refractive power. The intermediate group GM consists of, in order from the object side to the image side, two lens groups including a first intermediate lens group GM1 having a positive refractive power and a second intermediate lens group GM2 having a negative refractive power.

During changing magnification from the wide angle end to the telephoto end, all lens groups move along the optical axis Z by changing the spacings between the adjacent lens groups. In addition, the first intermediate lens group GM1 and the final lens group GE move on the same trajectory during changing magnification from the wide angle end to the telephoto end. The focusing group consists of the second intermediate lens group GM2. During focusing from the infinite distance object to the nearest object, the focusing group moves to the image side.

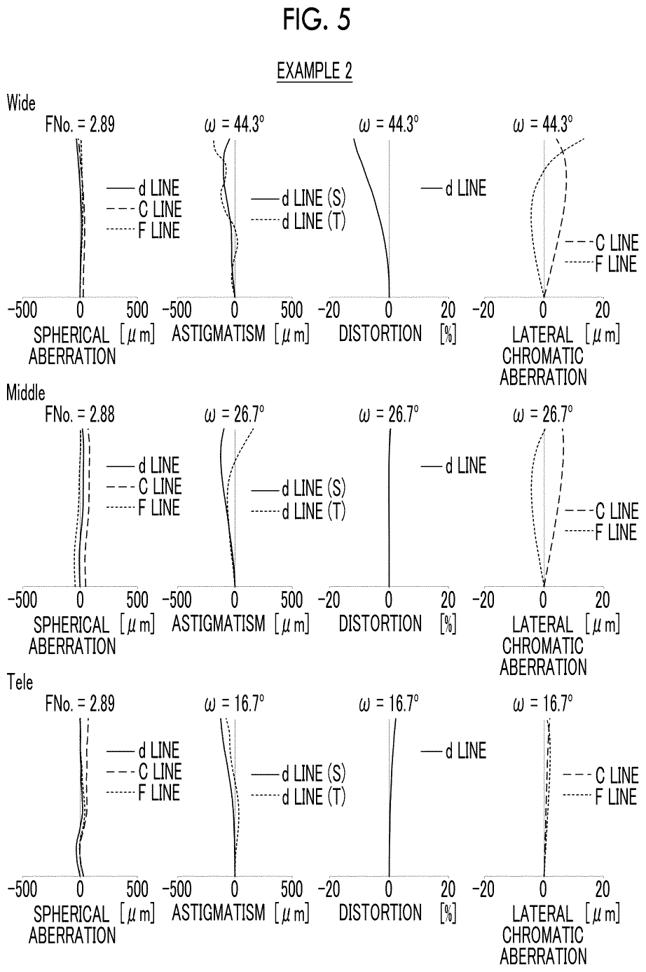

For the variable magnification optical system according to Example 2, basic lens data is shown in Table 4, specifications and variable surface spacings are shown in Table 5, aspherical coefficients are shown in Table 6, and each aberration diagram is shown in FIG. 5.

TABLE 4
Example 2

| Sn | R | D | Nd | νd | Material | ED |
|---|---|---|---|---|---|---|
| 1 | 43.6757 | 1.0098 | 1.59551 | 39.24 | S-TIM8.OHARA | 42.58 |
| 2 | 36.4790 | 7.0996 | 1.48749 | 70.24 | S-FSL5.OHARA | 40.80 |
| 3 | 441.9245 | DD[3] | | | | 39.99 |
| 4 | 39.1475 | 0.6654 | 2.00266 | 31.67 | N200.GLASS | 26.43 |
| 5 | 13.8388 | 8.6287 | | | | 21.00 |
| *6 | −26.4485 | 0.4138 | 1.58913 | 61.15 | L-BAL35.OHARA | 18.94 |
| 7 | 19.0154 | 4.4938 | 1.74000 | 28.30 | S-TIH3.OHARA | 17.89 |
| 8 | −44.0263 | 1.9009 | | | | 17.51 |
| 9 | −15.5037 | 0.8748 | 1.48749 | 70.24 | S-FSL5.OHARA | 17.43 |
| 10 | −24.8711 | DD[10] | | | | 17.40 |
| 11(St) | ∞ | 0.0498 | | | | 17.17 |
| *12 | 28.5126 | 2.8365 | 1.85135 | 40.10 | M-TAFD305.HOYA | 17.81 |
| *13 | −152.3402 | 0.2000 | | | | 17.76 |
| 14 | 23.0006 | 0.4763 | 1.48749 | 70.24 | S-FSL5.OHARA | 17.39 |
| 15 | 17.3258 | 5.1187 | | | | 17.01 |
| 16 | 31.6530 | 4.7504 | 1.43875 | 94.66 | S-FPL55.OHARA | 16.89 |
| 17 | −16.9352 | 0.4304 | 1.75520 | 27.51 | S-TIH4.OHARA | 16.62 |
| 18 | 50.8412 | 3.8708 | | | | 16.80 |
| *19 | 345.7060 | 1.6194 | 1.53409 | 55.87 | plastic | 17.91 |
| *20 | −29.8494 | 0.0502 | | | | 18.00 |
| 21 | 47.2505 | 5.0553 | 1.59522 | 67.73 | S-FPM2.OHARA | 20.00 |
| 22 | −21.3984 | DD[22] | | | | 20.48 |
| 23 | 40.6708 | 1.8940 | 2.00266 | 31.67 | N200.GLASS | 19.87 |
| 24 | 19.4965 | DD[24] | | | | 18.98 |
| 25 | −51.9967 | 0.6023 | 1.65160 | 58.54 | S-LAL7Q.OHARA | 21.25 |
| 26 | 24.1136 | 4.4112 | 2.00266 | 31.67 | N200.GLASS | 23.62 |
| 27 | 1706.9771 | DD[27] | | | | 23.86 |

TABLE 5
Example 2

| | Wide | Middle | Tele |
|---|---|---|---|
| Zr | 1.0 | 1.7 | 2.8 |
| f | 16.51 | 28.12 | 46.24 |
| Bf | 12.05 | 18.38 | 30.36 |
| FNo. | 2.89 | 2.88 | 2.89 |
| 2ω[°] | 88.6 | 53.4 | 33.4 |
| DD[3] | 0.050 | 13.807 | 26.130 |
| DD[10] | 14.702 | 4.020 | 0.064 |
| DD[22] | 3.003 | 3.601 | 0.333 |
| DD[24] | 7.938 | 7.340 | 10.608 |
| DD[27] | 12.046 | 18.381 | 30.358 |

TABLE 6
Example 2

| Sn | 6 | 12 | 13 |
|---|---|---|---|
| KA | −7.0167289E−01 | 1.0000000E+00 | 1.0000000E+00 |
| A3 | 6.7197773E−18 | 0.0000000E+00 | −1.1102230E−19 |
| A4 | 5.6744791E−05 | −4.7726109E−06 | 6.3296379E−06 |
| A5 | −3.1639171E−05 | 1.3077321E−06 | 1.2269247E−07 |
| A6 | 7.6410467E−06 | −2.9411961E−07 | −1.2973130E−07 |
| A7 | −8.3961846E−07 | 1.0667902E−08 | 2.2629587E−09 |
| A8 | 8.5987840E−08 | 1.1293998E−09 | 6.9091013E−10 |
| A9 | −2.2549543E−08 | −4.1268511E−11 | 5.1431053E−12 |
| A10 | 3.9178495E−09 | −1.1068999E−12 | −7.9408669E−13 |
| A11 | −3.0627823E−10 | 3.5255784E−14 | −5.4597903E−15 |
| A12 | 8.9069947E−12 | | |

| Sn | 19 | 20 |
|---|---|---|
| KA | 1.0000000E+00 | 1.0000000E+00 |
| A4 | −4.9504891E−05 | 7.3152594E−06 |
| A6 | 2.8186449E−07 | −7.4989551E−08 |
| A8 | −5.3603639E−09 | 6.9443387E−09 |
| A10 | 3.3560133E−11 | −1.5489131E−10 |
| A12 | −1.4936362E−13 | 6.2914700E−13 |
| A14 | 2.1700593E−14 | 3.4146878E−14 |
| A16 | −3.0382691E−16 | −4.6471503E−16 |
| A18 | 1.5001176E−18 | 2.0729836E−18 |

### Example 3

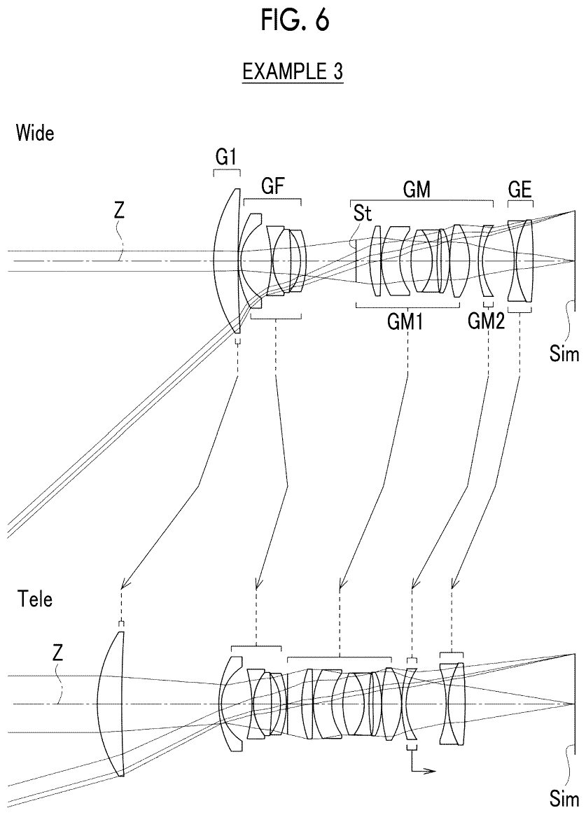

A configuration and a movement trajectory of a variable magnification optical system according to Example 3 are shown in FIG. 6. The variable magnification optical system according to Example 3 consists of, in order from the object side to the image side, a first lens group G1 having a positive refractive power, a front group GF, an intermediate group GM, and a final lens group GE having a negative refractive power. The front group GF consists of one lens group having a negative refractive power. The intermediate group GM consists of, in order from the object side to the image side, two lens groups including a first intermediate lens group GM1 having a positive refractive power and a second intermediate lens group GM2 having a negative refractive power.

During changing magnification from the wide angle end to the telephoto end, all lens groups move along the optical axis Z by changing the spacings between the adjacent lens groups. In addition, the first intermediate lens group GM1 and the final lens group GE move on the same trajectory during changing magnification from the wide angle end to the telephoto end. The focusing group consists of the second intermediate lens group GM2. During focusing from the infinite distance object to the nearest object, the focusing group moves to the image side.

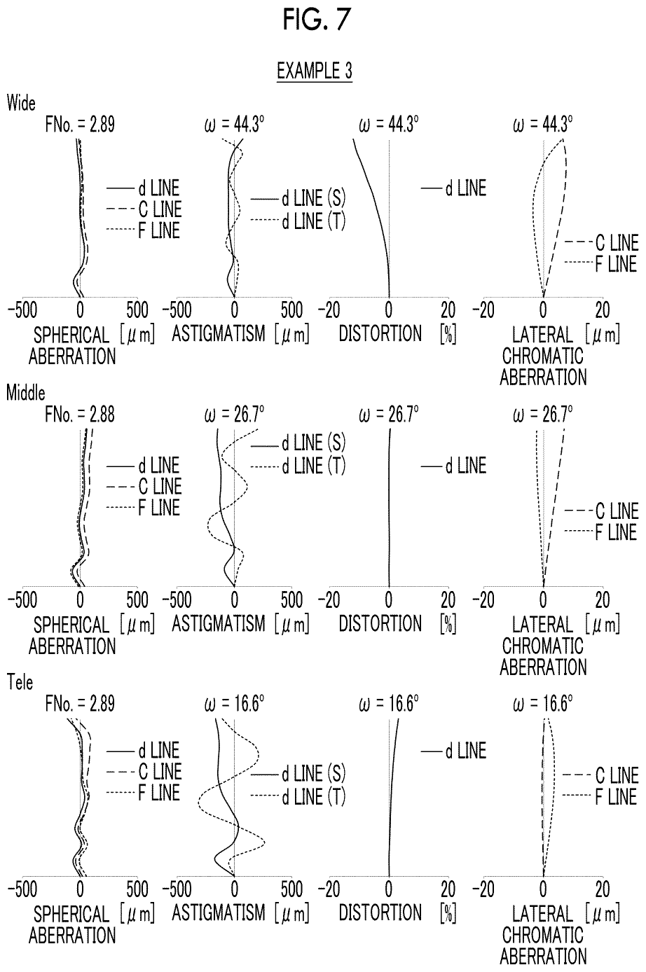

For the variable magnification optical system according to Example 3, basic lens data is shown in Table 7, specifications and variable surface spacings are shown in Table 8, aspherical coefficients are shown in Table 9, and each aberration diagram is shown in FIG. 7.

TABLE 7
Example 3

| Sn | R | D | Nd | νd | Material | ED |
|---|---|---|---|---|---|---|
| 1 | 39.4884 | 6.3864 | 1.43875 | 94.66 | S-FPL55.OHARA | 40.80 |
| 2 | 361.0433 | DD[2] | | | | 39.98 |
| 3 | 28.9316 | 0.6807 | 2.00266 | 31.67 | N200.GLASS | 26.69 |
| 4 | 12.8807 | 8.0070 | | | | 21.00 |
| *5 | −33.4408 | 0.3987 | 1.58913 | 61.15 | L-BAL35.OHARA | 19.61 |
| 6 | 15.1239 | 4.7078 | 1.74000 | 28.30 | S-TIH3.OHARA | 17.82 |
| 7 | −94.6937 | 2.3983 | | | | 17.25 |
| 8 | −15.0461 | 1.4912 | 1.48749 | 70.24 | S-FSL5.OHARA | 17.15 |
| 9 | −28.1874 | DD[9] | | | | 17.08 |
| 10(St) | ∞ | 3.5861 | | | | 17.05 |
| *11 | 31.0788 | 2.8626 | 1.85135 | 40.10 | M-TAFD305.HOYA | 19.68 |
| *12 | −540.5950 | 0.2000 | | | | 19.66 |
| 13 | 20.9354 | 4.7969 | 1.48749 | 70.24 | S-FSL5.OHARA | 19.41 |
| 14 | 15.8245 | 2.9307 | | | | 17.43 |
| 15 | 24.7199 | 5.6147 | 1.43875 | 94.66 | S-FPL55.OHARA | 17.49 |
| 16 | −15.3560 | 1.2100 | 1.75520 | 27.51 | S-TIH4.OHARA | 17.20 |
| 17 | 64.7789 | 1.0717 | | | | 17.56 |
| *18 | 110.0552 | 2.2347 | 1.53409 | 55.87 | plastic | 17.61 |
| *19 | −29.9357 | 0.0502 | | | | 18.00 |
| 20 | 43.5848 | 5.1580 | 1.59522 | 67.73 | S-FPM2.OHARA | 20.00 |
| 21 | −21.2429 | DD[21] | | | | 20.45 |
| 22 | 34.8380 | 1.1162 | 2.00266 | 31.67 | N200.GLASS | 19.49 |
| 23 | 19.1880 | DD[23] | | | | 18.74 |
| 24 | −32.5339 | 0.5353 | 1.65160 | 58.54 | S-LAL7Q.OHARA | 20.35 |
| 25 | 26.2949 | 4.4182 | 1.84666 | 23.78 | S-TIH53W.OHARA | 22.71 |
| 26 | −139.6457 | DD[26] | | | | 23.14 |

TABLE 8
Example 3

| | Wide | Middle | Tele |
|---|---|---|---|
| Zr | 1.0 | 1.7 | 2.8 |
| f | 16.53 | 28.14 | 46.28 |
| Bf | 10.96 | 17.35 | 28.79 |
| FNo. | 2.89 | 2.88 | 2.89 |
| 2ω[°] | 88.6 | 53.4 | 33.2 |
| DD[2] | 0.050 | 13.503 | 25.438 |
| DD[9] | 13.048 | 3.528 | 0.307 |
| DD[21] | 2.288 | 3.190 | 0.090 |
| DD[23] | 8.316 | 7.414 | 10.514 |
| DD[26] | 10.961 | 17.345 | 28.789 |

TABLE 9
Example 3

| Sn | 5 | 11 | 12 |
|---|---|---|---|
| KA | −4.9354038E+00 | 1.0000000E+00 | 1.0000000E+00 |
| A3 | 3.6958775E−17 | −1.7763568E−19 | 2.2204460E−20 |
| A4 | 6.4778269E−05 | −5.0763039E−06 | 2.7393896E−06 |
| A5 | −4.1523615E−05 | 1.4560123E−06 | −1.3348658E−07 |
| A6 | 9.5607063E−06 | −3.1826485E−07 | −1.4111678E−07 |
| A7 | −9.2811039E−07 | 9.9057459E−09 | 3.8141593E−09 |
| A8 | 7.0683179E−08 | 1.1067126E−09 | 5.5853840E−10 |
| A9 | −2.0912662E−08 | −4.2565137E−11 | −2.3760298E−12 |
| A10 | 3.9263875E−09 | −1.0510186E−12 | −6.3198880E−13 |
| A11 | −3.1082665E−10 | 3.5273586E−14 | 6.2311431E−16 |
| A12 | 8.9535108E−12 | | |

| Sn | 18 | 19 |
|---|---|---|
| KA | 1.0000000E+00 | 1.0000000E+00 |
| A3 | 5.2520595E−04 | 1.0205828E−04 |
| A4 | −1.1224695E−03 | −2.2237540E−04 |
| A5 | 8.4761903E−04 | 1.8380790E−04 |
| A6 | −3.7119310E−04 | −8.4849485E−05 |
| A7 | 9.6776087E−05 | 2.2997549E−05 |
| A8 | −1.5515671E−05 | −3.8128121E−06 |
| A9 | 1.5000577E−06 | 3.7887695E−07 |
| A10 | −8.0412642E−08 | −2.0846734E−08 |
| A11 | 1.8378698E−09 | 4.8931292E−10 |

### Example 4

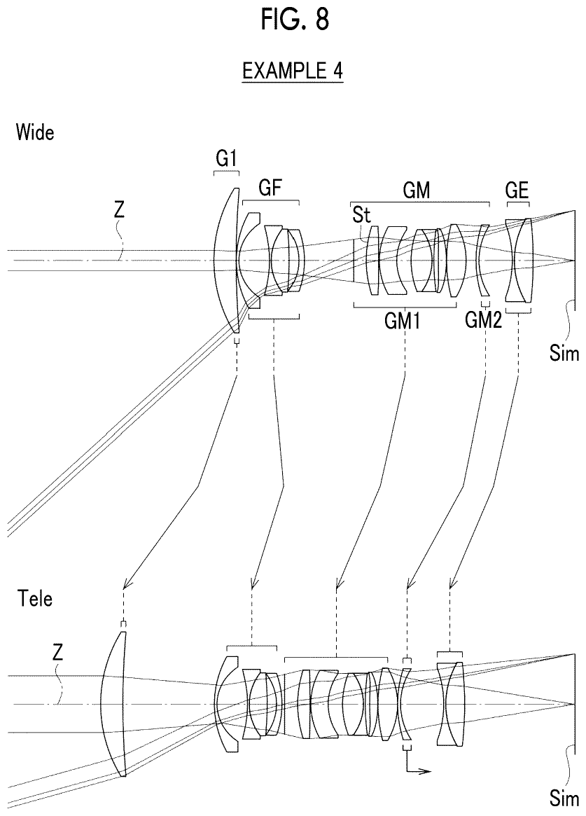

A configuration and a movement trajectory of a variable magnification optical system according to Example 4 are shown in FIG. 8. The variable magnification optical system according to Example 4 consists of, in order from the object side to the image side, a first lens group G1 having a positive refractive power, a front group GF, an intermediate group GM, and a final lens group GE having a negative refractive power. The front group GF consists of one lens group having a negative refractive power. The intermediate group GM consists of, in order from the object side to the image side, two lens groups including a first intermediate lens group GM1 having a positive refractive power and a second intermediate lens group GM2 having a negative refractive power.

During changing magnification from the wide angle end to the telephoto end, all lens groups move along the optical axis Z by changing the spacings between the adjacent lens groups. In addition, the first intermediate lens group GM1 and the final lens group GE move on the same trajectory during changing magnification from the wide angle end to the telephoto end. The focusing group consists of the second intermediate lens group GM2. During focusing from the infinite distance object to the nearest object, the focusing group moves to the image side.

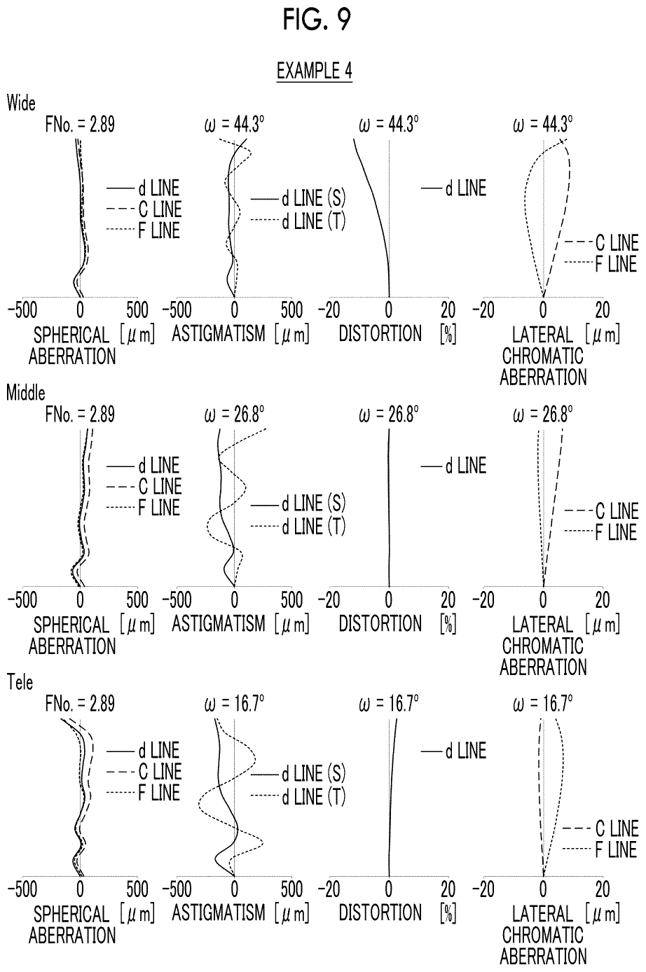

For the variable magnification optical system according to Example 4, basic lens data is shown in Table 10, specifications and variable surface spacings are shown in Table 11, aspherical coefficients are shown in Table 12, and each aberration diagram is shown in FIG. 9.

TABLE 10
Example 4

| Sn | R | D | Nd | νd | Material | ED |
|---|---|---|---|---|---|---|
| 1 | 41.3927 | 5.8265 | 1.53775 | 74.70 | S-FPM3.OHARA | 40.80 |
| 2 | 255.1130 | DD[2] | | | | 39.99 |
| 3 | 29.3879 | 0.6864 | 2.00266 | 31.67 | N200.GLASS | 26.91 |
| 4 | 12.8090 | 7.9956 | | | | 21.00 |
| *5 | −32.5505 | 0.4615 | 1.58913 | 61.15 | L-BAL35.OHARA | 19.70 |
| 6 | 15.1378 | 4.6665 | 1.74000 | 28.30 | S-TIH3.OHARA | 17.77 |
| 7 | −102.2879 | 2.4564 | | | | 17.19 |
| 8 | −14.9234 | 1.4284 | 1.48749 | 70.24 | S-FSL5.OHARA | 17.07 |
| 9 | −27.4888 | DD[9] | | | | 17.03 |
| 10(St) | ∞ | 3.2778 | | | | 16.94 |
| *11 | 31.5236 | 3.2475 | 1.85135 | 40.10 | M-TAFD305.HOYA | 19.32 |
| *12 | −526.2787 | 0.2000 | | | | 19.33 |
| 13 | 20.7709 | 4.5519 | 1.48749 | 70.24 | S-FSL5.OHARA | 19.13 |
| 14 | 15.7583 | 3.7615 | | | | 17.31 |
| 15 | 25.2241 | 5.4822 | 1.43875 | 94.66 | S-FPL55.OHARA | 17.46 |
| 16 | −15.5477 | 0.4697 | 1.75520 | 27.51 | S-TIH4.OHARA | 17.22 |
| 17 | 68.9645 | 1.1703 | | | | 17.55 |
| *18 | 103.8673 | 2.1146 | 1.53409 | 55.87 | plastic | 17.66 |
| *19 | −30.5462 | 0.0502 | | | | 18.00 |
| 20 | 43.3875 | 5.1200 | 1.59522 | 67.73 | S-FPM2.OHARA | 20.00 |
| 21 | −21.5801 | DD[21] | | | | 20.44 |
| 22 | 34.6419 | 0.7688 | 2.00266 | 31.67 | N200.GLASS | 19.48 |
| 23 | 19.3563 | DD[23] | | | | 18.85 |
| 24 | −31.8028 | 0.5620 | 1.65160 | 58.54 | S-LAL7Q.OHARA | 20.58 |
| 25 | 24.7313 | 4.9069 | 1.84666 | 23.78 | S-TIH53W.OHARA | 23.18 |
| 26 | −117.6594 | DD[26] | | | | 23.62 |

TABLE 11
Example 4

| | Wide | Middle | Tele |
|---|---|---|---|
| Zr | 1.0 | 1.7 | 2.8 |
| f | 16.55 | 28.18 | 46.33 |
| Bf | 10.97 | 17.46 | 28.92 |
| FNo. | 2.89 | 2.89 | 2.89 |
| 2ω[°] | 88.6 | 53.6 | 33.4 |
| DD[2] | 0.050 | 12.766 | 23.972 |
| DD[9] | 12.906 | 3.826 | 0.697 |
| DD[21] | 2.602 | 3.269 | 0.028 |
| DD[23] | 8.719 | 8.052 | 11.293 |
| DD[26] | 10.965 | 17.457 | 28.924 |

TABLE 12
Example 4

| Sn | 5 | 11 | 12 |
|---|---|---|---|
| KA | −6.0398430E+00 | 1.0000000E+00 | 1.0000000E+00 |
| A3 | 3.2345067E−06 | −8.8817842E−20 | 4.4408921E−20 |
| A4 | 6.4493356E−05 | −1.0234459E−05 | −1.3065553E−06 |
| A5 | −4.3040117E−05 | 1.8185294E−06 | −1.5298622E−07 |
| A6 | 8.8873310E−06 | −3.1750602E−07 | −9.7194640E−08 |
| A7 | −5.3474154E−07 | 6.6452621E−09 | 6.2996351E−10 |
| A8 | −1.0682500E−08 | 1.1360051E−09 | 4.0118827E−10 |
| A9 | −1.1627524E−08 | −3.5233417E−11 | 9.1690125E−12 |
| A10 | 3.2672437E−09 | −1.0803523E−12 | −4.7709799E−13 |
| A11 | −2.8148389E−10 | 2.9829863E−14 | −9.4558879E−15 |
| A12 | 8.3052434E−12 | | |

| Sn | 18 | 19 |
|---|---|---|
| KA | 1.0000000E+00 | 1.0000000E+00 |
| A3 | 5.1428126E−04 | 1.0680985E−04 |
| A4 | −1.0942506E−03 | −2.3192583E−04 |
| A5 | 8.2423188E−04 | 1.9217149E−04 |
| A6 | −3.5948455E−04 | −8.8635703E−05 |
| A7 | 9.3310149E−05 | 2.3994750E−05 |
| A8 | −1.4884602E−05 | −3.9706440E−06 |
| A9 | 1.4305855E−06 | 3.9327473E−07 |
| A10 | −7.6142387E−08 | −2.1500340E−08 |
| A11 | 1.7244219E−09 | 4.9853045E−10 |

### Example 5

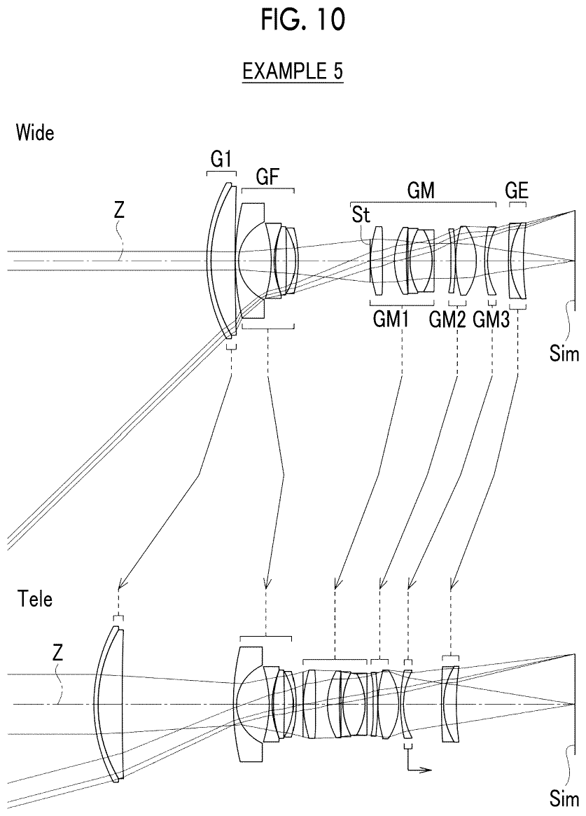

A configuration and a movement trajectory of a variable magnification optical system according to Example 5 are shown in FIG. 10. The variable magnification optical system according to Example 5 consists of, in order from the object side to the image side, a first lens group G1 having a positive refractive power, a front group GF, an intermediate group GM, and a final lens group GE having a negative refractive power. The front group GF consists of one lens group having a negative refractive power. The intermediate group GM consists of, in order from the object side to the image side, three lens groups including a first intermediate lens group GM1 having a positive refractive power, a second intermediate lens group GM2 having a positive refractive power, and a third intermediate lens group GM3 having a negative refractive power.

During changing magnification from the wide angle end to the telephoto end, all lens groups move along the optical axis Z by changing the spacings between the adjacent lens groups. In addition, the first intermediate lens group GM1 and the final lens group GE move on the same trajectory during changing magnification from the wide angle end to the telephoto end. A focusing group consists of the third intermediate lens group GM3. During focusing from the infinite distance object to the nearest object, the focusing group moves to the image side.

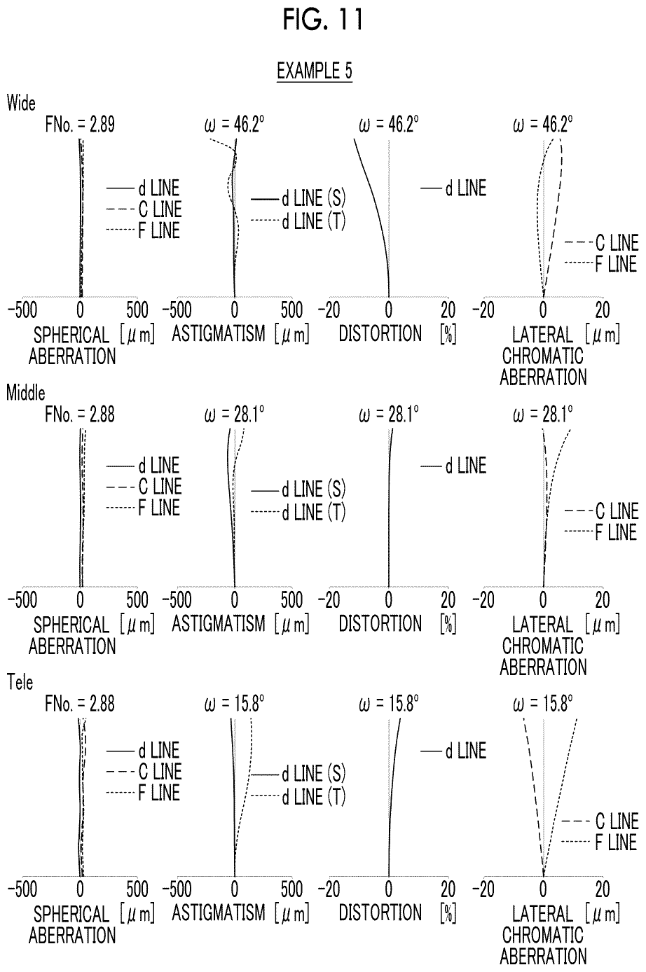

For the variable magnification optical system according to Example 5, basic lens data is shown in Table 13, specifications and variable surface spacings are shown in Table 14, aspherical coefficients are shown in Table 15, and each aberration diagram is shown in FIG. 11.

TABLE 13
Example 5

| Sn | R | D | Nd | νd | Material | ED |
|---|---|---|---|---|---|---|
| 1 | 49.5418 | 1.1036 | 1.80809 | 22.76 | S-NPH1W.OHARA | 44.02 |
| 2 | 43.8361 | 6.3117 | 1.48749 | 70.24 | S-FSL5.OHARA | 42.00 |
| 3 | 705.6825 | DD[3] | | | | 41.31 |
| 4 | 74.3183 | 0.8360 | 1.58913 | 61.13 | S-BAL35.OHARA | 32.42 |
| 5 | 12.3569 | 8.5588 | | | | 21.82 |
| *6 | −29.6731 | 0.7456 | 1.51633 | 64.06 | L-BSL7.OHARA | 21.24 |
| *7 | 25.5001 | 0.3690 | | | | 19.28 |
| 8 | 31.5218 | 2.8553 | 2.00330 | 28.27 | S-LAH79.OHARA | 19.26 |
| 9 | −254.1059 | 2.2855 | | | | 18.66 |
| 10 | −19.4918 | 0.6778 | 1.48749 | 70.24 | S-FSL5.OHARA | 18.51 |
| 11 | −38.0557 | DD[11] | | | | 18.00 |
| 12(St) | ∞ | 0.1212 | | | | 18.28 |
| *13 | 30.2704 | 3.1169 | 1.85135 | 40.10 | M-TAFD305.HOYA | 19.14 |
| *14 | 1102.0058 | 3.1461 | | | | 19.26 |
| 15 | 20.5503 | 3.1254 | 1.60300 | 65.44 | S-PHM53.OHARA | 18.90 |
| 16 | 107.2329 | 0.4319 | | | | 18.39 |
| 17 | 4454.1223 | 0.4987 | 1.72047 | 34.71 | S-NBH8.OHARA | 18.36 |
| 18 | 19.7849 | 5.8197 | 1.43875 | 94.66 | S-FPL55.OHARA | 17.54 |
| 19 | −17.9979 | 0.4994 | 1.85025 | 30.05 | S-NBH57.OHARA | 17.25 |
| 20 | −1286.1067 | DD[20] | | | | 17.51 |
| *21 | 280.3862 | 1.1969 | 1.53409 | 55.87 | plastic | 17.70 |
| *22 | −80.2346 | 0.0865 | | | | 18.03 |
| 23 | 35.3823 | 5.4164 | 1.58913 | 61.13 | S-BAL35.OHARA | 18.80 |
| 24 | −18.6757 | DD[24] | | | | 19.40 |
| 25 | 48.7677 | 0.7587 | 1.90525 | 35.04 | S-LAH93.OHARA | 19.19 |
| 26 | 20.9391 | DD[26] | | | | 18.77 |
| 27 | 187.0959 | 0.5709 | 1.80100 | 34.97 | S-LAM66.OHARA | 20.51 |
| 28 | 21.7816 | 3.3300 | 1.92286 | 18.90 | S-NPH2.OHARA | 21.23 |
| 29 | 83.5843 | DD[29] | | | | 21.41 |

TABLE 14
Example 5

| | Wide | Middle | Tele |
|---|---|---|---|
| Zr | 1.0 | 1.7 | 3.2 |
| f | 15.39 | 26.21 | 48.49 |
| Bf | 13.53 | 19.74 | 31.09 |
| FNo. | 2.89 | 2.88 | 2.88 |
| 2ω[°] | 92.4 | 56.2 | 31.6 |
| DD[3] | 0.077 | 12.762 | 29.123 |
| DD[11] | 18.815 | 8.431 | 1.792 |
| DD[20] | 4.390 | 2.701 | 1.597 |
| DD[24] | 2.158 | 1.758 | 0.490 |
| DD[26] | 5.482 | 7.571 | 9.943 |
| DD[29] | 13.532 | 19.736 | 31.087 |

TABLE 15
Example 5

| Sn | 6 | 7 |
|---|---|---|
| KA | −1.3662052E+00 | −1.8022893E+00 |
| A3 | −5.0398330E−18 | 2.8719711E−18 |
| A4 | 2.1300389E−04 | 1.8868041E−04 |
| A5 | −2.5850626E−05 | −1.3338394E−05 |
| A6 | −3.1915956E−06 | −8.5986353E−06 |
| A7 | 2.9045297E−07 | 1.9695661E−06 |
| A8 | 1.9963252E−07 | −1.5563507E−07 |
| A9 | −4.6009434E−08 | 7.8044144E−10 |
| A10 | 4.2716398E−09 | 6.8818877E−10 |
| A11 | −1.9094535E−10 | −4.9691525E−11 |
| A12 | 3.4226201E−12 | 1.3421861E−12 |
| Sn | 13 | 14 |
| KA | 1.0000000E+00 | 1.0000000E+00 |
| A4 | −2.3955485E−06 | −5.4799697E−06 |
| A6 | −9.2654362E−08 | −9.1392159E−08 |
| A8 | −2.0655264E−10 | −8.5216110E−10 |
| A10 | −6.1812527E−12 | −1.5650381E−12 |
| Sn | 21 | 22 |
| KA | 1.0000000E+00 | 1.0000000E+00 |
| A4 | −1.0872463E−04 | 2.4608621E−06 |
| A6 | −3.7189293E−07 | −4.6585249E−07 |
| A8 | −4.7373578E−09 | 3.0659539E−09 |
| A10 | 4.7032301E−11 | −1.8581900E−11 |
| A12 | 1.0215584E−12 | 9.9519278E−13 |
| A14 | 2.6921538E−14 | 2.2772989E−14 |
| A16 | −5.5418558E−16 | −4.5976236E−16 |
| A18 | 2.4016222E−18 | 1.9644520E−18 |

### Example 6

A configuration and a movement trajectory of a variable magnification optical system according to Example 6 are shown in FIG. 12. The variable magnification optical system according to Example 6 consists of, in order from the object side to the image side, a first lens group G1 having a positive refractive power, a front group GF, an intermediate group GM, and a final lens group GE having a negative refractive power. The front group GF consists of one lens group having a negative refractive power. The intermediate group GM consists of, in order from the object side to the image side, two lens groups including a first intermediate lens group GM1 having a positive refractive power and a second intermediate lens group GM2 having a negative refractive power.

During changing magnification from the wide angle end to the telephoto end, all lens groups move along the optical axis Z by changing the spacings between the adjacent lens groups. In addition, the first intermediate lens group GM1 and the final lens group GE move on the same trajectory during changing magnification from the wide angle end to the telephoto end. The focusing group consists of the second intermediate lens group GM2. During focusing from the infinite distance object to the nearest object, the focusing group moves to the image side. The anti-vibration group consists of a second lens from the object side in the first intermediate lens group GM1.

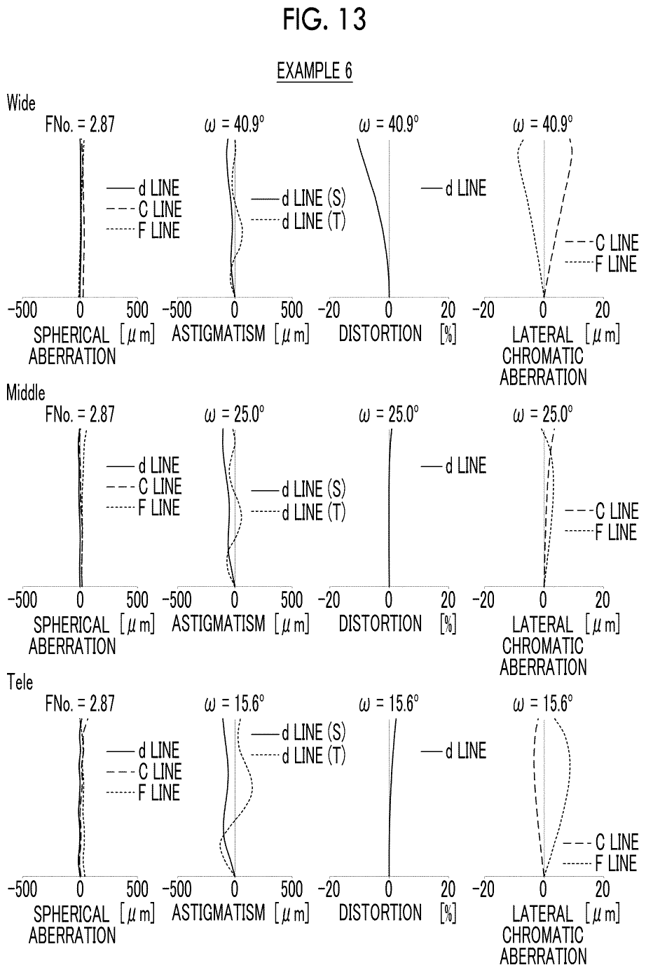

For the variable magnification optical system according to Example 6, basic lens data is shown in Table 16, specifications and variable surface spacings are shown in Table 17, aspherical coefficients are shown in Table 18, and each aberration diagram is shown in FIG. 13.

TABLE 16
Example 6

| Sn | R | D | Nd | νd | Material | ED |
|---|---|---|---|---|---|---|
| 1 | 42.4010 | 5.0071 | 1.52841 | 76.45 | S-FPM4.OHARA | 36.00 |
| 2 | 913.9692 | DD[2] | | | | 35.33 |
| 3 | 44.6037 | 0.7152 | 1.95375 | 32.32 | S-LAH98.OHARA | 27.69 |
| 4 | 14.3708 | 7.1767 | | | | 22.21 |
| 5 | −38.2246 | 1.0578 | 1.53775 | 74.70 | S-FPM3.OHARA | 21.97 |
| 6 | 18.7637 | 5.9190 | 1.90110 | 27.06 | NBFD27.HOYA | 20.59 |
| 7 | 282.6142 | 2.8381 | | | | 20.59 |
| 8 | −19.8176 | 1.0426 | 1.88300 | 39.22 | H-ZLAF68N.CDGM | 19.29 |
| 9 | −28.5561 | DD[9] | | | | 19.12 |
| 10(St) | ∞ | 0.0500 | | | | 19.41 |
| 11 | 26.3598 | 3.1964 | 2.00330 | 28.27 | S-LAH79.OHARA | 19.68 |
| 12 | 350.9756 | 3.2755 | | | | 20.94 |
| *13 | 33.9806 | 4.1681 | 1.43875 | 94.66 | S-FPL55.OHARA | 20.74 |
| *14 | −32.7789 | 1.3828 | | | | 20.35 |
| 15 | −26.3999 | 0.5401 | 2.00100 | 29.13 | TAFD55-W.HOYA | 20.00 |
| 16 | 92.7331 | 0.5695 | | | | 18.08 |
| 17 | 459.2087 | 0.4898 | 1.80518 | 25.46 | FD60-W.HOYA | 18.23 |
| 18 | 18.8174 | 5.8689 | 1.52841 | 76.45 | S-FPM4.OHARA | 18.61 |
| 19 | −24.1150 | 2.0966 | | | | 19.16 |
| *20 | 27.2451 | 2.4917 | 1.51633 | 64.06 | L-BSL7.OHARA | 19.97 |
| *21 | −516.1728 | 0.1559 | | | | 20.00 |
| 22 | 47.2270 | 4.8472 | 1.49700 | 81.54 | S-FPL51.OHARA | 20.11 |
| 23 | −22.1612 | DD[23] | | | | 20.00 |
| 24 | 36.0528 | 0.9562 | 1.75500 | 52.32 | S-LAH97.OHARA | 18.00 |
| 25 | 15.8213 | DD[25] | | | | 17.23 |
| 26 | −27.3059 | 1.0065 | 1.69680 | 55.53 | S-LAL14.OHARA | 19.08 |
| 27 | 21.4213 | 5.2913 | 1.96300 | 24.11 | S-TIH57.OHARA | 22.17 |
| 28 | 864.1575 | DD[28] | | | | 22.75 |

TABLE 17
Example 6

| | Wide | Middle | Tele |
|---|---|---|---|
| Zr | 1.0 | 1.6 | 2.7 |
| f | 18.37 | 30.18 | 49.59 |
| Bf | 10.43 | 15.92 | 26.80 |
| FNo. | 2.87 | 2.87 | 2.87 |
| 2ω[°] | 81.8 | 50.0 | 31.2 |
| DD[2] | 0.325 | 10.803 | 18.191 |
| DD[9] | 16.367 | 6.845 | 1.778 |
| DD[23] | 0.369 | 1.417 | 0.312 |
| DD[25] | 9.146 | 8.098 | 9.203 |
| DD[28] | 10.429 | 15.922 | 26.799 |

TABLE 18
Example 6

| Sn | 13 | 14 | 20 | 21 |
|---|---|---|---|---|
| KA | 7.0814338E+00 | −1.1377188E+00 | 5.8303109E+00 | −1.9998258E+02 |
| A3 | −5.9577598E−18 | −3.2372737E−18 | −9.0420765E−18 | 0.0000000E+00 |
| A4 | −4.6073806E−05 | 5.1469146E−05 | −1.8879242E−05 | 7.5352240E−07 |
| A5 | 5.5774582E−06 | −3.4065262E−05 | −2.5217293E−05 | 2.0091948E−05 |
| A6 | −3.3941687E−06 | 8.8334093E−06 | 9.5095468E−06 | −5.9434043E−06 |
| A7 | −5.9057772E−08 | −2.5863034E−06 | −1.1863449E−06 | 1.3621697E−06 |
| A8 | 2.9790258E−07 | 7.6129289E−07 | −2.4821619E−07 | −3.1472917E−07 |
| A9 | −7.2061162E−08 | −1.4452950E−07 | 1.0113544E−07 | 5.5415001E−08 |
| A10 | 7.7375939E−09 | 1.5448235E−08 | −1.3851474E−08 | −5.9196283E−09 |
| A11 | −3.9991389E−10 | −8.5547175E−10 | 8.8901572E−10 | 3.3300281E−10 |
| A12 | 7.9470740E−12 | 1.9098781E−11 | −2.2675839E−11 | −7.6651752E−12 |

### Example 7

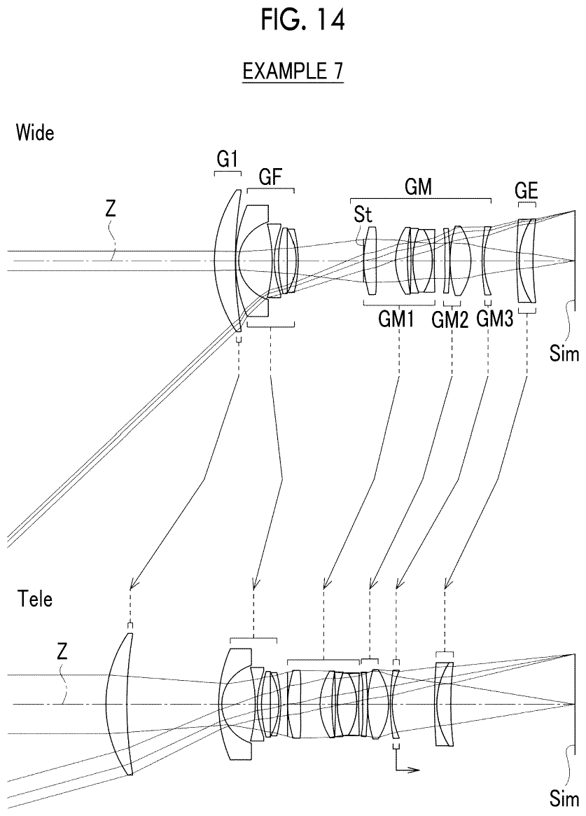

A configuration and a movement trajectory of a variable magnification optical system according to Example 7 are shown in FIG. 14. The variable magnification optical system according to Example 7 consists of, in order from the object side to the image side, a first lens group G1 having a positive refractive power, a front group GF, an intermediate group GM, and a final lens group GE having a positive refractive power. The front group GF consists of one lens group having a negative refractive power. The intermediate group GM consists of, in order from the object side to the image side, three lens groups including a first intermediate lens group GM1 having a positive refractive power, a second intermediate lens group GM2 having a positive refractive power, and a third intermediate lens group GM3 having a negative refractive power.

During changing magnification from the wide angle end to the telephoto end, all lens groups move along the optical axis Z by changing the spacings between the adjacent lens groups. In addition, the second intermediate lens group GM2 and the final lens group GE move on the same trajectory during changing magnification from the wide angle end to the telephoto end. A focusing group consists of the third intermediate lens group GM3. During focusing from the infinite distance object to the nearest object, the focusing group moves to the image side.

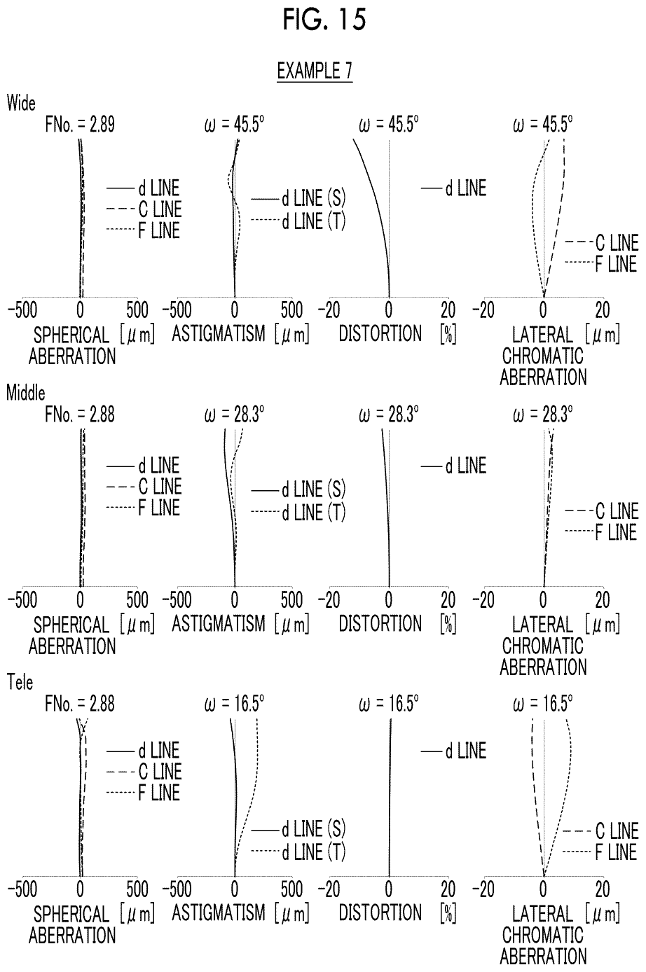

For the variable magnification optical system according to Example 7, basic lens data is shown in Table 19, specifications and variable surface spacings are shown in Table 20, aspherical coefficients are shown in Table 21, and each aberration diagram is shown in FIG. 15.

TABLE 19
Example 7

| Sn | R | D | Nd | νd | Material | ED |
|---|---|---|---|---|---|---|
| 1 | 37.5094 | 5.4758 | 1.49700 | 81.54 | S-FPL51.OHARA | 40.00 |
| 2 | 126.7187 | DD[2] | | | | 39.18 |
| 3 | 41.9207 | 0.8089 | 1.58913 | 61.13 | S-BAL35.OHARA | 31.37 |
| 4 | 11.6839 | 8.7858 | | | | 21.41 |
| *5 | −33.8103 | 0.5399 | 1.51633 | 64.06 | L-BSL7.OHARA | 20.75 |
| *6 | 25.6863 | 1.1055 | | | | 18.85 |
| 7 | 36.6693 | 2.3009 | 2.00330 | 28.27 | S-LAH79.OHARA | 18.53 |
| 8 | −9865.6488 | 2.2134 | | | | 17.95 |
| 9 | −19.7536 | 0.4971 | 1.48749 | 70.24 | S-FSL5.OHARA | 17.84 |
| 10 | −38.9955 | DD[10] | | | | 17.40 |
| 11(St) | ∞ | 0.0498 | | | | 18.06 |
| *12 | 29.7546 | 3.2401 | 1.85135 | 40.10 | M-TAFD305.HOYA | 18.88 |
| *13 | 385.7825 | 5.1124 | | | | 19.09 |
| 14 | 18.4030 | 3.1009 | 1.60300 | 65.44 | S-PHM53.OHARA | 18.83 |
| 15 | 60.5850 | 0.9167 | | | | 18.29 |
| 16 | −247.6755 | 0.4974 | 1.72047 | 34.71 | S-NBH8.OHARA | 18.26 |
| 17 | 27.2811 | 5.1246 | 1.43875 | 94.66 | S-FPL55.OHARA | 17.69 |
| 18 | −18.3293 | 0.4968 | 1.85025 | 30.05 | S-NBH57.OHARA | 17.42 |
| 19 | 289.2941 | DD[19] | | | | 17.73 |
| *20 | 123.7898 | 1.2931 | 1.53409 | 55.87 | plastic | 17.86 |
| *21 | −90.2226 | 0.0556 | | | | 18.19 |
| 22 | 35.5188 | 5.4441 | 1.58913 | 61.13 | S-BAL35.OHARA | 19.00 |
| 23 | −18.9373 | DD[23] | | | | 19.57 |
| 24 | 65.3404 | 0.5012 | 1.90525 | 35.04 | S-LAH93.OHARA | 19.21 |
| 25 | 25.5021 | DD[25] | | | | 19.00 |
| 26 | 152.7017 | 0.6210 | 1.80100 | 34.97 | S-LAM66.OHARA | 22.73 |
| 27 | 22.9977 | 3.6437 | 1.92286 | 18.90 | S-NPH2.OHARA | 23.46 |
| 28 | 99.9693 | DD[28] | | | | 23.59 |

TABLE 20
Example 7

| | Wide | Middle | Tele |
|---|---|---|---|
| Zr | 1.0 | 1.7 | 3.0 |
| f | 15.86 | 27.01 | 47.58 |
| Bf | 10.99 | 18.69 | 32.55 |
| FNo. | 2.89 | 2.88 | 2.88 |
| 2ω[°] | 91.0 | 56.6 | 33.0 |
| DD[2] | 0.075 | 12.239 | 24.063 |
| DD[10] | 17.124 | 7.441 | 1.769 |
| DD[19] | 2.778 | 1.679 | 1.007 |
| DD[23] | 2.955 | 2.878 | 0.473 |
| DD[25] | 8.572 | 8.649 | 11.054 |
| DD[28] | 10.989 | 18.685 | 32.546 |

TABLE 21
Example 7

| Sn | 5 | 6 |
|---|---|---|
| KA | −1.7846178E+00 | −3.1718251E−01 |
| A3 | 3.3598886E−18 | 1.0443531E−18 |
| A4 | 1.9573034E−04 | 1.5641857E−04 |
| A5 | −2.4679203E−05 | −1.4732417E−05 |
| A6 | −2.8059203E−06 | −7.6476196E−06 |
| A7 | 2.7692046E−07 | 1.9516563E−06 |
| A8 | 1.9395011E−07 | −1.6960548E−07 |
| A9 | −4.5965982E−08 | 9.7868475E−10 |
| A10 | 4.3214613E−09 | 8.0267791E−10 |
| A11 | −1.9116595E−10 | −5.0335916E−11 |
| A12 | 3.2706383E−12 | 9.5301210E−13 |
| Sn | 12 | 13 |
| KA | 1.0000000E+00 | 1.0000000E+00 |
| A4 | −3.5194204E−06 | −7.9400733E−06 |
| A6 | −1.3062351E−07 | −1.4551861E−07 |
| A8 | −4.4388034E−10 | −1.0673008E−09 |
| A10 | −8.1371689E−12 | −2.8466416E−12 |
| Sn | 20 | 21 |
| KA | 1.0000000E+00 | 1.0000000E+00 |
| A4 | −1.0533072E−04 | 1.1019852E−05 |
| A6 | −4.0921793E−07 | −5.2610596E−07 |
| A8 | −5.1857323E−09 | 3.1832966E−09 |
| A10 | 7.2377476E−11 | −2.8770818E−11 |
| A12 | 8.8946962E−13 | 1.3216223E−12 |
| A14 | 2.5694233E−14 | 2.1315704E−14 |
| A16 | −5.3493689E−16 | −4.7839797E−16 |
| A18 | 2.3089511E−18 | 2.0914284E−18 |

### Example 8

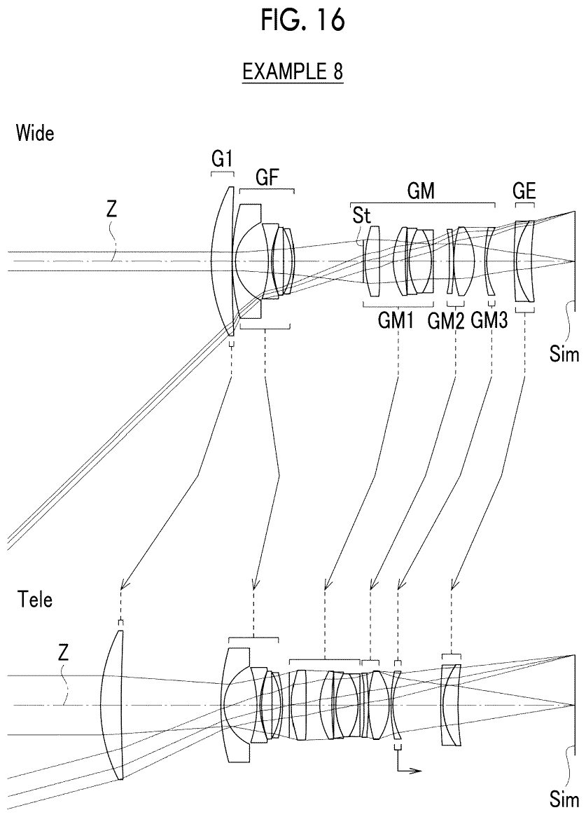

A configuration and a movement trajectory of a variable magnification optical system according to Example 8 are shown in FIG. 16. The variable magnification optical system according to Example 8 consists of, in order from the object side to the image side, a first lens group G1 having a positive refractive power, a front group GF, an intermediate group GM, and a final lens group GE having a positive refractive power. The front group GF consists of one lens group having a negative refractive power. The intermediate group GM consists of, in order from the object side to the image side, three lens groups including a first intermediate lens group GM1 having a positive refractive power, a second intermediate lens group GM2 having a positive refractive power, and a third intermediate lens group GM3 having a negative refractive power.

During changing magnification from the wide angle end to the telephoto end, all lens groups move along the optical axis Z by changing the spacings between the adjacent lens groups. In addition, the first intermediate lens group GM1 and the final lens group GE move on the same trajectory during changing magnification from the wide angle end to the telephoto end. A focusing group consists of the third intermediate lens group GM3. During focusing from the infinite distance object to the nearest object, the focusing group moves to the image side.

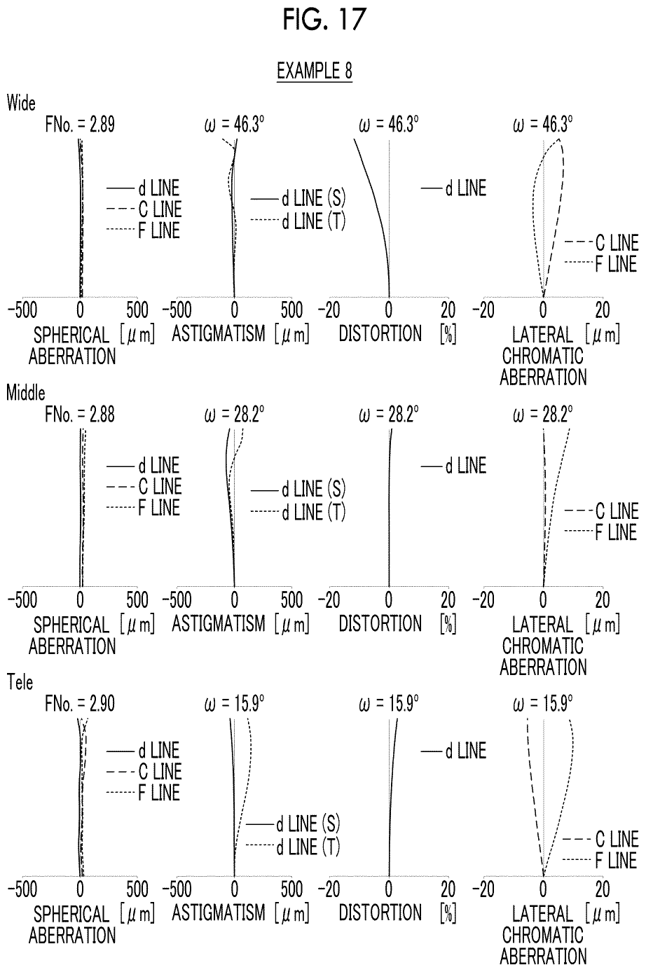

For the variable magnification optical system according to Example 8, basic lens data is shown in Table 22, specifications and variable surface spacings are shown in Table 23, aspherical coefficients are shown in Table 24, and each aberration diagram is shown in FIG. 17.

TABLE 22
Example 8

| Sn | R | D | Nd | νd | Material | ED |
|---|---|---|---|---|---|---|
| 1 | 49.1862 | 5.4480 | 1.49700 | 81.54 | S-FPL51.OHARA | 42.00 |
| 2 | 464.6956 | DD[2] | | | | 41.31 |
| 3 | 63.1802 | 0.8287 | 1.58913 | 61.13 | S-BAL35.OHARA | 32.14 |
| 4 | 12.3914 | 8.6309 | | | | 21.82 |
| *5 | −28.0435 | 0.8003 | 1.51633 | 64.06 | L-BSL7.OHARA | 21.20 |
| *6 | 25.4334 | 0.4190 | | | | 19.15 |
| 7 | 31.8838 | 2.7259 | 2.00330 | 28.27 | S-LAH79.OHARA | 19.14 |
| 8 | −466.6792 | 2.2511 | | | | 18.56 |
| 9 | −20.1021 | 0.4994 | 1.48749 | 70.24 | S-FSL5.OHARA | 18.43 |
| 10 | −38.5461 | DD[10] | | | | 18.00 |
| 11(St) | ∞ | 0.4811 | | | | 18.54 |
| *12 | 29.8679 | 3.7654 | 1.85135 | 40.10 | M-TAFD305.HOYA | 19.59 |
| *13 | 1413.0110 | 3.6160 | | | | 19.73 |
| 14 | 20.4586 | 3.1476 | 1.60300 | 65.44 | S-PHM53.OHARA | 19.18 |
| 15 | 98.0396 | 0.5044 | | | | 18.66 |
| 16 | −3032.3439 | 0.4981 | 1.72047 | 34.71 | S-NBH8.OHARA | 18.63 |
| 17 | 20.6414 | 5.8398 | 1.43875 | 94.66 | S-FPL55.OHARA | 17.79 |
| 18 | −17.9021 | 0.4978 | 1.85025 | 30.05 | S-NBH57.OHARA | 17.46 |
| 19 | −6676.4996 | DD[19] | | | | 17.71 |
| *20 | 293.0790 | 1.1427 | 1.53409 | 55.87 | plastic | 17.79 |
| *21 | −89.1660 | 0.0500 | | | | 18.10 |
| 22 | 35.5291 | 5.3987 | 1.58913 | 61.13 | S-BAL35.OHARA | 18.80 |
| 23 | −18.6756 | DD[23] | | | | 19.35 |
| 24 | 50.2869 | 0.4999 | 1.90525 | 35.04 | S-LAH93.OHARA | 19.14 |
| 25 | 21.5497 | DD[25] | | | | 18.80 |
| 26 | 165.8469 | 0.6034 | 1.80100 | 34.97 | S-LAM66.OHARA | 21.80 |
| 27 | 20.6157 | 3.9205 | 1.92286 | 18.90 | S-NPH2.OHARA | 22.67 |
| 28 | 88.8791 | DD[28] | | | | 22.84 |

TABLE 23
Example 8

| | Wide | Middle | Tele |
|---|---|---|---|
| Zr | 1.0 | 1.7 | 3.2 |
| f | 15.40 | 26.23 | 48.52 |
| Bf | 11.42 | 17.55 | 30.65 |
| FNo. | 2.89 | 2.88 | 2.90 |
| 2ω[°] | 92.6 | 56.4 | 31.8 |
| DD[2] | 0.066 | 12.626 | 26.075 |
| DD[10] | 18.024 | 8.137 | 1.784 |
| DD[19] | 4.164 | 2.402 | 1.076 |
| DD[23] | 2.715 | 2.359 | 0.471 |
| DD[25] | 7.193 | 9.311 | 12.525 |
| DD[28] | 11.417 | 17.554 | 30.650 |

TABLE 24
Example 8

| Sn | 5 | 6 |
|---|---|---|
| KA | −2.2145959E+00 | −1.0528212E+00 |
| A3 | −3.6958775E−17 | −1.8276180E−18 |
| A4 | 2.1763686E−04 | 1.9525648E−04 |
| A5 | −2.6329637E−05 | −1.3983713E−05 |
| A6 | −3.3418556E−06 | −8.7332189E−06 |
| A7 | 2.8567310E−07 | 1.9768957E−06 |
| A8 | 2.0170873E−07 | −1.5484459E−07 |
| A9 | −4.5952636E−08 | 7.2282417E−10 |
| A10 | 4.2582463E−09 | 6.9044071E−10 |
| A11 | −1.9114118E−10 | −4.9488019E−11 |
| A12 | 3.4548155E−12 | 1.3205290E−12 |
| Sn | 12 | 13 |
| KA | 1.0000000E+00 | 1.0000000E+00 |
| A4 | −2.9371473E−06 | −5.2342286E−06 |
| A6 | −1.0282673E−07 | −1.1229424E−07 |
| A8 | −1.6438239E−10 | −7.0766185E−10 |
| A10 | −5.2373516E−12 | −1.1548421E−12 |
| Sn | 20 | 21 |
| KA | 1.0000000E+00 | 1.0000000E+00 |
| A4 | −1.0920710E−04 | −2.5237230E−08 |
| A6 | −3.7793231E−07 | −4.5610829E−07 |
| A8 | −4.8232609E−09 | 2.8336969E−09 |
| A10 | 4.8230331E−11 | −1.7345278E−11 |
| A12 | 1.0482979E−12 | 1.0039192E−12 |
| A14 | 2.6905779E−14 | 2.2892711E−14 |
| A16 | −5.5999557E−16 | −4.6193235E−16 |
| A18 | 2.4160698E−18 | 1.9526837E−18 |

### Example 9

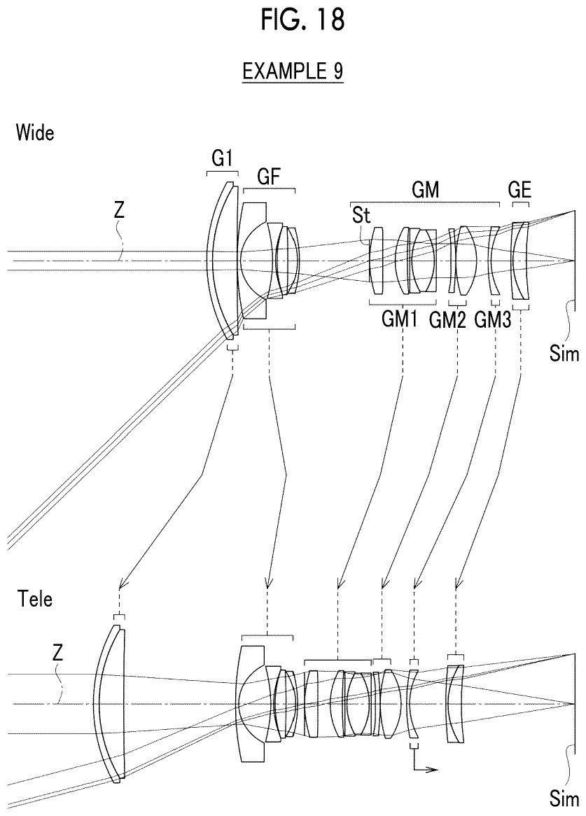

A configuration and a movement trajectory of a variable magnification optical system according to Example 9 are shown in FIG. 18. The variable magnification optical system according to Example 9 consists of, in order from the object side to the image side, a first lens group G1 having a positive refractive power, a front group GF, an intermediate group GM, and a final lens group GE having a positive refractive power. The front group GF consists of one lens group having a negative refractive power. The intermediate group GM consists of, in order from the object side to the image side, three lens groups including a first intermediate lens group GM1 having a positive refractive power, a second intermediate lens group GM2 having a positive refractive power, and a third intermediate lens group GM3 having a negative refractive power.

During changing magnification from the wide angle end to the telephoto end, all lens groups move along the optical axis Z by changing the spacings between the adjacent lens groups. In addition, the first intermediate lens group GM1 and the final lens group GE move on the same trajectory during changing magnification from the wide angle end to the telephoto end. A focusing group consists of the third intermediate lens group GM3. During focusing from the infinite distance object to the nearest object, the focusing group moves to the image side.

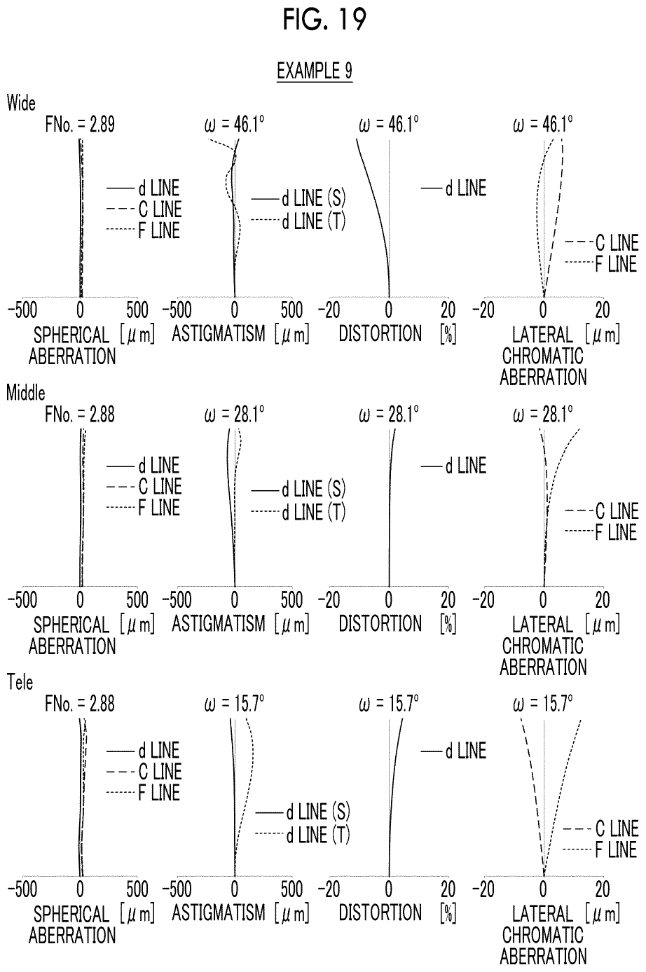

For the variable magnification optical system according to Example 9, basic lens data is shown in Table 25, specifications and variable surface spacings are shown in Table 26, aspherical coefficients are shown in Table 27, and each aberration diagram is shown in FIG. 19.

TABLE 25
Example 9

| Sn | R | D | Nd | νd | Material | ED |
|---|---|---|---|---|---|---|
| 1 | 48.9196 | 1.5002 | 1.80809 | 22.76 | S-NPH1W.OHARA | 42.00 |
| 2 | 43.3271 | 6.4342 | 1.48749 | 70.24 | S-FSL5.OHARA | 32.14 |
| 3 | 821.2150 | DD[3] | | | | 21.82 |
| 4 | 83.5442 | 0.8434 | 1.58913 | 61.13 | S-BAL35.OHARA | 21.20 |
| 5 | 12.4036 | 8.4000 | | | | 19.15 |
| *6 | −31.7271 | 0.7599 | 1.51633 | 64.06 | L-BSL7.OHARA | 19.14 |
| *7 | 25.4420 | 0.3933 | | | | 18.56 |
| 8 | 32.1953 | 2.8205 | 2.00330 | 28.27 | S-LAH79.OHARA | 18.43 |
| 9 | −256.0358 | 2.4166 | | | | 18.00 |
| 10 | −18.5715 | 0.5002 | 1.48749 | 70.24 | S-FSL5.OHARA | 18.54 |
| 11 | −36.3678 | DD[11] | | | | 19.59 |
| 12(St) | ∞ | 0.0501 | | | | 19.73 |
| *13 | 30.4856 | 3.4522 | 1.85135 | 40.10 | M-TAFD305.HOYA | 19.18 |
| *14 | 1136.6581 | 3.2485 | | | | 18.66 |
| 15 | 20.3995 | 3.1670 | 1.60300 | 65.44 | S-PHM53.OHARA | 18.63 |
| 16 | 117.5382 | 0.6541 | | | | 17.80 |
| 17 | 4042.6413 | 0.5355 | 1.72047 | 34.71 | S-NBH8.OHARA | 17.79 |
| 18 | 18.8450 | 5.8903 | 1.43875 | 94.66 | S-FPL55.OHARA | 17.46 |
| 19 | −18.0073 | 0.4987 | 1.85025 | 30.05 | S-NBH57.OHARA | 17.79 |
| 20 | −1639.5878 | DD[20] | | | | 18.10 |
| *21 | 289.8026 | 1.2561 | 1.53409 | 55.87 | plastic | 18.80 |
| *22 | −87.8769 | 0.0675 | | | | 19.35 |
| 23 | 36.0586 | 5.4351 | 1.58913 | 61.13 | S-BAL35.OHARA | 19.14 |
| 24 | −18.5823 | DD[24] | | | | 18.80 |
| 25 | 52.2171 | 0.7982 | 1.90525 | 35.04 | S-LAH93.OHARA | 21.80 |
| 26 | 20.8565 | DD[26] | | | | 22.67 |
| 27 | 113.5228 | 0.5784 | 1.80100 | 34.97 | S-LAM66.OHARA | 22.67 |
| 28 | 21.7886 | 3.4915 | 1.92286 | 18.90 | S-NPH2.OHARA | 25.62 |
| 29 | 91.8429 | DD[29] | | | | 25.62 |

TABLE 26
Example 9

| | Wide | Middle | Tele |
|---|---|---|---|
| Zr | 1.0 | 1.7 | 3.2 |
| f | 15.35 | 26.14 | 48.35 |
| Bf | 12.74 | 18.62 | 29.76 |
| FNo. | 2.89 | 2.88 | 2.88 |
| 2ω[°] | 92.2 | 56.2 | 31.4 |
| DD[3] | 0.069 | 12.620 | 29.287 |
| DD[11] | 18.333 | 7.934 | 1.787 |
| DD[20] | 3.825 | 2.162 | 1.058 |
| DD[24] | 2.987 | 3.038 | 1.445 |
| DD[26] | 5.173 | 6.785 | 9.482 |
| DD[29] | 12.742 | 18.620 | 29.761 |

TABLE 27
Example 9

| Sn | 6 | 7 |
|---|---|---|
| KA | −1.8307254E+00 | −1.6002122E+00 |
| A3 | −2.5199165E−17 | 7.8326484E−19 |
| A4 | 2.0611905E−04 | 1.7805397E−04 |
| A5 | −2.5821488E−05 | −1.3584596E−05 |
| A6 | −2.8946647E−06 | −8.2015924E−06 |
| A7 | 2.8447027E−07 | 1.9696181E−06 |
| A8 | 1.9589451E−07 | −1.6246609E−07 |
| A9 | −4.5937160E−08 | 7.7958813E−10 |
| A10 | 4.2949330E−09 | 7.4810697E−10 |
| A11 | −1.9115839E−10 | −4.9760579E−11 |
| A12 | 3.3655871E−12 | 1.1387443E−12 |
| Sn | 13 | 14 |
| KA | 1.0000000E+00 | 1.0000000E+00 |
| A4 | −3.2928049E−06 | −5.7698977E−06 |
| A6 | −1.0024964E−07 | −1.0237968E−07 |
| A8 | −2.7523683E−10 | −8.8122091E−10 |
| A10 | −6.3928099E−12 | −1.8474705E−12 |
| Sn | 21 | 22 |
| KA | 1.0000000E+00 | 1.0000000E+00 |
| A4 | −1.0899293E−04 | 2.0205279E−06 |
| A6 | −3.7643902E−07 | −4.8248460E−07 |
| A8 | −4.9638507E−09 | 3.5662786E−09 |
| A10 | 5.3626172E−11 | −3.0233547E−11 |
| A12 | 9.2231768E−13 | 1.0997963E−12 |
| A14 | 2.6220769E−14 | 2.1682624E−14 |
| A16 | −5.4976500E−16 | −4.6394176E−16 |
| A18 | 2.4515469E−18 | 2.0567352E−18 |

### Example 10

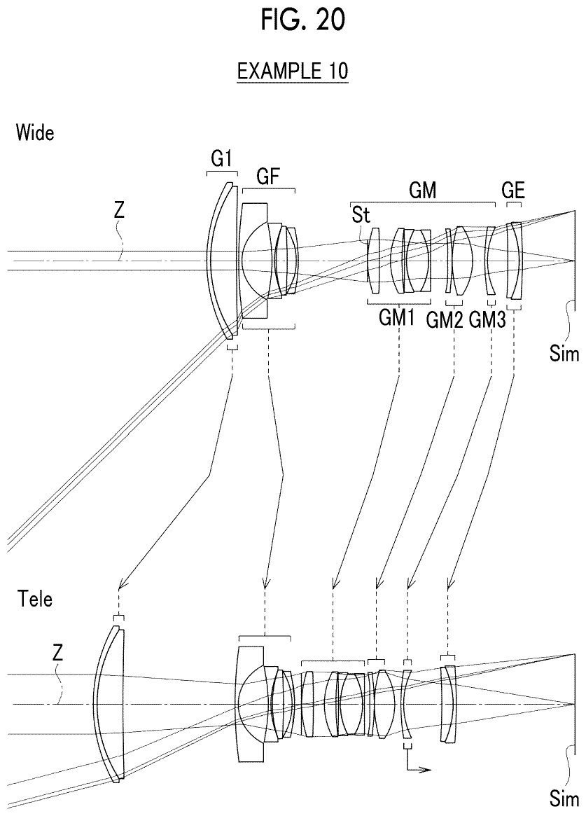

A configuration and a movement trajectory of a variable magnification optical system according to Example 10 are shown in FIG. 20. The variable magnification optical system according to Example 10 consists of, in order from the object side to the image side, a first lens group G1 having a positive refractive power, a front group GF, an intermediate group GM, and a final lens group GE having a positive refractive power. The front group GF consists of one lens group having a negative refractive power. The intermediate group GM consists of, in order from the object side to the image side, three lens groups including a first intermediate lens group GM1 having a positive refractive power, a second intermediate lens group GM2 having a positive refractive power, and a third intermediate lens group GM3 having a negative refractive power.

During changing magnification from the wide angle end to the telephoto end, all lens groups move along the optical axis Z by changing the spacings between the adjacent lens groups. In addition, the first intermediate lens group GM1 and the final lens group GE move on the same trajectory during changing magnification from the wide angle end to the telephoto end. A focusing group consists of the third intermediate lens group GM3. During focusing from the infinite distance object to the nearest object, the focusing group moves to the image side.

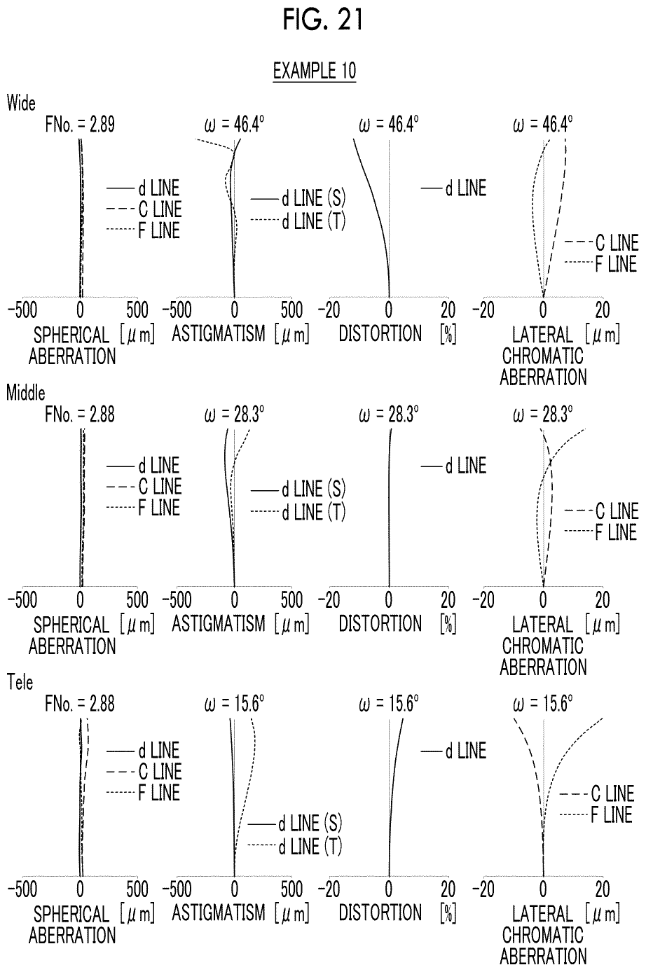

For the variable magnification optical system according to Example 10, basic lens data is shown in Table 28, specifications and variable surface spacings are shown in Table 29, aspherical coefficients are shown in Table 30, and each aberration diagram is shown in FIG. 21.

TABLE 28
Example 10

| Sn | R | D | Nd | νd | Material | ED |
|---|---|---|---|---|---|---|
| 1 | 48.5041 | 1.0094 | 1.84666 | 23.78 | S-TIH53W.OHARA | 44.22 |
| 2 | 41.2025 | 6.7868 | 1.51680 | 64.20 | BSC7.HOYA | 42.00 |
| 3 | 827.8368 | DD[3] | | | | 41.29 |
| 4 | 128.8749 | 0.8375 | 1.58913 | 61.13 | S-BAL35.OHARA | 32.52 |
| 5 | 12.4759 | 7.8721 | | | | 21.74 |
| *6 | −36.7133 | 0.6700 | 1.51633 | 64.06 | L-BSL7.OHARA | 21.28 |
| *7 | 24.9868 | 0.4145 | | | | 19.39 |
| 8 | 32.4815 | 2.8744 | 2.00330 | 28.27 | S-LAH79.OHARA | 19.37 |
| 9 | −194.0593 | 2.2696 | | | | 18.74 |
| 10 | −19.2731 | 0.5007 | 1.48749 | 70.24 | S-FSL5.OHARA | 18.59 |
| 11 | −46.4494 | DD[11] | | | | 18.00 |
| 12(St) | ∞ | 0.0499 | | | | 17.47 |
| *13 | 30.1641 | 3.0622 | 1.85135 | 40.10 | M-TAFD305.HOYA | 18.31 |
| *14 | −715.2546 | 2.9093 | | | | 18.43 |
| 15 | 20.9309 | 3.0275 | 1.60300 | 65.44 | S-PHM53.OHARA | 18.32 |
| 16 | 77.7488 | 0.6577 | | | | 17.79 |
| 17 | −448.3655 | 0.4990 | 1.72047 | 34.71 | S-NBH8.OHARA | 17.76 |
| 18 | 19.8274 | 5.8296 | 1.43875 | 94.66 | S-FPL55.OHARA | 17.16 |
| 19 | −18.5287 | 0.4979 | 1.85025 | 30.05 | S-NBH57.OHARA | 16.97 |
| 20 | −145740.7137 | DD[20] | | | | 17.35 |
| *21 | 277.3218 | 1.1664 | 1.53409 | 55.87 | plastic | 17.60 |
| *22 | −69.7257 | 0.0498 | | | | 17.93 |
| 23 | 35.1114 | 5.3160 | 1.58913 | 61.13 | S-BAL35.OHARA | 18.80 |
| 24 | −18.7740 | DD[24] | | | | 19.32 |
| 25 | 62.1860 | 0.7178 | 1.90525 | 35.04 | S-LAH93.OHARA | 19.12 |
| 26 | 22.6907 | DD[26] | | | | 18.80 |
| 27 | −180.1704 | 2.9498 | 1.92286 | 18.90 | S-NPH2.OHARA | 20.52 |
| 28 | −27.7406 | 0.8314 | 1.80100 | 34.97 | S-LAM66.OHARA | 20.94 |
| 29 | −163.3520 | DD[29] | | | | 21.73 |

TABLE 29
Example 10

| | Wide | Middle | Tele |
|---|---|---|---|
| Zr | 1.0 | 1.7 | 3.2 |
| f | 15.39 | 26.20 | 48.47 |
| Bf | 13.80 | 20.62 | 31.12 |
| FNo. | 2.89 | 2.88 | 2.88 |
| 2ω[°] | 92.8 | 56.6 | 31.2 |
| DD[3] | 0.587 | 10.427 | 29.348 |
| DD[11] | 18.145 | 7.454 | 1.795 |
| DD[20] | 4.460 | 2.539 | 1.389 |
| DD[24] | 3.200 | 3.086 | 1.610 |
| DD[26] | 5.342 | 7.377 | 10.003 |
| DD[29] | 13.798 | 20.619 | 31.116 |

TABLE 30
Example 10

| Sn | 6 | 7 |
|---|---|---|
| KA | −2.1539901E+00 | −2.6299730E+00 |
| A3 | −2.5199165E−17 | 1.3054414E−18 |
| A4 | 2.0374261E−04 | 1.8341885E−04 |
| A5 | −2.4021335E−05 | −1.3239961E−05 |
| A6 | −3.1424505E−06 | −8.3649112E−06 |
| A7 | 2.7480900E−07 | 1.9768528E−06 |
| A8 | 1.9991342E−07 | −1.6063781E−07 |
| A9 | −4.5906157E−08 | 7.2181281E−10 |
| A10 | 4.2672072E−09 | 7.3598199E−10 |
| A11 | −1.9119943E−10 | −4.9645126E−11 |
| A12 | 3.4401360E−12 | 1.1706468E−12 |
| Sn | 13 | 14 |
| KA | 1.0000000E+00 | 1.0000000E+00 |
| A4 | −1.9163188E−06 | −4.0255197E−06 |
| A6 | −9.2232489E−08 | −9.0722933E−08 |
| A8 | −4.1035167E−11 | −6.0357377E−10 |
| A10 | −6.3170218E−12 | −2.0747931E−12 |
| Sn | 21 | 22 |
| KA | 1.0000000E+00 | 1.0000000E+00 |
| A4 | −1.0210740E−04 | 3.3648783E−06 |
| A6 | −3.5394803E−07 | −4.1928664E−07 |
| A8 | −5.0282058E−09 | 1.7974455E−09 |
| A10 | 3.6831653E−11 | −2.9750820E−11 |
| A12 | 1.1212817E−12 | 1.4066786E−12 |
| A14 | 2.9406315E−14 | 2.1258870E−14 |
| A16 | −5.4375225E−16 | −4.4460465E−16 |
| A18 | 2.0827720E−18 | 1.7674448E−18 |

### Example 11

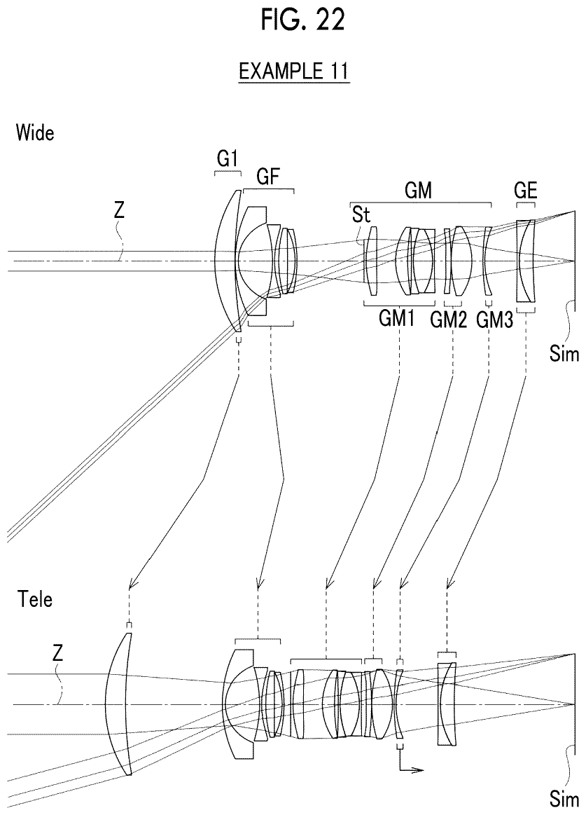

A configuration and a movement trajectory of a variable magnification optical system according to Example 11 are shown in FIG. 22. The variable magnification optical system according to Example 11 consists of, in order from the object side to the image side, a first lens group G1 having a positive refractive power, a front group GF, an intermediate group GM, and a final lens group GE having a negative refractive power. The front group GF consists of one lens group having a negative refractive power. The intermediate group GM consists of, in order from the object side to the image side, three lens groups including a first intermediate lens group GM1 having a positive refractive power, a second intermediate lens group GM2 having a positive refractive power, and a third intermediate lens group GM3 having a negative refractive power.

During changing magnification from the wide angle end to the telephoto end, all lens groups move along the optical axis Z by changing the spacings between the adjacent lens groups. In addition, the second intermediate lens group GM2 and the final lens group GE move on the same trajectory during changing magnification from the wide angle end to the telephoto end. A focusing group consists of the third intermediate lens group GM3. During focusing from the infinite distance object to the nearest object, the focusing group moves to the image side.

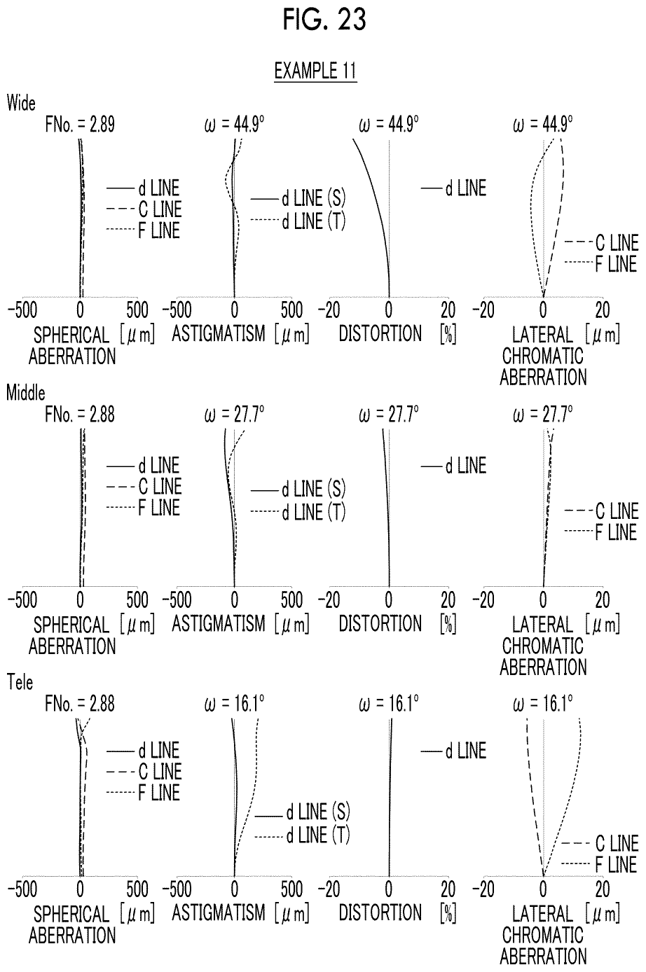

For the variable magnification optical system according to Example 11, basic lens data is shown in Table 31, specifications and variable surface spacings are shown in Table 32, aspherical coefficients are shown in Table 33, and each aberration diagram is shown in FIG. 23.

TABLE 31
Example 11

| Sn | R | D | Nd | νd | Material | ED |
|---|---|---|---|---|---|---|
| 1 | 38.1789 | 5.3078 | 1.49700 | 81.54 | S-FPL51.OHARA | 40.00 |
| 2 | 123.4694 | DD[2] | | | | 39.20 |
| 3 | 36.6577 | 0.7931 | 1.58913 | 61.13 | S-BAL35.OHARA | 30.73 |
| 4 | 11.6282 | 8.9743 | | | | 21.32 |
| *5 | −31.6462 | 0.5370 | 1.51633 | 64.06 | L-BSL7.OHARA | 20.62 |
| *6 | 27.8097 | 1.0810 | | | | 18.85 |
| 7 | 38.5307 | 2.2655 | 2.00330 | 28.27 | S-LAH79.OHARA | 18.50 |
| 8 | −1326.9963 | 2.0195 | | | | 17.94 |
| 9 | −21.2795 | 0.4973 | 1.48749 | 70.24 | S-FSL5.OHARA | 17.84 |
| 10 | −40.9981 | DD[10] | | | | 17.40 |
| 11(St) | ∞ | 0.5948 | | | | 18.09 |
| *12 | 30.3353 | 2.7357 | 1.85135 | 40.10 | M-TAFD305.HOYA | 19.16 |
| *13 | 239.2697 | 4.9670 | | | | 19.31 |
| 14 | 18.0850 | 3.1834 | 1.60300 | 65.44 | S-PHM53.OHARA | 19.11 |
| 15 | 58.1928 | 0.9751 | | | | 18.55 |
| 16 | −229.3229 | 0.4961 | 1.72047 | 34.71 | S-NBH8.OHARA | 18.52 |
| 17 | 28.1973 | 5.0465 | 1.43875 | 94.66 | S-FPL55.OHARA | 17.93 |
| 18 | −19.1906 | 0.4965 | 1.85025 | 30.05 | S-NBH57.OHARA | 17.64 |
| 19 | 365.0496 | DD[19] | | | | 17.85 |
| *20 | 141.5379 | 1.4043 | 1.53409 | 55.87 | plastic | 18.00 |
| *21 | −74.7629 | 0.0500 | | | | 18.30 |
| 22 | 36.3212 | 5.4073 | 1.58913 | 61.13 | S-BAL35.OHARA | 19.00 |
| 23 | −18.8933 | DD[23] | | | | 19.55 |
| 24 | 64.0212 | 0.5010 | 1.90525 | 35.04 | S-LAH93.OHARA | 19.25 |
| 25 | 25.3651 | DD[25] | | | | 19.00 |
| 26 | −885.0940 | 0.6090 | 1.80100 | 34.97 | S-LAM66.OHARA | 22.03 |
| 27 | 23.7440 | 3.6276 | 1.92286 | 18.90 | S-NPH2.OHARA | 23.00 |
| 28 | 144.9335 | DD[28] | | | | 23.19 |

TABLE 32
Example 11

| | Wide | Middle | Tele |
|---|---|---|---|
| Zr | 1.0 | 1.7 | 3.0 |
| f | 16.21 | 27.60 | 48.62 |
| Bf | 10.97 | 18.46 | 31.66 |
| FNo. | 2.89 | 2.88 | 2.88 |
| 2ω[°] | 89.8 | 55.4 | 32.2 |
| DD[2] | 0.075 | 12.728 | 25.248 |
| DD[10] | 17.560 | 7.615 | 1.758 |
| DD[19] | 2.809 | 1.837 | 1.303 |
| DD[23] | 2.893 | 2.666 | 0.456 |
| DD[25] | 8.442 | 8.669 | 10.879 |
| DD[28] | 10.967 | 18.464 | 31.663 |

TABLE 33
Example 11

| Sn | 5 | 6 |
|---|---|---|
| KA | −1.8357902E+00 | 1.6853884E−01 |
| A3 | 3.6958775E−17 | 5.2217656E−19 |
| A4 | 1.6022310E−04 | 1.2217164E−04 |
| A5 | −1.9714581E−05 | −1.0371265E−05 |
| A6 | −2.5986212E−06 | −7.2897110E−06 |
| A7 | 1.6125199E−07 | 1.8131288E−06 |
| A8 | 1.9980878E−07 | −1.6363601E−07 |
| A9 | −4.5212279E−08 | 2.3218748E−09 |
| A10 | 4.2531509E−09 | 6.8690563E−10 |
| A11 | −1.9254614E−10 | −5.4636573E−11 |
| A12 | 3.4620192E−12 | 1.4606144E−12 |

| Sn | 12 | 13 | 20 | 21 |
|---|---|---|---|---|
| KA | 1.0000000E+00 | 1.0000000E+00 | 1.0000000E+00 | 1.0000000E+00 |
| A4 | −2.4951128E−06 | −6.8147631E−06 | −1.0684101E−04 | 1.0781462E−05 |
| A6 | −1.3275959E−07 | −1.4195464E−07 | −3.9369076E−07 | −4.9475653E−07 |
| A8 | −4.7106729E−10 | −1.1782880E−09 | −5.1135473E−09 | 3.1250660E−09 |
| A10 | −8.5889241E−12 | −3.3235986E−12 | 6.8998394E−11 | −2.9872337E−11 |
| A12 | 1.9393044E−16 | 1.0252307E−15 | 8.5567051E−13 | 1.2908649E−12 |
| A14 | −4.7795800E−19 | 4.0422477E−17 | 2.5809172E−14 | 2.1253488E−14 |
| A16 | −6.8561769E−20 | 6.5665622E−19 | −5.3680024E−16 | −4.8140429E−16 |
| A18 | 1.1029196E−21 | −1.6500624E−20 | 2.3703957E−18 | 2.1628829E−18 |
| A20 | 1.1242278E−23 | 8.9704597E−23 | 0.0000000E+00 | 0.0000000E+00 |

### Example 12

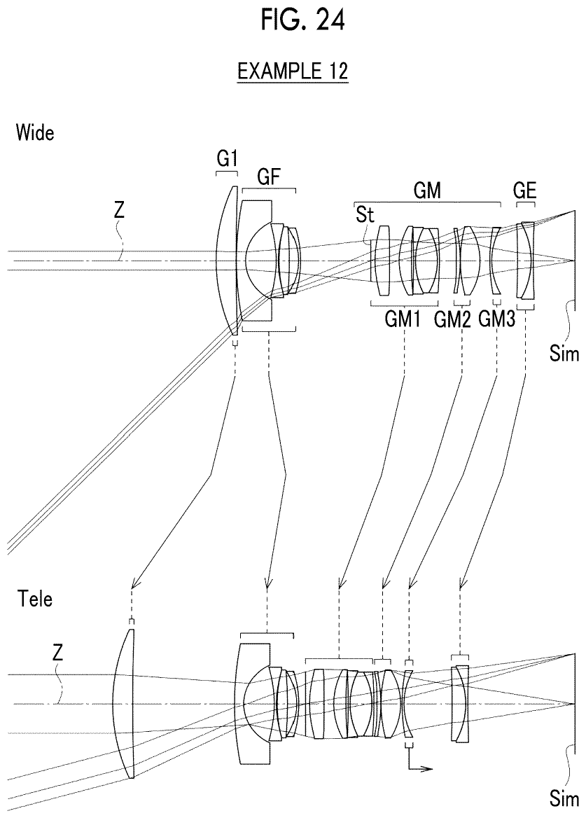

A configuration and a movement trajectory of a variable magnification optical system according to Example 12 are shown in FIG. 24. The variable magnification optical system according to Example 12 consists of, in order from the object side to the image side, a first lens group G1 having a positive refractive power, a front group GF, an intermediate group GM, and a final lens group GE having a negative refractive power. The front group GF consists of one lens group having a negative refractive power. The intermediate group GM consists of, in order from the object side to the image side, three lens groups including a first intermediate lens group GM1 having a positive refractive power, a second intermediate lens group GM2 having a positive refractive power, and a third intermediate lens group GM3 having a negative refractive power.

During changing magnification from the wide angle end to the telephoto end, all lens groups move along the optical axis Z by changing the spacings between the adjacent lens groups. In addition, the first intermediate lens group GM1 and the final lens group GE move on the same trajectory during changing magnification from the wide angle end to the telephoto end. A focusing group consists of the third intermediate lens group GM3. During focusing from the infinite distance object to the nearest object, the focusing group moves to the image side.

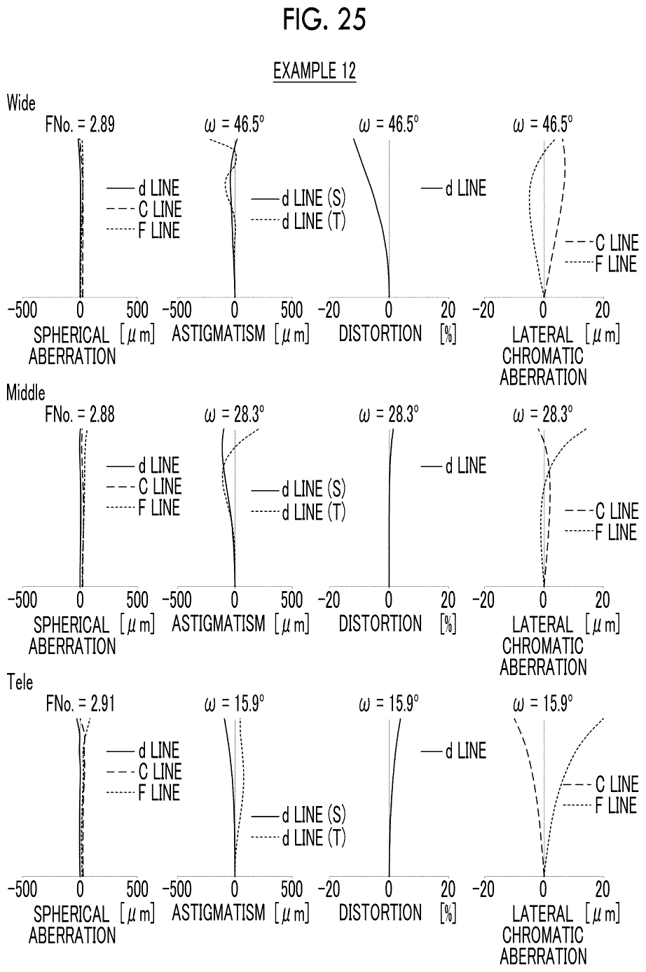

For the variable magnification optical system according to Example 12, basic lens data is shown in Table 34, specifications and variable surface spacings are shown in Table 35, aspherical coefficients are shown in Table 36, and each aberration diagram is shown in FIG. 25.

TABLE 34
Example 12

| Sn | R | D | Nd | νd | Material | ED |
|---|---|---|---|---|---|---|
| 1 | 52.4425 | 5.2375 | 1.49700 | 81.54 | S-FPL51.OHARA | 42.00 |
| 2 | 628.7557 | DD[2] | | | | 41.34 |
| 3 | 94.3546 | 2.3909 | 1.58913 | 61.13 | S-BAL35.OHARA | 34.01 |
| 4 | 12.2495 | 8.0223 | | | | 21.31 |
| *5 | −30.8912 | 0.5525 | 1.51633 | 64.06 | L-BSL7.OHARA | 20.83 |
| *6 | 31.9745 | 0.2075 | | | | 19.16 |
| 7 | 40.1210 | 2.6721 | 2.00330 | 28.27 | S-LAH79.OHARA | 19.15 |
| 8 | −116.7006 | 2.2953 | | | | 18.57 |
| 9 | −17.7558 | 0.5297 | 1.48749 | 70.24 | S-FSL5.OHARA | 18.45 |
| 10 | −32.5282 | DD[10] | | | | 18.00 |
| 11(St) | ∞ | 1.0969 | | | | 18.22 |
| *12 | 33.2704 | 3.7856 | 1.85135 | 40.10 | M-TAFD305.HOYA | 19.40 |
| *13 | −3262.4028 | 2.5407 | | | | 19.61 |
| 14 | 21.1296 | 3.1988 | 1.60300 | 65.44 | S-PHM53.OHARA | 19.37 |
| 15 | 123.0268 | 0.5745 | | | | 18.88 |
| 16 | −244.4606 | 0.4979 | 1.72047 | 34.71 | S-NBH8.OHARA | 18.86 |
| 17 | 21.2937 | 5.7378 | 1.43875 | 94.66 | S-FPL55.OHARA | 18.10 |
| 18 | −19.2975 | 0.4979 | 1.85025 | 30.05 | S-NBH57.OHARA | 17.86 |
| 19 | −122.8723 | DD[19] | | | | 18.12 |
| *20 | −3570.7011 | 1.0197 | 1.53409 | 55.87 | plastic | 18.16 |
| *21 | −44.5342 | 0.0498 | | | | 18.30 |
| 22 | 39.3366 | 5.1253 | 1.58913 | 61.13 | S-BAL35.OHARA | 18.80 |
| 23 | −19.1539 | DD[23] | | | | 19.30 |
| 24 | 53.4854 | 0.4987 | 1.90525 | 35.04 | S-LAH93.OHARA | 18.64 |
| 25 | 20.1646 | DD[25] | | | | 18.24 |
| 26 | −285.0458 | 3.5576 | 1.92286 | 18.90 | S-NPH2.OHARA | 20.42 |
| 27 | −22.9620 | 0.5764 | 1.88300 | 39.22 | H-ZLAF68N.CDGM | 20.80 |
| 28 | 306.0260 | DD[28] | | | | 21.72 |

TABLE 35
Example 12

| | Wide | Middle | Tele |
|---|---|---|---|
| Zr | 1.0 | 1.7 | 3.2 |
| f | 15.29 | 26.03 | 48.15 |
| Bf | 10.93 | 16.93 | 28.07 |
| FNo. | 2.89 | 2.88 | 2.91 |
| 2ω[°] | 93.0 | 56.6 | 31.8 |
| DD[2] | 0.078 | 10.940 | 26.685 |
| DD[10] | 18.401 | 7.928 | 1.753 |
| DD[19] | 4.451 | 2.321 | 0.801 |
| DD[23] | 2.598 | 1.869 | 0.397 |
| DD[25] | 6.744 | 9.603 | 12.595 |
| DD[28] | 10.932 | 16.925 | 28.072 |

TABLE 36
Example 12

| Sn | 5 | 6 |
|---|---|---|
| KA | 3.8199624E−01 | −3.0190921E+00 |
| A3 | 3.1918942E−17 | −2.0887062E−18 |
| A4 | 1.9892583E−04 | 1.6330838E−04 |
| A5 | −2.3371242E−05 | −1.5972843E−05 |
| A6 | −3.1957223E−06 | −7.5883550E−06 |
| A7 | 2.8538310E−07 | 1.9495464E−06 |
| A8 | 2.0073751E−07 | −1.6850888E−07 |
| A9 | −4.6194217E−08 | 1.4115028E−09 |
| A10 | 4.2687567E−09 | 7.4311990E−10 |
| A11 | −1.8979616E−10 | −5.2970879E−11 |
| A12 | 3.4219541E−12 | 1.3304613E−12 |

| Sn | 12 | 13 | 20 | 21 |
|---|---|---|---|---|
| KA | 1.0000000E+00 | 1.0000000E+00 | 1.0000000E+00 | 1.0000000E+00 |
| A4 | −3.3833181E−06 | −4.4248499E−06 | −1.0235627E−04 | 4.6245253E−06 |
| A6 | −1.2156198E−07 | −1.1160651E−07 | −3.4654640E−07 | −4.4757804E−07 |
| A8 | 9.0221785E−11 | −7.5863365E−10 | −3.9344556E−09 | 2.8518251E−09 |
| A10 | −7.3151652E−12 | −2.9356966E−12 | 5.7222145E−11 | −2.2221455E−12 |
| A12 | −1.2882356E−14 | 1.0703972E−14 | 9.1361624E−13 | 9.7771965E−13 |
| A14 | 3.0484514E−17 | 1.0053421E−17 | 2.8838917E−14 | 2.3957874E−14 |
| A16 | −3.8425280E−19 | 2.3923759E−18 | −5.7025654E−16 | −4.6294385E−16 |
| A18 | 1.0691636E−20 | −4.9223695E−20 | 2.4146974E−18 | 1.8531381E−18 |
| A20 | 3.4397159E−23 | 2.9556870E−22 | −6.0217299E−22 | −3.1553491E−22 |

### Example 13

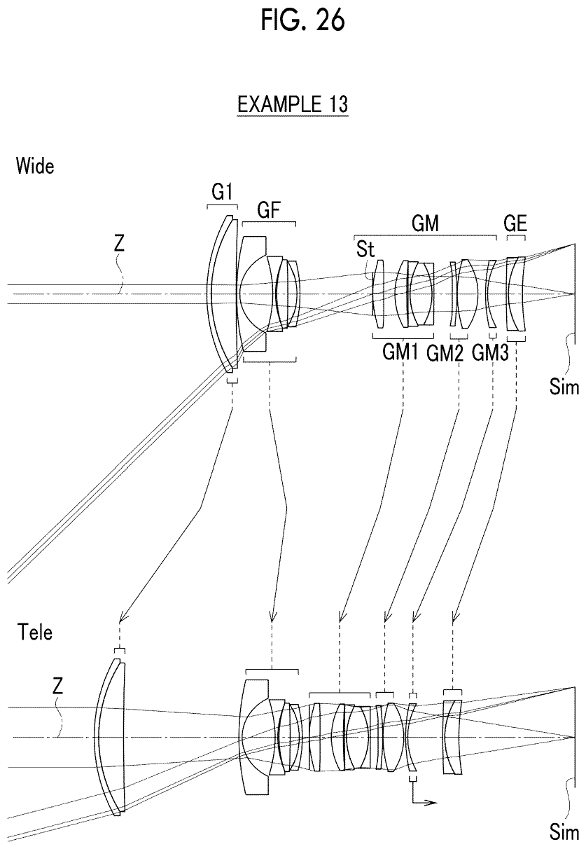

A configuration and a movement trajectory of a variable magnification optical system according to Example 13 are shown in FIG. 26. The variable magnification optical system according to Example 13 consists of, in order from the object side to the image side, a first lens group G1 having a positive refractive power, a front group GF, an intermediate group GM, and a final lens group GE having a negative refractive power. The front group GF consists of one lens group having a negative refractive power. The intermediate group GM consists of, in order from the object side to the image side, three lens groups including a first intermediate lens group GM1 having a positive refractive power, a second intermediate lens group GM2 having a positive refractive power, and a third intermediate lens group GM3 having a negative refractive power.

During changing magnification from the wide angle end to the telephoto end, all lens groups move along the optical axis Z by changing the spacings between the adjacent lens groups. In addition, the first intermediate lens group GM1 and the final lens group GE move on the same trajectory during changing magnification from the wide angle end to the telephoto end. A focusing group consists of the third intermediate lens group GM3. During focusing from the infinite distance object to the nearest object, the focusing group moves to the image side.

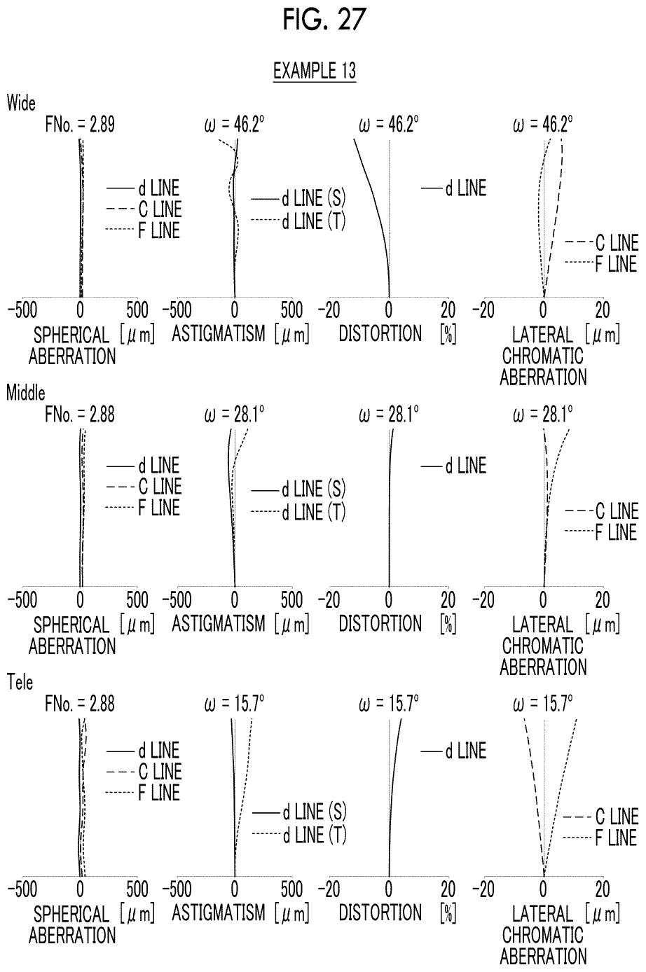

For the variable magnification optical system according to Example 13, basic lens data is shown in Table 37, specifications and variable surface spacings are shown in Table 38, aspherical coefficients are shown in Table 39, and each aberration diagram is shown in FIG. 27.

TABLE 37
Example 13

| Sn | R | D | Nd | νd | Material | ED |
|---|---|---|---|---|---|---|
| 1 | 49.0362 | 1.1722 | 1.80809 | 22.76 | S-NPH1W.OHARA | 44.29 |
| 2 | 42.2633 | 6.5178 | 1.48749 | 70.24 | S-FSL5.OHARA | 42.00 |
| 3 | 614.7654 | DD[3] | | | | 41.30 |
| 4 | 73.7338 | 0.8356 | 1.58913 | 61.13 | S-BAL35.OHARA | 32.41 |
| 5 | 12.2762 | 8.6372 | | | | 21.76 |
| *6 | −29.3932 | 0.7123 | 1.51633 | 64.06 | L-BSL7.OHARA | 21.19 |
| *7 | 25.8598 | 0.3268 | | | | 19.33 |
| 8 | 31.3481 | 2.9018 | 2.00330 | 28.27 | S-LAH79.OHARA | 19.32 |
| 9 | −226.5296 | 2.2382 | | | | 18.72 |
| 10 | −19.8449 | 0.8151 | 1.48749 | 70.24 | S-FSL5.OHARA | 18.56 |
| 11 | −39.4292 | DD[11] | | | | 18.00 |
| 12(St) | ∞ | 0.0498 | | | | 18.26 |
| *13 | 30.4939 | 2.8091 | 1.85135 | 40.10 | M-TAFD305.HOYA | 19.04 |
| *14 | 1108.0141 | 2.9704 | | | | 19.15 |
| 15 | 20.6602 | 3.1082 | 1.60300 | 65.44 | S-PHM53.OHARA | 18.81 |
| 16 | 114.6709 | 0.3571 | | | | 18.32 |
| 17 | 1272.9479 | 0.4977 | 1.72047 | 34.71 | S-NBH8.OHARA | 18.30 |
| 18 | 19.6592 | 5.7507 | 1.43875 | 94.66 | S-FPL55.OHARA | 17.49 |
| 19 | −18.3054 | 0.4997 | 1.85025 | 30.05 | S-NBH57.OHARA | 17.22 |
| 20 | −644.8317 | DD[20] | | | | 17.48 |
| *21 | 271.4416 | 1.1859 | 1.53409 | 55.87 | plastic | 17.74 |
| *22 | −79.2997 | 0.1216 | | | | 18.04 |
| 23 | 34.7881 | 5.4172 | 1.58913 | 61.13 | S-BAL35.OHARA | 18.80 |
| 24 | −18.6973 | DD[24] | | | | 19.37 |
| 25 | 46.3478 | 0.5476 | 1.90525 | 35.04 | S-LAH93.OHARA | 18.99 |
| 26 | 20.5091 | DD[26] | | | | 18.59 |
| 27 | 234.3929 | 0.5502 | 1.80100 | 34.97 | S-LAM66.OHARA | 19.91 |
| 28 | 21.6249 | 3.6790 | 1.92286 | 18.90 | S-NPH2.OHARA | 20.59 |
| 29 | 70.9641 | DD[29] | | | | 20.85 |

TABLE 38
Example 13

| | Wide | Middle | Tele |
|---|---|---|---|
| Zr | 1.0 | 1.7 | 3.2 |
| f | 15.42 | 26.26 | 48.58 |
| Bf | 13.78 | 19.79 | 30.41 |
| FNo. | 2.89 | 2.88 | 2.88 |
| 2ω[°] | 92.4 | 56.2 | 31.4 |
| DD[3] | 0.129 | 12.969 | 30.222 |
| DD[11] | 19.019 | 8.465 | 1.788 |
| DD[20] | 4.824 | 3.099 | 2.023 |
| DD[24] | 1.976 | 1.570 | 0.482 |
| DD[26] | 4.884 | 7.015 | 9.179 |
| DD[29] | 13.778 | 19.791 | 30.410 |

TABLE 39
Example 13

| Sn | 6 | 7 |
|---|---|---|
| KA | −1.3111643E+00 | −1.6507827E+00 |
| A3 | −8.3997216E−18 | 5.2217656E−19 |
| A4 | 2.1389066E−04 | 1.8755984E−04 |
| A5 | −2.6269650E−05 | −1.3519340E−05 |
| A6 | −3.1380372E−06 | −8.5739692E−06 |
| A7 | 2.8889121E−07 | 1.9681627E−06 |
| A8 | 1.9924164E−07 | −1.5567793E−07 |
| A9 | −4.5978040E−08 | 7.9048380E−10 |
| A10 | 4.2721365E−09 | 6.8860425E−10 |
| A11 | −1.9105808E−10 | −4.9739914E−11 |
| A12 | 3.4234531E−12 | 1.3366337E−12 |
| Sn | 13 | 14 |
| KA | 1.0000000E+00 | 1.0000000E+00 |
| A4 | −2.6810045E−06 | −5.7876072E−06 |
| A6 | −9.7243741E−08 | −9.6224324E−08 |
| A8 | −2.5250059E−10 | −9.1444926E−10 |
| A10 | −6.8368178E−12 | −1.8697832E−12 |
| Sn | 21 | 22 |
| KA | 1.0000000E+00 | 1.0000000E+00 |
| A4 | −1.1033483E−04 | 2.8158022E−06 |
| A6 | −3.8215612E−07 | −4.7175714E−07 |
| A8 | −4.6982865E−09 | 3.1284905E−09 |
| A10 | 4.9898355E−11 | −1.5276860E−11 |
| A12 | 1.0074651E−12 | 9.8620161E−13 |
| A14 | 2.6722309E−14 | 2.2741843E−14 |
| A16 | −5.5166706E−16 | −4.6270102E−16 |
| A18 | 2.4096373E−18 | 1.9972549E−18 |

### Example 14

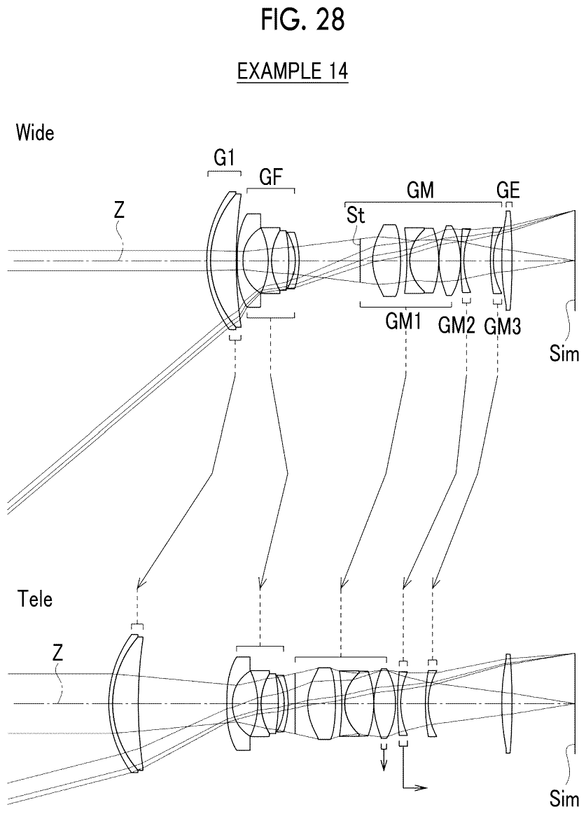

A configuration and a movement trajectory of a variable magnification optical system according to Example 14 are shown in FIG. 28. The variable magnification optical system according to Example 14 consists of, in order from the object side to the image side, a first lens group G1 having a positive refractive power, a front group GF, an intermediate group GM, and a final lens group GE having a positive refractive power. The front group GF consists of one lens group having a negative refractive power. The intermediate group GM consists of, in order from the object side to the image side, three lens groups including a first intermediate lens group GM1 having a positive refractive power, a second intermediate lens group GM2 having a negative refractive power, and a third intermediate lens group GM3 having a negative refractive power.

During changing magnification from the wide angle end to the telephoto end, the final lens group GE is fixed with respect to the image plane Sim, and the other lens groups move along the optical axis Z by changing the spacings between the adjacent lens groups. The first intermediate lens group GM1 and the third intermediate lens group GM3 move on the same trajectory during changing magnification from the wide angle end to the telephoto end. The focusing group consists of the second intermediate lens group GM2. During focusing from the infinite distance object to the nearest object, the focusing group moves to the image side. The anti-vibration group consists of a lens closest to the image side in the first intermediate lens group GM1.

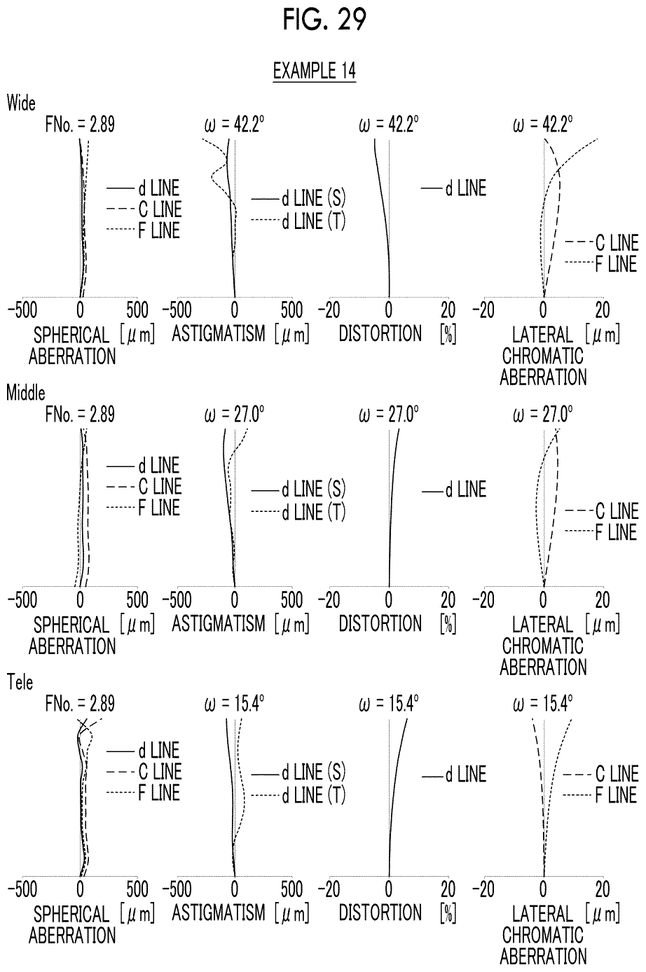

For the variable magnification optical system according to Example 14, basic lens data is shown in Table 40, specifications and variable surface spacings are shown in Table 41, aspherical coefficients are shown in Table 42, and each aberration diagram is shown in FIG. 29.

TABLE 40
Example 14

| Sn | R | D | Nd | νd | Material | ED |
|---|---|---|---|---|---|---|
| 1 | 34.9792 | 0.9998 | 2.00272 | 19.32 | E-FDS2.HOYA | 39.00 |
| 2 | 30.0310 | 6.7200 | 1.61800 | 63.33 | S-PHM52.OHARA | 37.63 |
| 3 | 136.1700 | DD[3] | | | | 36.76 |
| *4 | 571.3983 | 1.4534 | 1.85135 | 40.10 | M-TAFD305.HOYA | 26.36 |
| *5 | 15.3209 | 6.6324 | | | | 18.40 |
| 6 | −23.4234 | 0.8852 | 1.72916 | 54.68 | S-LAL18.OHARA | 18.12 |
| 7 | 17.4308 | 4.4919 | 2.05090 | 26.94 | TAFD65.HOYA | 16.87 |
| 8 | −48.7698 | 1.5798 | | | | 16.34 |
| 9 | −16.9929 | 0.9999 | 1.84666 | 23.78 | S-TIH53W.OHARA | 16.00 |
| 10 | −27.2561 | DD[10] | | | | 16.00 |
| 11(St) | ∞ | 3.2698 | | | | 17.04 |
| *12 | 16.5051 | 7.2896 | 1.69304 | 52.93 | L-LAL15.OHARA | 20.12 |
| *13 | −54.7266 | 1.6593 | | | | 20.27 |
| 14 | −71.0452 | 0.7498 | 1.90525 | 35.04 | S-LAH93.OHARA | 18.51 |
| 15 | 11.8235 | 7.6019 | 1.43875 | 94.66 | S-FPL55.OHARA | 17.31 |
| 16 | −28.9331 | 0.0498 | | | | 18.30 |
| *17 | 21.7815 | 5.6603 | 1.54436 | 56.03 | plastic | 19.40 |
| *18 | −22.7463 | DD[18] | | | | 19.71 |
| 19 | 93.1247 | 0.8285 | 1.48749 | 70.24 | S-FSL5.OHARA | 18.00 |
| 20 | 23.5632 | DD[20] | | | | 17.72 |
| 21 | 57.0544 | 0.7501 | 1.64000 | 60.08 | S-BSM81.OHARA | 18.62 |
| 22 | 20.6026 | DD[22] | | | | 18.60 |
| 23 | 70.5954 | 2.6867 | 1.48749 | 70.24 | S-FSL5.OHARA | 25.27 |
| 24 | −192.6818 | 16.5000 | | | | 25.45 |

TABLE 41
Example 14

| | Wide | Middle | Tele |
|---|---|---|---|
| Zr | 1.0 | 1.6 | 3.0 |
| f | 16.44 | 27.02 | 48.51 |
| Bf | 0.00 | 0.00 | 0.00 |
| FNo. | 2.89 | 2.89 | 2.89 |
| 2ω[°] | 84.4 | 54.0 | 30.8 |
| DD[3] | 0.300 | 10.861 | 23.206 |
| DD[10] | 16.002 | 6.260 | 1.709 |
| DD[18] | 0.050 | 2.545 | 0.548 |
| DD[20] | 6.960 | 4.465 | 6.462 |
| DD[22] | 2.216 | 7.453 | 19.255 |

TABLE 42
Example 14

| Sn | 4 | 5 | 12 | 13 |
|---|---|---|---|---|
| KA | −1.0484264E+04 | 2.2744982E+00. | 5.4686810E−01 | 4.4958595E−01 |
| A3 | −2.2019472E−16 | −3.0520198E−17 | −2.0993837E−17 | 1.4201688E−16 |
| A4 | 4.8695063E−04 | 4.4693581E−04 | −7.3256194E−06 | 5.0593419E−05 |
| A5 | −7.4982521E−05 | −3.9611608E−05 | −7.1288691E−06 | −6.3230893E−05 |
| A6 | 1.0730507E−05 | −1.7472057E−06 | 2.8685385E−06 | 3.5648796E−05 |
| A7 | −2.6578619E−06 | −2.7120437E−06 | −1.9750989E−07 | −1.2057249E−05 |
| A8 | 4.9583965E−07 | 1.7285613E−06 | −1.5962209E−07 | 2.7666838E−06 |
| A9 | −5.3628464E−08 | −3.4881731E−07 | 4.9459422E−08 | −4.7043347E−07 |
| A10 | 2.8369230E−09 | 1.7197244E−08 | −7.0993015E−09 | 5.8374137E−08 |
| A11 | 7.6314858E−12 | 1.8248424E−09 | 7.5100298E−10 | −3.9211559E−09 |
| A12 | −4.7752896E−12 | 1.9913260E−10 | −5.8225036E−11 | −1.2344772E−10 |
| A13 | −5.8109919E−13 | −7.3623509E−11 | −1.8503215E−12 | 3.6391405E−11 |
| A14 | 5.1209087E−14 | −7.7375934E−13 | 7.1085155E−13 | 7.6777392E−13 |
| A15 | 2.2605414E−15 | 9.2148002E−13 | 1.2726191E−14 | −4.2437804E−13 |
| A16 | −2.3795639E−16 | −1.1922966E−14 | −7.1733496E−15 | 7.7410133E−15 |
| A17 | −4.7316447E−18 | −6.1570735E−15 | −3.6813033E−17 | 2.4854453E−15 |
| A18 | 5.7645115E−19 | 1.7558273E−16 | 3.8833631E−17 | −9.8921784E−17 |
| A19 | 4.1048719E−21 | 1.6983189E−17 | 1.2747211E−20 | −5.8280468E−18 |
| A20 | −5.7358966E−22 | −6.6667028E−19 | −8.7364611E−20 | 3.0925554E−19 |

| Sn | 17 | 18 |
|---|---|---|
| KA | 1.0000000E+00 | 1.0000000E+00 |
| A4 | −3.0970227E−05 | 7.6185841E−06 |
| A6 | −2.2445579E−07 | −1.4149289E−07 |
| A8 | 6.4699161E−09 | −5.1763122E−09 |
| A10 | −1.1146189E−10 | 2.6545823E−10 |
| A12 | 2.7498293E−13 | −6.2951795E−12 |
| A14 | 1.4258744E−14 | 7.9013640E−14 |
| A16 | −1.8124607E−16 | −5.2329764E−16 |
| A18 | 7.0383163E−19 | 1.4454273E−18 |
| A20 | −2.0619831E−23 | 1.7291628E−23 |

### Example 15

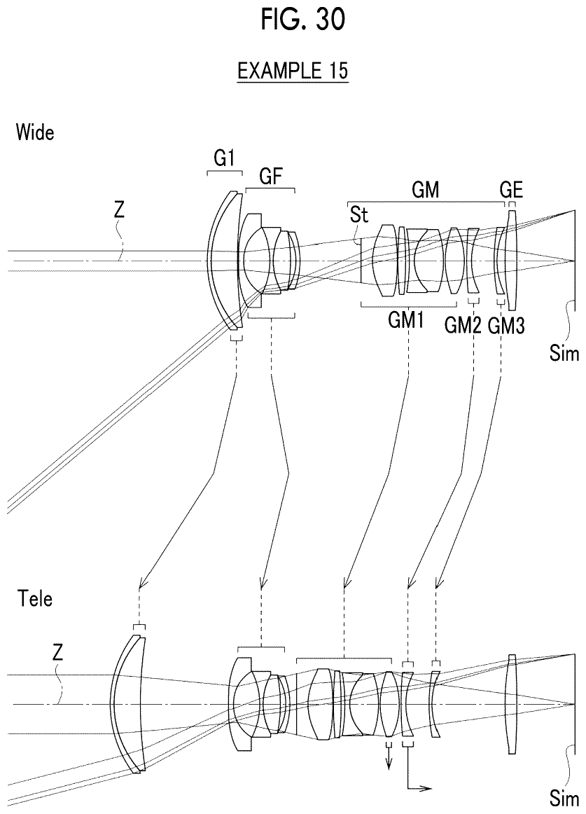

A configuration and a movement trajectory of a variable magnification optical system according to Example 15 are shown in FIG. 30. The variable magnification optical system according to Example 15 consists of, in order from the object side to the image side, a first lens group G1 having a positive refractive power, a front group GF, an intermediate group GM, and a final lens group GE having a positive refractive power. The front group GF consists of one lens group having a negative refractive power. The intermediate group GM consists of, in order from the object side to the image side, three lens groups including a first intermediate lens group GM1 having a positive refractive power, a second intermediate lens group GM2 having a negative refractive power, and a third intermediate lens group GM3 having a negative refractive power.

During changing magnification from the wide angle end to the telephoto end, the final lens group GE is fixed with respect to the image plane Sim, and the other lens groups move along the optical axis Z by changing the spacings between the adjacent lens groups. The first intermediate lens group GM1 and the third intermediate lens group GM3 move on the same trajectory during changing magnification from the wide angle end to the telephoto end. The focusing group consists of the second intermediate lens group GM2. During focusing from the infinite distance object to the nearest object, the focusing group moves to the image side. The anti-vibration group consists of a lens closest to the image side in the first intermediate lens group GM1.

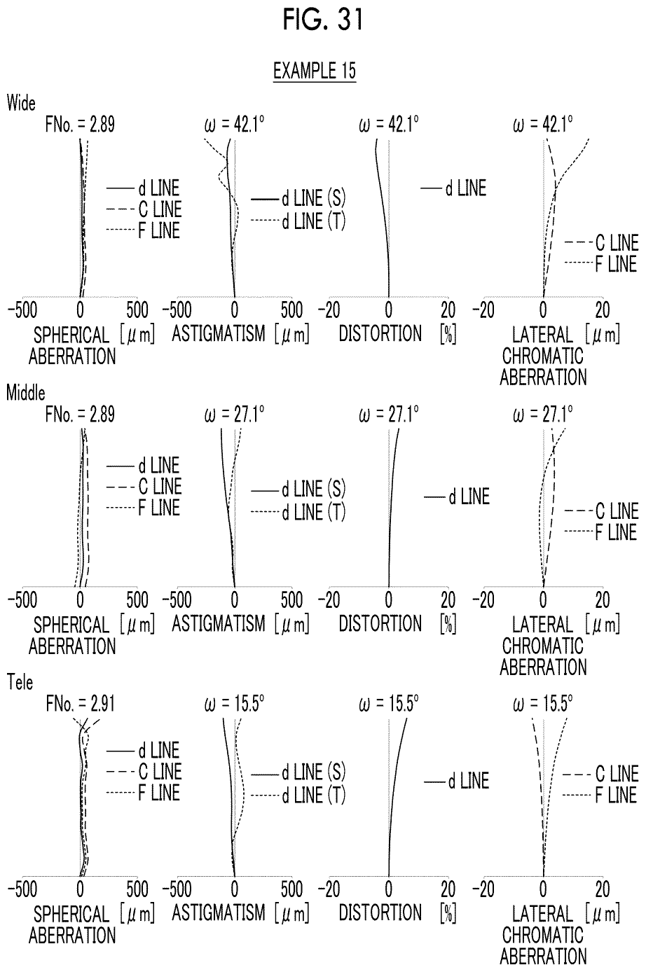

For the variable magnification optical system according to Example 15, basic lens data is shown in Table 43, specifications and variable surface spacings are shown in Table 44, aspherical coefficients are shown in Table 45, and each aberration diagram is shown in FIG. 31.

TABLE 43
Example 15

| Sn | R | D | Nd | νd | Material | ED |
|---|---|---|---|---|---|---|
| 1 | 34.3392 | 0.9998 | 2.00272 | 19.32 | E-FDS2.HOYA | 39.00 |
| 2 | 29.3044 | 6.9004 | 1.61800 | 63.33 | S-PHM52.OHARA | 37.56 |
| 3 | 132.9451 | DD[3] | | | | 36.67 |
| *4 | −4216.3779 | 1.3242 | 1.85135 | 40.10 | M-TAFD305.HOYA | 26.30 |
| *5 | 15.3625 | 6.8748 | | | | 18.40 |
| 6 | −22.1234 | 0.8848 | 1.72916 | 54.68 | S-LAL18.OHARA | 17.72 |
| 7 | 18.2304 | 4.5235 | 2.05090 | 26.94 | TAFD65.HOYA | 16.53 |
| 8 | −44.6425 | 1.4255 | | | | 15.97 |
| 9 | −16.1158 | 1.0651 | 1.84666 | 23.78 | S-TIH53W.OHARA | 15.92 |
| 10 | −24.1013 | DD[10] | | | | 16.00 |
| 11(St) | ∞ | 3.0043 | | | | 17.36 |
| *12 | 17.4404 | 6.5019 | 1.69304 | 52.93 | L-LAL15.OHARA | 19.88 |
| *13 | −64.6802 | 0.1683 | | | | 19.96 |
| 14 | 113.2034 | 2.0000 | 1.48749 | 70.24 | S-FSL5.OHARA | 18.92 |
| 15 | −104.9455 | 1.0000 | | | | 18.36 |
| 16 | −56.2503 | 1.2752 | 1.90525 | 35.04 | S-LAH93.OHARA | 17.78 |
| 17 | 11.7890 | 7.5318 | 1.43875 | 94.66 | S-FPL55.OHARA | 16.48 |
| 18 | −28.0032 | 0.4377 | | | | 17.38 |
| *19 | 22.8969 | 4.9994 | 1.54436 | 56.03 | plastic | 18.00 |
| *20 | −22.9118 | DD[20] | | | | 18.39 |
| 21 | 102.7734 | 1.2500 | 1.48749 | 70.24 | S-FSL5.OHARA | 17.97 |
| 22 | 20.7353 | DD[22] | | | | 17.64 |
| 23 | 54.5606 | 0.7498 | 1.64000 | 60.08 | S-BSM81.OHARA | 18.52 |
| 24 | 22.6951 | DD[24] | | | | 18.60 |
| 25 | 76.1488 | 3.0990 | 1.48749 | 70.24 | S-FSL5.OHARA | 25.00 |
| 26 | −245.4436 | 15.2540 | | | | 25.29 |

TABLE 44
Example 15

| | Wide | Middle | Tele |
|---|---|---|---|
| Zr | 1.0 | 1.6 | 3.0 |
| f | 16.37 | 26.90 | 48.30 |
| Bf | 0.00 | 0.00 | 0.00 |
| FNo. | 2.89 | 2.89 | 2.91 |
| 2ω[°] | 84.2 | 54.2 | 31.0 |
| DD[3] | 0.300 | 10.872 | 22.961 |
| DD[10] | 16.010 | 6.244 | 1.760 |
| DD[20] | 0.641 | 2.613 | 0.470 |
| DD[22] | 5.940 | 3.968 | 6.111 |
| DD[24] | 2.110 | 7.298 | 19.021 |

TABLE 45
Example 15

| Sn | 4 | 5 | 12 | 13 |
|---|---|---|---|---|
| KA | 7.5076290E+04 | 2.3133947E+00 | 6.2376169E−01 | −1.0155135E+00 |
| A3 | 1.2584761E−16 | 7.6648580E−18 | 2.0048750E−17 | 8.7314094E−17 |
| A4 | 5.4601662E−04 | 5.1769362E−04 | −1.7801368E−05 | 3.5941949E−05 |
| A5 | −8.7290169E−05 | −5.9621370E−05 | −3.5834628E−06 | −5.3449637E−05 |
| A6 | 9.9129429E−06 | −1.0421213E−06 | 2.2668317E−06 | 3.3006843E−05 |
| A7 | −2.1790507E−06 | −1.6410407E−06 | −3.6562038E−07 | −1.2287020E−05 |
| A8 | 4.6796532E−07 | 1.3930361E−06 | −1.0734562E−07 | 3.0062585E−06 |
| A9 | −6.0833160E−08 | −3.4379571E−07 | 5.3382681E−08 | −4.9297800E−07 |
| A10 | 3.7109585E−09 | 3.1981514E−08 | −9.0307825E−09 | 5.0580114E−08 |
| A11 | 6.0942851E−11 | 1.1972235E−10 | 6.5790901E−10 | −2.4829390E−09 |
| A12 | −1.5279654E−11 | −7.4224237E−11 | −1.0903492E−11 | −2.1718619E−11 |
| A13 | −7.7329865E−13 | −2.2437745E−11 | 2.0844324E−13 | 1.8579166E−12 |
| A14 | 1.2031392E−13 | 1.3482387E−12 | −9.4170843E−14 | 7.5607952E−13 |
| A15 | 2.4871074E−15 | 2.2975284E−13 | −1.4992375E−14 | −1.0003067E−14 |
| A16 | −5.0338675E−16 | −1.2121642E−14 | 1.5087785E−15 | −5.2508671E−15 |
| A17 | −4.3257944E−18 | −1.6161856E−15 | 1.5061621E−16 | 5.8167958E−18 |
| A18 | 1.1423063E−18 | 8.9518186E−17 | −1.2745768E−17 | 2.2567481E−17 |
| A19 | 3.1345570E−21 | 5.2240134E−18 | −4.7886762E−19 | 7.3483381E−20 |
| A20 | −1.0956020E−21 | −3.3237231E−19 | 3.9510296E−20 | −4.4920482E−20 |

| Sn | 19 | 20 |
|---|---|---|
| KA | 1.0000000E+00 | 1.0000000E+00 |
| A4 | −3.0401024E−05 | 3.6068376E−06 |
| A6 | −2.3992327E−07 | −1.5859427E−07 |
| A8 | 6.3764085E−09 | −5.4109265E−09 |
| A10 | −1.1064640E−10 | 2.6607407E−10 |
| A12 | 2.9784484E−13 | −6.3102848E−12 |
| A14 | 1.3664367E−14 | 7.9219147E−14 |
| A16 | −1.8002770E−16 | −5.2142398E−16 |
| A18 | 7.9512428E−19 | 1.4085560E−18 |
| A20 | −6.2559678E−22 | 2.0301635E−22 |

### Example 16

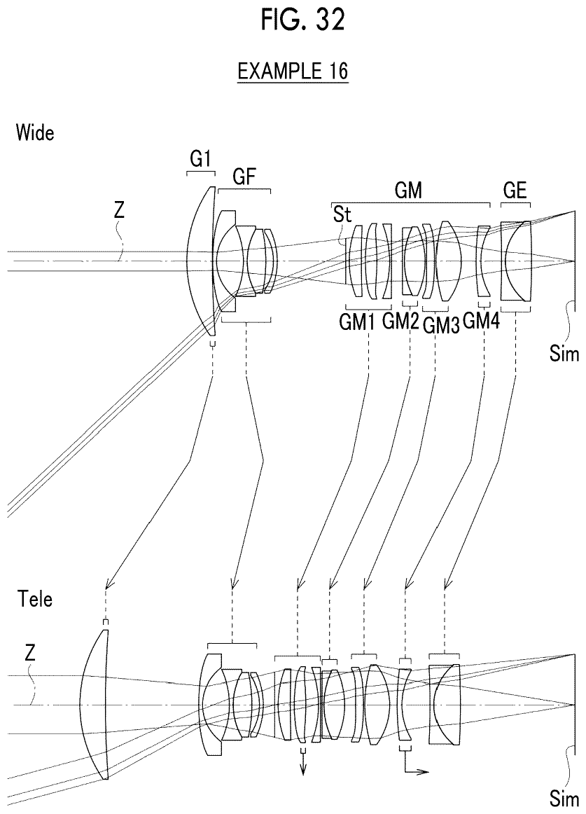

A configuration and a movement trajectory of a variable magnification optical system according to Example 16 are shown in FIG. 32. The variable magnification optical system according to Example 16 consists of, in order from the object side to the image side, a first lens group G1 having a positive refractive power, a front group GF, an intermediate group GM, and a final lens group GE having a positive refractive power. The front group GF consists of one lens group having a negative refractive power. The intermediate group GM consists of, in order from the object side to the image side, four lens groups including a first intermediate lens group GM1 having a positive refractive power, a second intermediate lens group GM2 having a positive refractive power, a third intermediate lens group GM3 having a positive refractive power, and a fourth intermediate lens group GM4 having a negative refractive power.

During changing magnification from the wide angle end to the telephoto end, all lens groups move along the optical axis Z by changing the spacings between the adjacent lens groups. In addition, the first intermediate lens group GM1, the third intermediate lens group GM3, and the final lens group GE move on the same trajectory during changing magnification from the wide angle end to the telephoto end. The focusing group consists of the fourth intermediate lens group GM4. During focusing from the infinite distance object to the nearest object, the focusing group moves to the image side. The anti-vibration group consists of a second lens from the object side in the first intermediate lens group GM1.

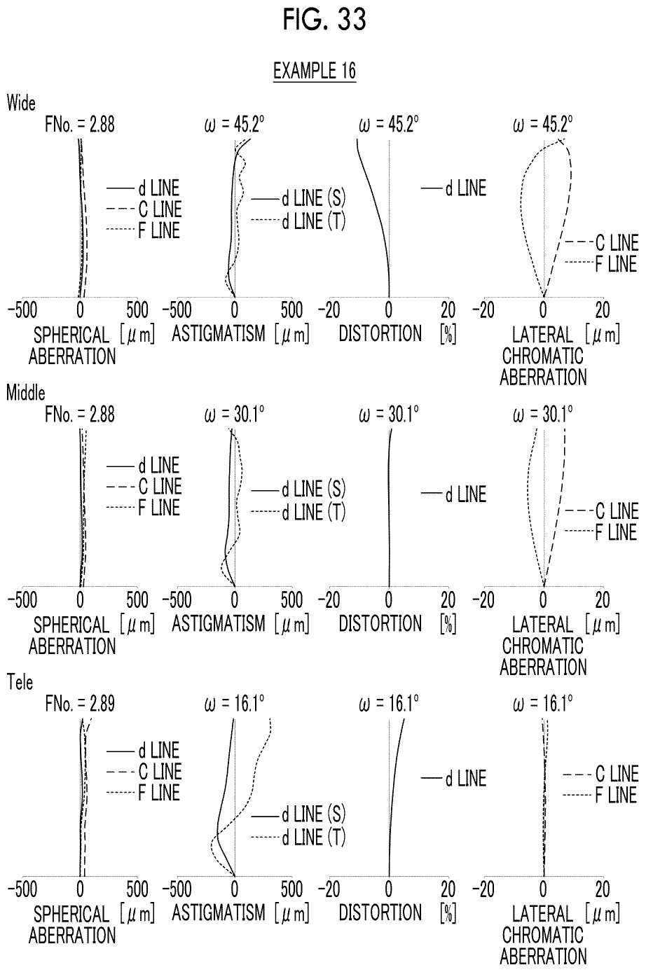

For the variable magnification optical system according to Example 16, basic lens data is shown in Table 46, specifications and variable surface spacings are shown in Table 47, aspherical coefficients are shown in Table 48, and each aberration diagram is shown in FIG. 33.

TABLE 46
Example 16

| Sn | R | D | Nd | νd | Material | ED |
|---|---|---|---|---|---|---|
| 1 | 39.0806 | 6.6989 | 1.49700 | 81.54 | S-FPL51.OHARA | 42.00 |
| 2 | 298.2300 | DD[2] | | | | 41.12 |
| *3 | 84.3527 | 0.9998 | 1.85135 | 40.10 | M-TAFD305.HOYA | 28.51 |
| *4 | 14.2756 | 7.0197 | | | | 20.54 |
| 5 | −25.2240 | 1.0068 | 1.77250 | 49.60 | S-LAH66.OHARA | 19.89 |
| 6 | 19.3091 | 4.8886 | 2.00266 | 31.67 | N200.GLASS | 18.05 |
| 7 | −45.0854 | 1.9944 | | | | 17.28 |
| 8 | −15.6720 | 1.0000 | 1.88300 | 39.22 | H-ZLAF68N.CDGM | 16.40 |
| 9 | −22.5316 | DD[9] | | | | 17.20 |
| 10(St) | ∞ | 0.9250 | | | | 18.25 |
| 11 | 29.4660 | 3.1774 | 2.00266 | 31.67 | N200.GLASS | 20.01 |
| 12 | 288.4431 | 1.0563 | | | | 19.90 |
| *13 | 56.7851 | 3.0112 | 1.53409 | 55.87 | plastic | 21.33 |
| *14 | −63.3079 | 3.3287 | | | | 20.66 |
| 15 | −31.2338 | 0.5249 | 2.00266 | 31.67 | N200.GLASS | 18.25 |
| 16 | −738.3235 | DD[16] | | | | 18.47 |
| 17 | 2796.4144 | 0.4999 | 1.85896 | 22.73 | S-NPH5.OHARA | 18.57 |
| 18 | 23.1087 | 5.4315 | 1.49700 | 81.54 | S-FPL51.OHARA | 18.84 |
| 19 | −24.6339 | DD[19] | | | | 19.39 |
| *20 | 398.2547 | 2.0673 | 1.53409 | 55.87 | plastic | 20.07 |
| *21 | −87.5215 | 0.3823 | | | | 20.92 |
| 22 | 41.3451 | 6.4979 | 1.49700 | 81.54 | S-FPL51.OHARA | 22.00 |
| 23 | −20.0130 | DD[23] | | | | 22.40 |
| 24 | 82.4752 | 1.2502 | 1.72916 | 54.68 | S-LAL18.OHARA | 19.93 |
| 25 | 20.0838 | DD[25] | | | | 19.00 |
| 26 | −256.0853 | 1.0068 | 1.80100 | 34.97 | S-LAM66.OHARA | 20.20 |
| 27 | 14.8228 | 6.8475 | 1.80518 | 25.42 | S-TIH6.OHARA | 22.08 |
| 28 | −225.6882 | DD[28] | | | | 22.60 |

TABLE 47
Example 16

| | Wide | Middle | Tele |
|---|---|---|---|
| Zr | 1.0 | 1.5 | 3.0 |
| f | 15.82 | 24.29 | 46.81 |
| Bf | 11.40 | 15.93 | 30.05 |
| FNo. | 2.88 | 2.88 | 2.89 |
| 2ω[°] | 90.4 | 60.2 | 32.2 |
| DD[2] | 0.099 | 10.557 | 24.333 |
| DD[9] | 17.955 | 8.926 | 2.982 |
| DD[16] | 2.848 | 1.758 | 0.398 |
| DD[19] | 0.398 | 1.488 | 2.848 |
| DD[23] | 3.882 | 4.976 | 1.972 |
| DD[25] | 5.438 | 4.344 | 7.348 |
| DD[28] | 11.404 | 15.927 | 30.046 |

TABLE 48
Example 16

| Sn | 3 | 4 | 13 | 14 |
|---|---|---|---|---|
| KA | −1.4990353E+01 | −2.2811769E−01 | 7.2019507E−01 | 7.5458274E−01 |
| A3 | 6.2624827E−18 | 3.2923188E−18 | −1.8141300E−16 | −1.3076057E−16 |
| A4 | 1.3578793E−04 | 1.2233608E−04 | −2.9328619E−05 | 8.1073560E−05 |
| A5 | −8.3489712E−06 | 3.1063116E−05 | 5.9203120E−05 | −3.7302939E−05 |
| A6 | −3.0864262E−06 | −1.0935696E−05 | −3.1366688E−05 | 1.5501445E−05 |
| A7 | 2.9396174E−07 | −1.8038096E−07 | 8.6672479E−06 | −4.6445567E−06 |
| A8 | 7.0925371E−08 | 4.6639282E−07 | −1.3093021E−06 | 1.0991783E−06 |
| A9 | −1.3453408E−08 | −5.8046922E−08 | 1.1479101E−07 | −1.8401474E−07 |
| A10 | 4.4143455E−10 | 8.8610097E−10 | −9.3756551E−09 | 1.7708637E−08 |
| A11 | 5.4669203E−11 | −1.7725499E−10 | 1.1009850E−09 | −5.4344840E−10 |
| A12 | −2.1861424E−12 | 8.3702973E−11 | −5.2071238E−11 | −3.6904437E−11 |
| A13 | −3.5764928E−13 | −3.0017599E−12 | −6.3476375E−12 | 3.1175469E−13 |
| A14 | 1.9194007E−14 | −6.3359269E−13 | 5.3130452E−13 | 3.2043549E−13 |
| A15 | 9.4583742E−16 | 2.0389928E−14 | 3.0142946E−14 | −4.1465758E−15 |
| A16 | −6.3849272E−17 | 3.1212334E−15 | −2.8685430E−15 | −1.1009066E−15 |
| A17 | −1.0152801E−18 | −5.3296400E−17 | −5.7050673E−17 | 1.1286260E−17 |
| A18 | 8.0336397E−20 | −6.8978278E−18 | 5.9532011E−18 | 1.5853959E−18 |

| Sn | 20 | 21 |
|---|---|---|
| KA | 1.3113219E+03 | 1.8850021E+00 |
| A3 | −1.2112615E−17 | 1.4241030E−17 |
| A4 | 2.9535837E−05 | −4.1537152E−06 |
| A5 | −1.0969434E−04 | −6.7398156E−06 |
| A6 | 5.6705838E−05 | 6.5704483E−07 |
| A7 | −1.6902516E−05 | 2.7777551E−07 |
| A8 | 3.0154716E−06 | −1.3068052E−07 |
| A9 | −3.2988670E−07 | 1.5149836E−08 |
| A10 | 2.1553892E−08 | 2.3221781E−10 |
| A11 | −7.9832797E−10 | −1.0861837E−10 |
| A12 | 1.6567340E−11 | −7.8246613E−12 |
| A13 | −8.9366142E−14 | 1.6066433E−12 |
| A14 | −1.9082460E−14 | 5.5891943E−15 |
| A15 | 2.4665223E−16 | −7.7672828E−15 |
| A16 | 4.0327968E−17 | 1.0883164E−16 |
| A17 | 0.0000000E+00 | 1.4623320E−17 |
| A18 | 0.0000000E+00 | −3.2473157E−19 |

### Example 17

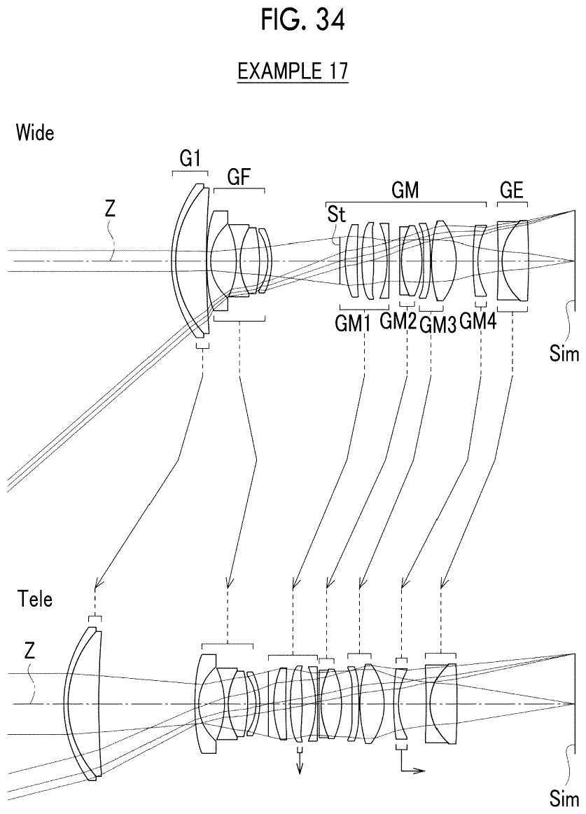

A configuration and a movement trajectory of a variable magnification optical system according to Example 17 are shown in FIG. 34. The variable magnification optical system according to Example 17 consists of, in order from the object side to the image side, a first lens group G1 having a positive refractive power, a front group GF, an intermediate group GM, and a final lens group GE having a positive refractive power. The front group GF consists of one lens group having a negative refractive power. The intermediate group GM consists of, in order from the object side to the image side, four lens groups including a first intermediate lens group GM1 having a positive refractive power, a second intermediate lens group GM2 having a positive refractive power, a third intermediate lens group GM3 having a positive refractive power, and a fourth intermediate lens group GM4 having a negative refractive power.

During changing magnification from the wide angle end to the telephoto end, all lens groups move along the optical axis Z by changing the spacings between the adjacent lens groups. In addition, the first intermediate lens group GM1, the third intermediate lens group GM3, and the final lens group GE move on the same trajectory during changing magnification from the wide angle end to the telephoto end. The focusing group consists of the fourth intermediate lens group GM4. During focusing from the infinite distance object to the nearest object, the focusing group moves to the image side. The anti-vibration group consists of a second lens from the object side in the first intermediate lens group GM1.

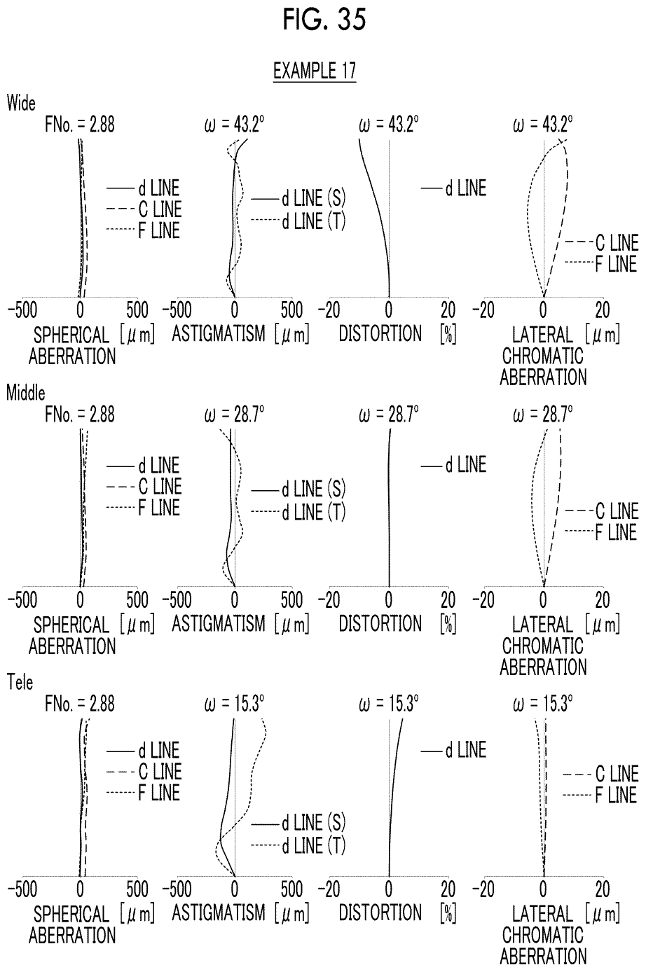

For the variable magnification optical system according to Example 17, basic lens data is shown in Table 49, specifications and variable surface spacings are shown in Table 50, aspherical coefficients are shown in Table 51, and each aberration diagram is shown in FIG. 35.

TABLE 49
Example 17

| Sn | R | D | Nd | νd | Material | ED |
|---|---|---|---|---|---|---|
| 1 | 39.2740 | 1.1104 | 1.67270 | 32.10 | S-TIM25.OHARA | 43.34 |
| 2 | 32.1855 | 8.0605 | 1.51680 | 64.20 | BSC7.HOYA | 41.00 |
| 3 | 288.0068 | DD[3] | | | | 40.13 |
| *4 | 96.7406 | 0.9998 | 1.85135 | 40.10 | M-TAFD305.HOYA | 27.97 |
| *5 | 14.6815 | 6.7469 | | | | 20.82 |
| 6 | −26.0815 | 1.0068 | 1.77250 | 49.60 | S-LAH66.OHARA | 20.23 |
| 7 | 19.6723 | 5.0693 | 2.00266 | 31.67 | N200.GLASS | 18.49 |
| 8 | −42.8220 | 2.1921 | | | | 17.75 |
| 9 | −15.5372 | 1.0000 | 1.88300 | 39.22 | H-ZLAF68N.CDGM | 16.40 |
| 10 | −22.5043 | DD[10] | | | | 17.25 |
| 11(St) | ∞ | 1.3932 | | | | 18.33 |
| 12 | 29.6420 | 3.1627 | 2.00266 | 31.67 | N200.GLASS | 20.31 |
| 13 | 221.5878 | 1.1938 | | | | 20.18 |
| *14 | 54.1025 | 3.1127 | 1.53409 | 55.87 | plastic | 21.54 |
| *15 | −64.9751 | 3.5119 | | | | 20.81 |
| 16 | −30.1403 | 0.5250 | 2.00266 | 31.67 | N200.GLASS | 18.46 |
| 17 | −823.1226 | DD[17] | | | | 18.71 |
| 18 | 1679.9133 | 0.5004 | 1.85896 | 22.73 | S-NPH5.OHARA | 18.82 |
| 19 | 23.9798 | 5.3855 | 1.49700 | 81.54 | S-FPL51.OHARA | 19.12 |
| 20 | −25.4824 | DD[20] | | | | 19.65 |
| *21 | 392.7809 | 1.8081 | 1.53409 | 55.87 | plastic | 20.24 |
| *22 | −100.2941 | 0.2793 | | | | 21.00 |
| 23 | 43.2418 | 6.3439 | 1.49700 | 81.54 | S-FPL51.OHARA | 22.00 |
| 24 | −19.9784 | DD[24] | | | | 22.39 |
| 25 | 80.2130 | 1.2502 | 1.72916 | 54.68 | S-LAL18.OHARA | 19.91 |
| 26 | 21.1962 | DD[26] | | | | 19.00 |
| 27 | −243.4403 | 1.0068 | 1.80100 | 34.97 | S-LAM66.OHARA | 20.18 |
| 28 | 15.2977 | 6.9518 | 1.80518 | 25.42 | S-TIH6.OHARA | 22.00 |
| 29 | −215.2154 | DD[29] | | | | 22.60 |

TABLE 50
Example 17

| | Wide | Middle | Tele |
|---|---|---|---|
| Zr | 1.0 | 1.5 | 3.0 |
| f | 16.78 | 25.77 | 49.68 |
| Bf | 12.18 | 16.78 | 30.93 |
| FNo. | 2.88 | 2.88 | 2.88 |
| 2ω[°] | 86.4 | 57.4 | 30.6 |
| DD[3] | 0.099 | 11.018 | 25.058 |
| DD[10] | 17.883 | 8.771 | 2.259 |
| DD[17] | 2.749 | 1.668 | 0.399 |
| DD[20] | 0.399 | 1.480 | 2.749 |
| DD[24] | 4.411 | 5.497 | 2.487 |
| DD[26] | 5.342 | 4.257 | 7.266 |
| DD[29] | 12.183 | 16.775 | 30.934 |

TABLE 51
Example 17

| Sn | 4 | 5 | 14 | 15 |
|---|---|---|---|---|
| KA | −1.2868084E+01 | −2.8741685E−01 | 6.4994251E−01 | 6.4830860E−01 |
| A3 | 3.4517621E−19 | −2.1187664E−17 | 5.0547187E−17 | 2.9349152E−17 |
| A4 | 8.9762928E−05 | 7.8493959E−05 | −2.9828416E−05 | 7.8094499E−05 |
| A5 | −6.7351802E−06 | 2.7294765E−05 | 5.8980697E−05 | −3.8011826E−05 |
| A6 | −1.9771911E−06 | −9.2647219E−06 | −3.1229220E−05 | 1.5878907E−05 |
| A7 | 2.2397788E−07 | −3.7078236E−08 | 8.6694164E−06 | −4.6464209E−06 |
| A8 | 5.6784466E−08 | 4.1527642E−07 | −1.3141430E−06 | 1.0875793E−06 |
| A9 | −1.2391815E−08 | −6.3489497E−08 | 1.1481102E−07 | −1.8364170E−07 |
| A10 | 5.5130523E−10 | 2.3462780E−09 | −9.2903596E−09 | 1.7894569E−08 |
| A11 | 4.6039404E−11 | −7.0646284E−11 | 1.1004129E−09 | −5.5092726E−10 |
| A12 | −2.7250190E−12 | 5.4740689E−11 | −5.2707935E−11 | −3.8222837E−11 |
| A13 | −3.1753060E−13 | −4.0743515E−12 | −6.3443519E−12 | 3.8127901E−13 |
| A14 | 2.0815349E−14 | −2.9970243E−13 | 5.3169224E−13 | 3.2079762E−13 |
| A15 | 8.4613619E−16 | 2.5742685E−14 | 3.0142445E−14 | −4.4655375E−15 |
| A16 | −6.6655689E−17 | 1.0848372E−15 | −2.8512144E−15 | −1.0596088E−15 |
| A17 | −9.1260193E−19 | −6.3842598E−17 | −5.7079204E−17 | 1.1871029E−17 |
| A18 | 8.2591964E−20 | −1.7918939E−18 | 5.8930039E−18 | 1.4400419E−18 |

| Sn | 21 | 22 |
|---|---|---|
| KA | 1.2710880E+03 | 2.9877788E+00 |
| A3 | 1.9284345E−16 | 6.0615666E−18 |
| A4 | 3.1957599E−05 | −2.6381810E−06 |
| A5 | −1.1097312E−04 | −8.0532622E−06 |
| A6 | 5.6622015E−05 | 5.1679561E−07 |
| A7 | −1.6875192E−05 | 3.0171223E−07 |
| A8 | 3.0187245E−06 | −1.2497855E−07 |
| A9 | −3.3026513E−07 | 1.4837720E−08 |
| A10 | 2.1467004E−08 | 8.1647043E−11 |
| A11 | −7.9492358E−10 | −1.0635719E−10 |
| A12 | 1.7710071E−11 | −5.6346805E−12 |
| A13 | −1.0577539E−13 | 1.5983760E−12 |
| A14 | −2.6001323E−14 | −1.1646933E−14 |
| A15 | 2.7810759E−16 | −7.7568264E−15 |
| A16 | 5.5859282E−17 | 1.7877443E−16 |
| A17 | 0.0000000E+00 | 1.4629959E−17 |
| A18 | 0.0000000E+00 | −4.4059419E−19 |

### Example 18

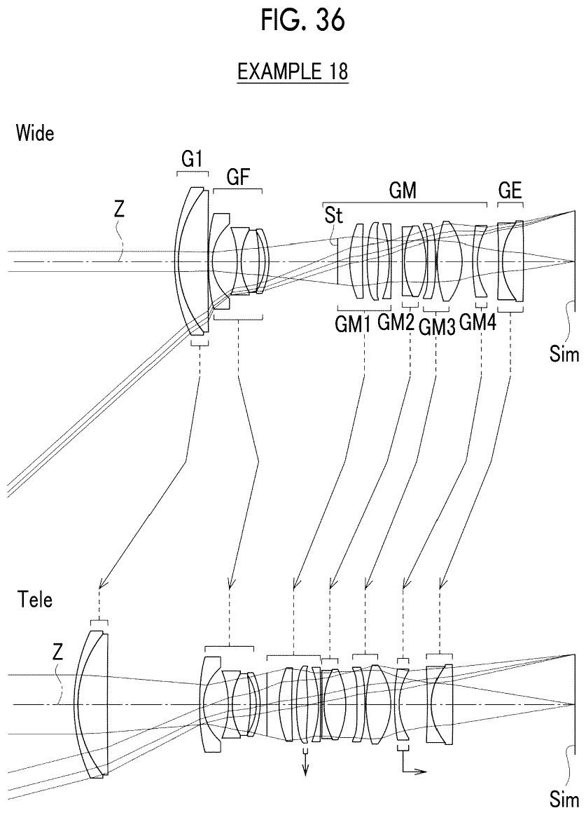

A configuration and a movement trajectory of a variable magnification optical system according to Example 18 are shown in FIG. 36. The variable magnification optical system according to Example 18 consists of, in order from the object side to the image side, a first lens group G1 having a positive refractive power, a front group GF, an intermediate group GM, and the final lens group GE having a negative refractive power. The front group GF consists of one lens group having a negative refractive power. The intermediate group GM consists of, in order from the object side to the image side, four lens groups including a first intermediate lens group GM1 having a positive refractive power, a second intermediate lens group GM2 having a positive refractive power, a third intermediate lens group GM3 having a positive refractive power, and a fourth intermediate lens group GM4 having a negative refractive power.

During changing magnification from the wide angle end to the telephoto end, all lens groups move along the optical axis Z by changing the spacings between the adjacent lens groups. In addition, the first intermediate lens group GM1, the third intermediate lens group GM3, and the final lens group GE move on the same trajectory during changing magnification from the wide angle end to the telephoto end. The focusing group consists of the fourth intermediate lens group GM4. During focusing from the infinite distance object to the nearest object, the focusing group moves to the image side. The anti-vibration group consists of a second lens from the object side in the first intermediate lens group GM1.

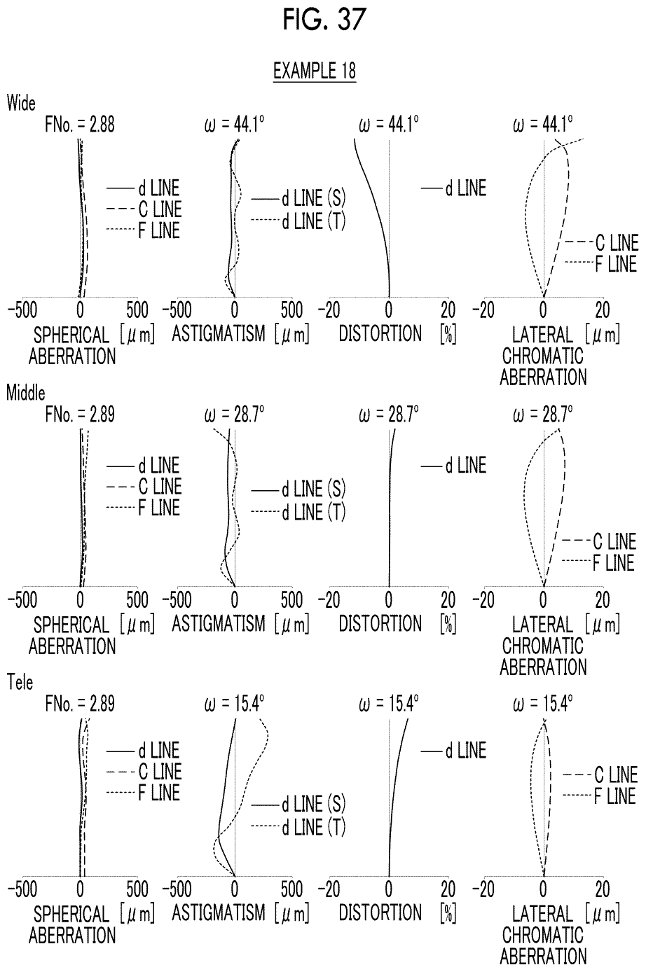

For the variable magnification optical system according to Example 18, basic lens data is shown in Table 52, specifications and variable surface spacings are shown in Table 53, aspherical coefficients are shown in Table 54, and each aberration diagram is shown in FIG. 37.

TABLE 52
Example 18

| Sn | R | D | Nd | νd | Material | ED |
|---|---|---|---|---|---|---|
| 1 | 52.0501 | 1.0000 | 1.59551 | 39.24 | S-TIM8.OHARA | 41.60 |
| 2 | 33.4574 | 7.7478 | 1.58913 | 61.13 | S-BAL35.OHARA | 39.82 |
| 3 | 1392.0589 | DD[3] | | | | 39.10 |
| *4 | 136.1983 | 1.0001 | 1.85135 | 40.10 | M-TAFD305.HOYA | 26.89 |
| *5 | 15.3917 | 6.5365 | | | | 20.18 |
| 6 | −27.4401 | 1.0068 | 1.77250 | 49.60 | S-LAH66.OHARA | 18.94 |
| 7 | 18.7971 | 4.7247 | 2.00266 | 31.67 | N200.GLASS | 17.41 |
| 8 | −47.5286 | 1.5731 | | | | 16.67 |
| 9 | −16.3603 | 1.0000 | 1.88300 | 39.22 | H-ZLAF68N.CDGM | 16.60 |
| 10 | −23.0638 | DD[10] | | | | 17.22 |
| 11(St) | ∞ | 3.1810 | | | | 17.78 |
| 12 | 29.2830 | 3.3282 | 2.00266 | 31.67 | N200.GLASS | 20.79 |
| 13 | 287.9502 | 1.2208 | | | | 20.62 |
| *14 | 58.7371 | 2.9601 | 1.53409 | 55.87 | plastic | 21.78 |
| *15 | −64.5519 | 2.8392 | | | | 21.04 |
| 16 | −32.5318 | 0.5248 | 2.00266 | 31.67 | N200.GLASS | 18.89 |
| 17 | −467.4330 | DD[17] | | | | 19.04 |
| 18 | −637.6667 | 0.5053 | 1.85896 | 22.73 | S-NPH5.OHARA | 19.10 |
| 19 | 22.6841 | 5.7123 | 1.49700 | 81.54 | S-FPL51.OHARA | 19.33 |
| 20 | −24.9569 | DD[20] | | | | 19.84 |
| *21 | 400.4686 | 2.0913 | 1.53409 | 55.87 | plastic | 20.24 |
| *22 | −99.4817 | 0.3241 | | | | 21.05 |
| 23 | 39.4675 | 6.4749 | 1.49700 | 81.54 | S-FPL51.OHARA | 22.00 |
| 24 | −19.9626 | DD[24] | | | | 22.35 |
| 25 | 63.9012 | 1.2289 | 1.72916 | 54.68 | S-LAL18.OHARA | 20.05 |
| 26 | 19.2594 | DD[26] | | | | 19.00 |
| 27 | −223.4304 | 1.0068 | 1.80100 | 34.97 | S-LAM66.OHARA | 20.21 |
| 28 | 18.1417 | 5.5155 | 1.80809 | 22.76 | S-NPH1W.OHARA | 21.53 |
| 29 | −737.1742 | DD[29] | | | | 22.03 |

TABLE 53
Example 18

| | Wide | Middle | Tele |
|---|---|---|---|
| Zr | 1.0 | 1.5 | 2.9 |
| f | 16.57 | 25.44 | 48.38 |
| Bf | 13.53 | 18.58 | 32.06 |
| FNo. | 2.88 | 2.89 | 2.89 |
| 2ω[°] | 88.2 | 57.4 | 30.8 |
| DD[3] | 0.156 | 9.136 | 24.057 |
| DD[10] | 18.014 | 7.616 | 1.807 |
| DD[17] | 2.921 | 1.940 | 0.390 |
| DD[20] | 0.388 | 1.369 | 2.919 |
| DD[24] | 2.801 | 3.841 | 0.955 |
| DD[26] | 5.551 | 4.511 | 7.397 |
| DD[29] | 13.525 | 18.582 | 32.060 |

TABLE 54
Example 18

| Sn | 4 | 5 | 14 | 15 |
|---|---|---|---|---|
| KA | 2.8703952E+00 | −4.1418435E−01 | 9.5028988E−01 | 5.4703640E−01 |
| A3 | −7.8897420E−18 | 1.3717995E−17 | −6.0292513E−17 | 3.3889747E−17 |
| A4 | 1.9227674E−04 | 1.8484915E−04 | −5.3797625E−05 | 5.5268329E−05 |
| A5 | −2.0288750E−05 | 1.7871608E−05 | 6.8917722E−05 | −2.6794354E−05 |
| A6 | −4.2624953E−06 | −1.1689597E−05 | −3.1460477E−05 | 1.5322222E−05 |
| A7 | 7.4307037E−07 | 1.8227647E−07 | 7.9647040E−06 | −5.4644204E−06 |
| A8 | 6.9660493E−08 | 4.6417632E−07 | −1.2269058E−06 | 1.2024297E−06 |
| A9 | −2.0886652E−08 | −6.4941220E−08 | 1.3463059E−07 | −1.5953010E−07 |
| A10 | 7.1589615E−10 | 1.5297331E−09 | −1.2630868E−08 | 1.3471763E−08 |
| A11 | 1.2025494E−10 | −1.1445497E−10 | 8.1644065E−10 | −9.1312782E−10 |
| A12 | −5.7219758E−12 | 6.6329532E−11 | 5.2374814E−12 | 4.1103201E−11 |
| A13 | −6.7716842E−13 | −2.9832586E−12 | −4.1585653E−12 | 3.2994287E−12 |
| A14 | 3.9794455E−14 | −4.3088723E−13 | 3.4953336E−15 | −4.3164713E−13 |
| A15 | 1.7556040E−15 | 1.6459923E−14 | 2.1534597E−14 | −1.6455475E−14 |
| A16 | −1.2245414E−16 | 2.0124064E−15 | −3.8876054E−16 | 2.5956875E−15 |
| A17 | −1.8481144E−18 | −3.5890293E−17 | −4.3460602E−17 | 3.1565111E−17 |
| A18 | 1.4635094E−19 | −4.5740356E−18 | 1.2590188E−18 | −5.7260286E−18 |

| Sn | 21 | 22 |
|---|---|---|
| KA | 1.3006804E+03 | 2.8242645E+00 |
| A3 | −1.4600954E−16 | −8.0820888E−18 |
| A4 | 2.8299509E−05 | −6.3783828E−06 |
| A5 | −1.0918833E−04 | −5.6107585E−06 |
| A6 | 5.6458796E−05 | 4.0949724E−07 |
| A7 | −1.6954018E−05 | 2.2474459E−07 |
| A8 | 3.0293775E−06 | −1.2150154E−07 |
| A9 | −3.2889147E−07 | 1.6847775E−08 |
| A10 | 2.1275650E−08 | 2.3071603E−11 |
| A11 | −8.0681722E−10 | −1.3633761E−10 |
| A12 | 1.9249107E−11 | −4.8608712E−12 |
| A13 | −5.3276715E−14 | 1.8407303E−12 |
| A14 | −3.1585235E−14 | −1.8055099E−14 |
| A15 | 1.8230975E−16 | −8.7314456E−15 |
| A16 | 6.2871780E−17 | 2.0520697E−16 |
| A17 | 0.0000000E+00 | 1.6126741E−17 |
| A18 | 0.0000000E+00 | −4.8057065E−19 |

### Example 19

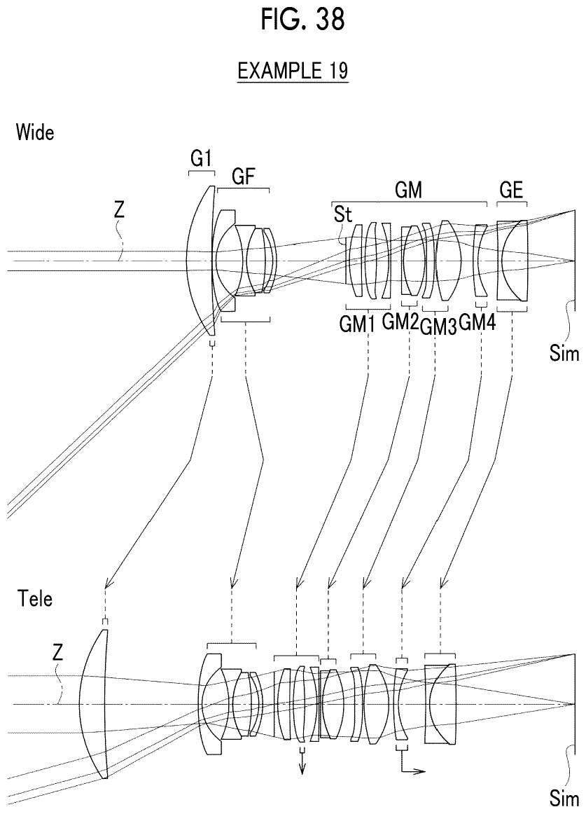

A configuration and a movement trajectory of a variable magnification optical system according to Example 19 are shown in FIG. 38. The variable magnification optical system of Example 19 consists of, in order from the object side to the image side, a first lens group G1 having a positive refractive power, a front group GF, an intermediate group GM, and a final lens group GE having a negative refractive power. The front group GF consists of one lens group having a negative refractive power. The intermediate group GM consists of, in order from the object side to the image side, four lens groups including a first intermediate lens group GM1 having a positive refractive power, a second intermediate lens group GM2 having a positive refractive power, a third intermediate lens group GM3 having a positive refractive power, and a fourth intermediate lens group GM4 having a negative refractive power.

During changing magnification from the wide angle end to the telephoto end, all lens groups move along the optical axis Z by changing the spacings between the adjacent lens groups. In addition, the first intermediate lens group GM1, the third intermediate lens group GM3, and the final lens group GE move on the same trajectory during changing magnification from the wide angle end to the telephoto end. The focusing group consists of the fourth intermediate lens group GM4. During focusing from the infinite distance object to the nearest object, the focusing group moves to the image side. The anti-vibration group consists of a second lens from the object side in the first intermediate lens group GM1.

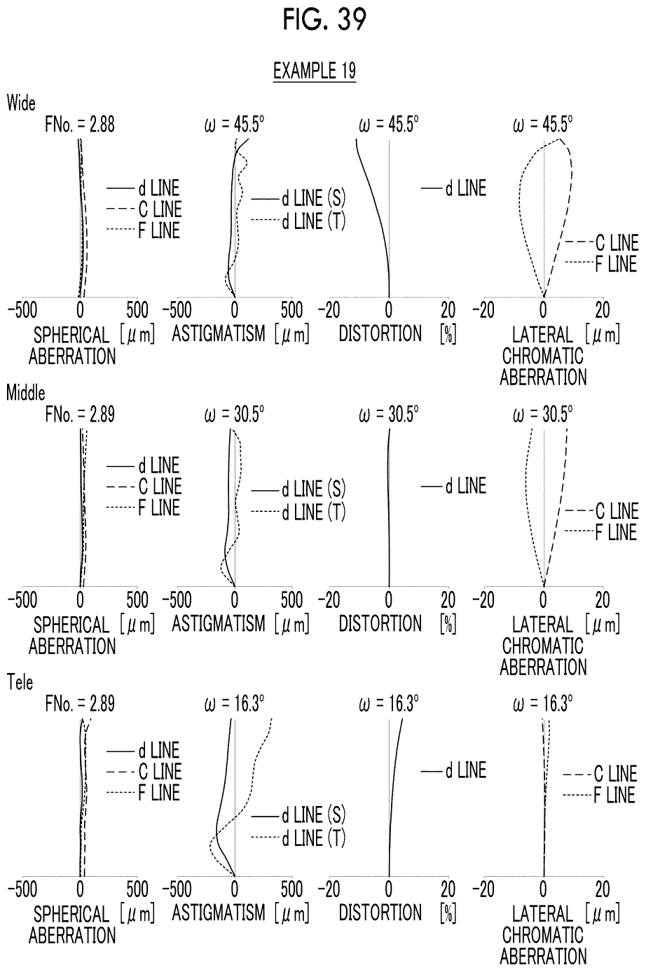

For the variable magnification optical system according to Example 19, basic lens data is shown in Table 55, specifications and variable surface spacings are shown in Table 56, aspherical coefficients are shown in Table 57, and each aberration diagram is shown in FIG. 39.

TABLE 55
Example 19

| Sn | R | D | Nd | νd | Material | ED |
|---|---|---|---|---|---|---|
| 1 | 38.9825 | 6.6336 | 1.49700 | 81.54 | S-FPL51.OHARA | 42.00 |
| 2 | 267.3334 | DD[2] | | | | 41.12 |
| *3 | 89.4071 | 0.9998 | 1.85135 | 40.10 | M-TAFD305.HOYA | 28.44 |
| *4 | 14.2987 | 7.0403 | | | | 20.45 |
| 5 | −25.1428 | 1.0068 | 1.77250 | 49.60 | S-LAH66.OHARA | 19.80 |
| 6 | 19.1240 | 4.8949 | 2.00266 | 31.67 | N200.GLASS | 17.98 |
| 7 | −44.7756 | 1.9495 | | | | 17.21 |
| 8 | −15.7203 | 1.0000 | 1.88300 | 39.22 | H-ZLAF68N.CDGM | 16.40 |
| 9 | −22.4104 | DD[9] | | | | 17.19 |
| 10(St) | ∞ | 0.9012 | | | | 18.33 |
| 11 | 29.4841 | 3.1706 | 2.00266 | 31.67 | N200.GLASS | 20.08 |
| 12 | 289.5149 | 0.9433 | | | | 19.97 |
| *13 | 57.4407 | 3.0077 | 1.53409 | 55.87 | plastic | 21.39 |
| *14 | −62.4443 | 3.1922 | | | | 20.71 |
| 15 | −31.4635 | 0.5249 | 2.00266 | 31.67 | N200.GLASS | 18.35 |
| 16 | −653.9333 | DD[16] | | | | 18.56 |
| 17 | 8457.0643 | 0.4999 | 1.85896 | 22.73 | S-NPH5.OHARA | 18.66 |
| 18 | 23.0456 | 5.6116 | 1.49700 | 81.54 | S-FPL51.OHARA | 18.93 |
| 19 | −24.4175 | DD[19] | | | | 19.51 |
| *20 | 399.5079 | 2.0875 | 1.53409 | 55.87 | plastic | 20.10 |
| *21 | −83.4284 | 0.3826 | | | | 20.94 |
| 22 | 41.1504 | 6.4806 | 1.49700 | 81.54 | S-FPL51.OHARA | 22.00 |
| 23 | −20.0006 | DD[23] | | | | 22.38 |
| 24 | 74.1439 | 1.2502 | 1.72916 | 54.68 | S-LAL18.OHARA | 20.05 |
| 25 | 20.0343 | DD[25] | | | | 19.00 |
| 26 | −217.3102 | 1.0068 | 1.80100 | 34.97 | S-LAM66.OHARA | 20.22 |
| 27 | 14.7669 | 6.8211 | 1.80518 | 25.42 | S-TIH6.OHARA | 22.06 |
| 28 | −312.1643 | DD[28] | | | | 22.54 |

TABLE 56
Example 19

| | Wide | Middle | Tele |
|---|---|---|---|
| Zr | 1.0 | 1.5 | 3.0 |
| f | 15.68 | 24.08 | 46.41 |
| Bf | 12.37 | 16.87 | 31.18 |
| FNo. | 2.88 | 2.89 | 2.89 |
| 2ω[°] | 91.0 | 61.0 | 32.6 |
| DD[2] | 0.099 | 10.560 | 24.405 |
| DD[9] | 18.193 | 8.991 | 3.027 |
| DD[16] | 2.847 | 1.761 | 0.399 |
| DD[19] | 0.400 | 1.486 | 2.848 |
| DD[23] | 3.162 | 4.254 | 1.252 |
| DD[25] | 5.266 | 4.174 | 7.176 |
| DD[28] | 12.371 | 16.874 | 31.179 |

TABLE 57
Example 19

| Sn | 3 | 4 | 13 | 14 |
|---|---|---|---|---|
| KA | −1.5165347E+01 | −2.2704607E−01 | 7.1971045E−01 | 7.9937412E−01 |
| A3 | 4.8669846E−17 | −2.3347142E−17 | −9.7024897E−17 | 7.7777400E−18 |
| A4 | 1.5120824E−04 | 1.3975961E−04 | −3.0941632E−05 | 8.0122234E−05 |
| A5 | −8.4592364E−06 | 3.0733953E−05 | 5.9352178E−05 | −3.7324947E−05 |
| A6 | −3.4108720E−06 | −1.1077076E−05 | −3.1308197E−05 | 1.5535582E−05 |
| A7 | 3.0064088E−07 | −1.8721675E−07 | 8.6609460E−06 | −4.6437518E−06 |
| A8 | 7.5233292E−08 | 4.6285746E−07 | −1.3106527E−06 | 1.0990944E−06 |
| A9 | −1.3563494E−08 | −5.6839796E−08 | 1.1494481E−07 | −1.8401441E−07 |
| A10 | 4.0373246E−10 | 9.2845751E−10 | −9.3455305E−09 | 1.7699582E−08 |
| A11 | 5.5601253E−11 | −2.0694638E−10 | 1.0987583E−09 | −5.4370229E−10 |
| A12 | −1.9734737E−12 | 8.4877435E−11 | −5.2621067E−11 | −3.6815468E−11 |
| A13 | −3.6196620E−13 | −2.6867361E−12 | −6.3289041E−12 | 3.1533756E−13 |
| A14 | 1.8453681E−14 | −6.6162696E−13 | 5.3727801E−13 | 3.2078436E−13 |
| A15 | 9.5620118E−16 | 1.8812338E−14 | 3.0059153E−14 | −4.1668258E−15 |
| A16 | −6.2411251E−17 | 3.3451481E−15 | −2.9013041E−15 | −1.1081859E−15 |
| A17 | −1.0253449E−18 | −5.0229000E−17 | −5.6897120E−17 | 1.1328458E−17 |
| A18 | 7.9164845E−20 | −7.5492754E−18 | 6.0232471E−18 | 1.6086548E−18 |

| Sn | 20 | 21 |
|---|---|---|
| KA | 1.3115074E+03 | 1.9224992E+00 |
| A3 | 2.7618840E−16 | −2.3613332E−18 |
| A4 | 2.9345872E−05 | −4.6319703E−06 |
| A5 | −1.0969530E−04 | −6.2269613E−06 |
| A6 | 5.6678383E−05 | 5.9737153E−07 |
| A7 | −1.6901409E−05 | 2.6254873E−07 |
| A8 | 3.0167102E−06 | −1.2770083E−07 |
| A9 | −3.2990345E−07 | 1.5431063E−08 |
| A10 | 2.1534427E−08 | 1.7450426E−10 |
| A11 | −7.9824790E−10 | −1.1183788E−10 |
| A12 | 1.6696750E−11 | −7.2273175E−12 |
| A13 | −8.9394975E−14 | 1.6286751E−12 |
| A14 | −1.9415797E−14 | 2.0320024E−15 |
| A15 | 2.4618234E−16 | −7.8494490E−15 |
| A16 | 4.0475907E−17 | 1.2055322E−16 |
| A17 | 0.0000000E+00 | 1.4751612E−17 |
| A18 | 0.0000000E+00 | −3.4150446E−19 |

### Example 20

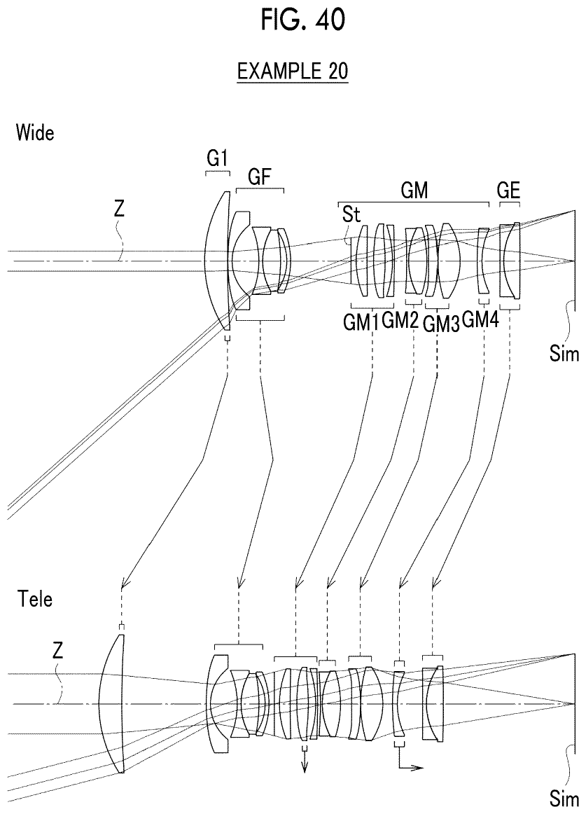

A configuration and a movement trajectory of a variable magnification optical system according to Example 20 are shown in FIG. 40. The variable magnification optical system according to Example 20 consists of, in order from the object side to the image side, a first lens group G1 having a positive refractive power, a front group GF, an intermediate group GM, and a final lens group GE having a positive refractive power. The front group GF consists of one lens group having a negative refractive power. The intermediate group GM consists of, in order from the object side to the image side, four lens groups including a first intermediate lens group GM1 having a positive refractive power, a second intermediate lens group GM2 having a negative refractive power, a third intermediate lens group GM3 having a positive refractive power, and a fourth intermediate lens group GM4 having a negative refractive power.

During changing magnification from the wide angle end to the telephoto end, all lens groups move along the optical axis Z by changing the spacings between the adjacent lens groups. In addition, the first intermediate lens group GM1, the third intermediate lens group GM3, and the final lens group GE move on the same trajectory during changing magnification from the wide angle end to the telephoto end. The focusing group consists of the fourth intermediate lens group GM4. During focusing from the infinite distance object to the nearest object, the focusing group moves to the image side. The anti-vibration group consists of a second lens from the object side in the first intermediate lens group GM1.

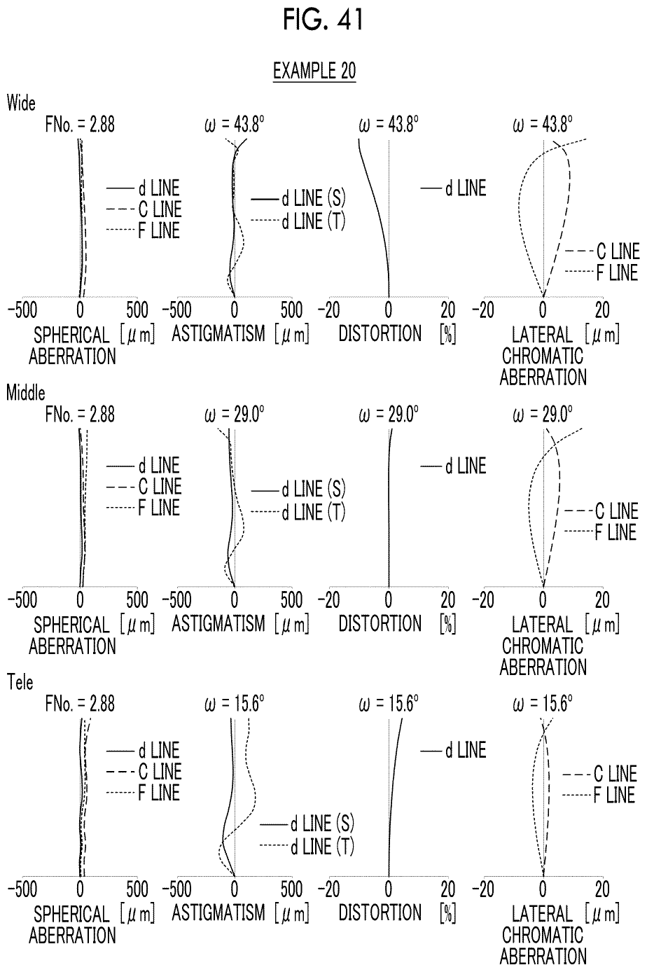

For the variable magnification optical system according to Example 20, basic lens data is shown in Table 58, specifications and variable surface spacings are shown in Table 59, aspherical coefficients are shown in Table 60, and each aberration diagram is shown in FIG. 41.

TABLE 58
Example 20

| Sn | R | D | Nd | νd | Material | ED |
|---|---|---|---|---|---|---|
| 1 | 38.3026 | 6.0082 | 1.52841 | 76.45 | S-FPM4.OHARA | 39.00 |
| 2 | 312.1907 | DD[2] | | | | 38.20 |
| *3 | 89.5110 | 1.0893 | 1.85135 | 40.10 | M-TAFD305.HOYA | 27.62 |
| *4 | 14.3396 | 7.0186 | | | | 20.20 |
| 5 | −25.9938 | 1.0068 | 1.77250 | 49.60 | S-LAH66.OHARA | 18.88 |
| 6 | 18.3126 | 4.6774 | 2.00266 | 31.67 | N200.GLASS | 17.15 |
| 7 | −46.3767 | 1.6353 | | | | 16.43 |
| 8 | −15.5237 | 1.0000 | 1.88300 | 39.22 | H-ZLAF68N.CDGM | 16.40 |
| 9 | −23.7280 | DD[9] | | | | 17.25 |
| 10(St) | ∞ | 1.3525 | | | | 18.00 |
| 11 | 28.1812 | 2.8158 | 2.00266 | 31.67 | N200.GLASS | 19.76 |
| 12 | 433.2263 | 1.7476 | | | | 19.63 |
| *13 | 58.4369 | 3.0098 | 1.53409 | 55.87 | plastic | 20.70 |
| *14 | −54.4531 | 1.9248 | | | | 20.06 |
| 15 | −33.6796 | 0.4999 | 2.00266 | 31.67 | N200.GLASS | 17.92 |
| 16 | −239.2572 | DD[16] | | | | 17.97 |
| 17 | −122.6388 | 0.4999 | 1.84666 | 23.78 | S-TIH53W.OHARA | 17.97 |
| 18 | 21.0238 | 4.7763 | 1.49700 | 81.54 | S-FPL51.OHARA | 18.14 |
| 19 | −32.9377 | DD[19] | | | | 18.57 |
| *20 | 382.1725 | 2.3258 | 1.53409 | 55.87 | plastic | 19.19 |
| *21 | −60.7913 | 0.0500 | | | | 19.94 |
| 22 | 39.1300 | 5.8057 | 1.49700 | 81.54 | S-FPL51.OHARA | 20.60 |
| 23 | −19.8505 | DD[23] | | | | 20.90 |
| 24 | 85.9950 | 1.2500 | 1.72916 | 54.68 | S-LAL18.OHARA | 18.25 |
| 25 | 21.3089 | DD[25] | | | | 17.40 |
| 26 | −1679.1360 | 1.0068 | 1.80100 | 34.97 | S-LAM66.OHARA | 19.01 |
| 27 | 19.5757 | 4.2502 | 1.80809 | 22.76 | S-NPH1W.OHARA | 20.21 |
| 28 | −615.6747 | DD[28] | | | | 20.62 |

TABLE 59
Example 20

| | Wide | Middle | Tele |
|---|---|---|---|
| Zr | 1.0 | 1.5 | 3.0 |
| f | 16.49 | 25.32 | 48.81 |
| Bf | 14.44 | 19.35 | 34.57 |
| FNo. | 2.88 | 2.88 | 2.88 |
| 2ω[°] | 87.6 | 58.0 | 31.2 |
| DD[2] | 0.098 | 9.903 | 22.022 |
| DD[9] | 15.856 | 7.604 | 1.402 |
| DD[16] | 3.252 | 2.198 | 0.730 |
| DD[19] | 0.397 | 1.451 | 2.919 |
| DD[23] | 4.460 | 5.568 | 2.547 |
| DD[25] | 4.717 | 3.609 | 6.630 |
| DD[28] | 14.438 | 19.351 | 34.565 |

TABLE 60
Example 20

| Sn | 3 | 4 | 13 | 14 |
|---|---|---|---|---|
| KA | −2.0756154E+01 | −4.1366051E−01 | 3.2559195E−01 | 5.9151521E−01 |
| A3 | 2.5789594E−17 | 5.2924910E−18 | −8.4602283E−18 | 6.5029355E−17 |
| A4 | 1.5361825E−04 | 1.7708684E−04 | −3.1587482E−05 | 7.9039425E−05 |
| A5 | −7.5612666E−06 | 1.7291853E−05 | 5.8982470E−05 | −3.8107739E−05 |
| A6 | −3.5040712E−06 | −9.6315466E−06 | −3.1291398E−05 | 1.5940588E−05 |
| A7 | 2.8479650E−07 | 3.8469714E−07 | 8.6674266E−06 | −4.6397331E−06 |
| A8 | 7.7002286E−08 | 3.4364091E−07 | −1.3154664E−06 | 1.0755608E−06 |
| A9 | −1.3391151E−08 | −6.7372135E−08 | 1.1484949E−07 | −1.8371511E−07 |
| A10 | 3.7155340E−10 | 4.2342754E−09 | −9.1618271E−09 | 1.8375343E−08 |
| A11 | 5.4547596E−11 | −9.5100381E−11 | 1.0991333E−09 | −5.5228928E−10 |
| A12 | −1.6043611E−12 | 3.2842755E−11 | −5.6025472E−11 | −4.8109050E−11 |
| A13 | −3.5882014E−13 | −3.3808985E−12 | −6.3226897E−12 | 4.1690058E−13 |
| A14 | 1.6182353E−14 | −1.7390434E−13 | 5.7063426E−13 | 4.2971788E−13 |
| A15 | 9.5285538E−16 | 2.1117056E−14 | 2.9994222E−14 | −4.7356401E−15 |
| A16 | −5.5410093E−17 | 8.4043767E−16 | −3.0648463E−15 | −1.6633227E−15 |
| A17 | −1.0263291E−18 | −5.3303033E−17 | −5.6724882E−17 | 1.2561850E−17 |
| A18 | 7.0614513E−20 | −2.2078034E−18 | 6.3384097E−18 | 2.7581535E−18 |

| Sn | 20 | 21 |
|---|---|---|
| KA | 1.2853682E+03 | 1.4077194E+00 |
| A3 | −2.1328132E−16 | −6.2806593E−18 |
| A4 | 3.5806201E−05 | 2.5311014E−06 |
| A5 | −1.0763160E−04 | −4.1086821E−06 |
| A6 | 5.6691528E−05 | 4.1175805E−07 |
| A7 | −1.6955626E−05 | 2.2403593E−07 |
| A8 | 3.0149997E−06 | −1.2133333E−07 |
| A9 | −3.2908171E−07 | 1.5840575E−08 |
| A10 | 2.1607157E−08 | 4.6723967E−11 |
| A11 | −8.0541562E−10 | −1.1405079E−10 |
| A12 | 1.5472003E−11 | −5.4598624E−12 |
| A13 | −5.6829717E−14 | 1.6306739E−12 |
| A14 | −1.1058080E−14 | −1.5046109E−14 |
| A15 | 1.8686055E−16 | −7.8157460E−15 |
| A16 | 2.0521505E−17 | 2.1377702E−16 |
| A17 | 0.0000000E+00 | 1.4643324E−17 |
| A18 | 0.0000000E+00 | −5.4583367E−19 |

### Example 21

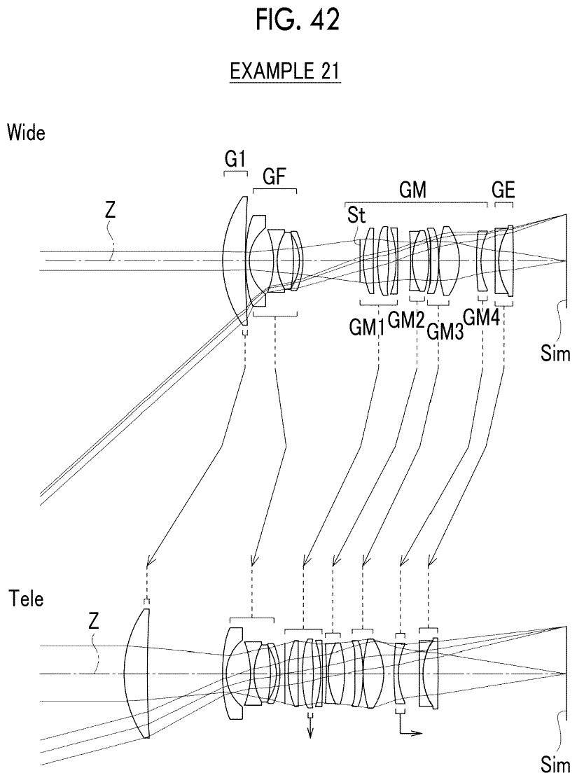

A configuration and a movement trajectory of a variable magnification optical system according to Example 21 are shown in FIG. 42. The variable magnification optical system according to Example 21 consists of, in order from the object side to the image side, a first lens group G1 having a positive refractive power, a front group GF, an intermediate group GM, and a final lens group GE having a positive refractive power. The front group GF consists of one lens group having a negative refractive power. The intermediate group GM consists of, in order from the object side to the image side, four lens groups including a first intermediate lens group GM1 having a positive refractive power, a second intermediate lens group GM2 having a negative refractive power, a third intermediate lens group GM3 having a positive refractive power, and a fourth intermediate lens group GM4 having a negative refractive power.

During changing magnification from the wide angle end to the telephoto end, all lens groups move along the optical axis Z by changing the spacings between the adjacent lens groups. In addition, the first intermediate lens group GM1, the third intermediate lens group GM3, and the final lens group GE move on the same trajectory during changing magnification from the wide angle end to the telephoto end. The focusing group consists of the fourth intermediate lens group GM4. During focusing from the infinite distance object to the nearest object, the focusing group moves to the image side. The anti-vibration group consists of a second lens from the object side in the first intermediate lens group GM1.

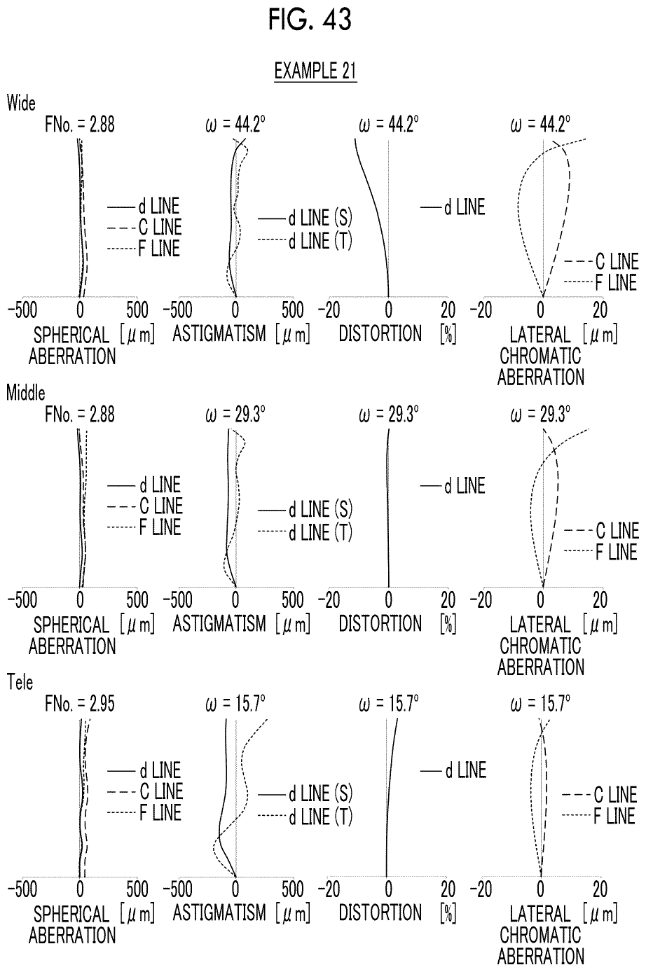

For the variable magnification optical system according to Example 21, basic lens data is shown in Table 61, specifications and variable surface spacings are shown in Table 62, aspherical coefficients are shown in Table 63, and each aberration diagram is shown in FIG. 43.

TABLE 61
Example 21

| Sn | R | D | Nd | νd | Material | ED |
|---|---|---|---|---|---|---|
| 1 | 36.3776 | 6.4066 | 1.48749 | 70.24 | S-FSL5.OHARA | 39.00 |
| 2 | 334.7240 | DD[2] | | | | 38.15 |
| *3 | 95.9361 | 1.0244 | 1.85135 | 40.10 | M-TAFD305.HOYA | 27.61 |
| *4 | 14.3830 | 6.8553 | | | | 20.20 |
| 5 | −27.3212 | 1.0068 | 1.77250 | 49.60 | S-LAH66.OHARA | 19.03 |
| 6 | 18.5059 | 4.6035 | 2.00266 | 31.67 | N200.GLASS | 17.22 |
| 7 | −49.7019 | 1.6902 | | | | 16.42 |
| 8 | −15.4346 | 1.0000 | 1.88300 | 39.22 | H-ZLAF68N.CDGM | 16.40 |
| 9 | −23.3477 | DD[9] | | | | 17.32 |
| 10(St) | ∞ | 0.9467 | | | | 18.34 |
| 11 | 28.1988 | 2.7820 | 2.00266 | 31.67 | N200.GLASS | 19.87 |
| 12 | 440.9072 | 1.2490 | | | | 19.74 |
| *13 | 57.1448 | 3.0868 | 1.53409 | 55.87 | plastic | 20.80 |
| *14 | −57.9055 | 2.1091 | | | | 20.05 |
| 15 | −33.3402 | 0.4999 | 2.00266 | 31.67 | N200.GLASS | 17.83 |
| 16 | −235.1827 | DD[16] | | | | 17.86 |
| 17 | −115.5888 | 0.4999 | 1.84666 | 23.78 | S-TIH53W.OHARA | 17.83 |
| 18 | 20.9844 | 4.6016 | 1.49700 | 81.54 | S-FPL51.OHARA | 17.99 |
| 19 | −35.7529 | DD[19] | | | | 18.40 |
| *20 | 385.1491 | 2.2513 | 1.53409 | 55.87 | plastic | 19.15 |
| *21 | −51.4646 | 0.0498 | | | | 19.87 |
| 22 | 39.5295 | 5.8017 | 1.49700 | 81.54 | S-FPL51.OHARA | 20.60 |
| 23 | −19.8249 | DD[23] | | | | 20.91 |
| 24 | 88.0873 | 1.2500 | 1.72916 | 54.68 | S-LAL18.OHARA | 18.22 |
| 25 | 21.8264 | DD[25] | | | | 17.40 |
| 26 | −1554.7574 | 1.0068 | 1.80100 | 34.97 | S-LAM66.OHARA | 18.65 |
| 27 | 19.6983 | 4.0898 | 1.80809 | 22.76 | S-NPH1W.OHARA | 19.82 |
| 28 | −597.3905 | DD[28] | | | | 20.23 |

TABLE 62
Example 21

| | Wide | Middle | Tele |
|---|---|---|---|
| Zr | 1.0 | 1.5 | 3.0 |
| f | 16.48 | 25.30 | 48.78 |
| Bf | 15.01 | 20.12 | 36.28 |
| FNo. | 2.88 | 2.88 | 2.95 |
| 2ω[°] | 88.4 | 58.6 | 31.4 |
| DD[2] | 0.098 | 9.850 | 21.287 |
| DD[9] | 16.130 | 7.884 | 1.399 |
| DD[16] | 3.647 | 2.582 | 1.092 |
| DD[19] | 0.397 | 1.462 | 2.952 |
| DD[23] | 4.841 | 5.955 | 2.930 |
| DD[25] | 4.034 | 2.920 | 5.945 |
| DD[28] | 15.014 | 20.118 | 36.276 |

TABLE 63
Example 21

| Sn | 3 | 4 | 13 | 14 |
|---|---|---|---|---|
| KA | −2.0747834E+01 | −4.6778534E−01 | 3.5812436E−01 | 6.6379280E−01 |
| A3 | −1.1144261E−17 | −1.3310880E−17 | −1.0923333E−16 | −3.3087623E−17 |
| A4 | 1.5097179E−04 | 1.9817890E−04 | −5.0975654E−05 | 7.8079412E−05 |
| A5 | −5.1491422E−06 | 1.2206715E−05 | 6.9373276E−05 | −3.5321943E−05 |
| A6 | −3.6530223E−06 | −1.1210007E−05 | −3.1839323E−05 | 1.5197897E−05 |
| A7 | 2.0643454E−07 | 1.1707374E−06 | 8.2911437E−06 | −4.4917724E−06 |
| A8 | 8.3830699E−08 | 3.4751289E−07 | −1.2645866E−06 | 1.0885785E−06 |
| A9 | −1.2251633E−08 | −1.0302905E−07 | 1.2168048E−07 | −1.9180411E−07 |
| A10 | 2.5860995E−10 | 6.4484253E−09 | −1.0520825E−08 | 1.8624774E−08 |
| A11 | 4.4935674E−11 | 6.3337420E−10 | 1.0329022E−09 | −3.9087499E−10 |
| A12 | −5.8852818E−13 | −3.3820000E−11 | −3.7147818E−11 | −5.8252895E−11 |
| A13 | −3.1130368E−13 | −1.1018202E−11 | −5.9834141E−12 | −1.2004323E−12 |
| A14 | 1.0982622E−14 | 6.6630995E−13 | 4.2219924E−13 | 5.5488228E−13 |
| A15 | 8.2601107E−16 | 6.1446287E−14 | 2.9186256E−14 | 3.3988660E−15 |
| A16 | −4.1256520E−17 | −4.1833524E−15 | −2.4368167E−15 | −2.3549623E−15 |
| A17 | −8.8583627E−19 | −1.3868389E−16 | −5.6176881E−17 | −3.8067499E−18 |
| A18 | 5.4785199E−20 | 9.5622084E−18 | 5.2254915E−18 | 4.2157611E−18 |

| Sn | 20 | 21 |
|---|---|---|
| KA | 1.2855869E+03 | 1.4737763E+00 |
| A3 | −2.1602946E−16 | 6.2806593E−18 |
| A4 | 5.5948597E−05 | 4.3548696E−06 |
| A5 | −1.1438084E−04 | −4.9333417E−06 |
| A6 | 5.7008827E−05 | 1.0409775E−06 |
| A7 | −1.6745259E−05 | 7.7568177E−08 |
| A8 | 2.9873442E−06 | −1.2989476E−07 |
| A9 | −3.3174967E−07 | 2.1994814E−08 |
| A10 | 2.2185322E−08 | −1.8325586E−10 |
| A11 | −7.9265093E−10 | −2.1957907E−10 |
| A12 | 9.7133087E−12 | 2.0568490E−12 |
| A13 | −5.8907828E−14 | 2.5354241E−12 |
| A14 | 1.7086011E−14 | −9.9157215E−14 |
| A15 | 8.9920566E−17 | −1.1649314E−14 |
| A16 | −3.3468825E−17 | 6.4297409E−16 |
| A17 | 0.0000000E+00 | 2.1046529E−17 |
| A18 | 0.0000000E+00 | −1.3836490E−18 |

### Example 22

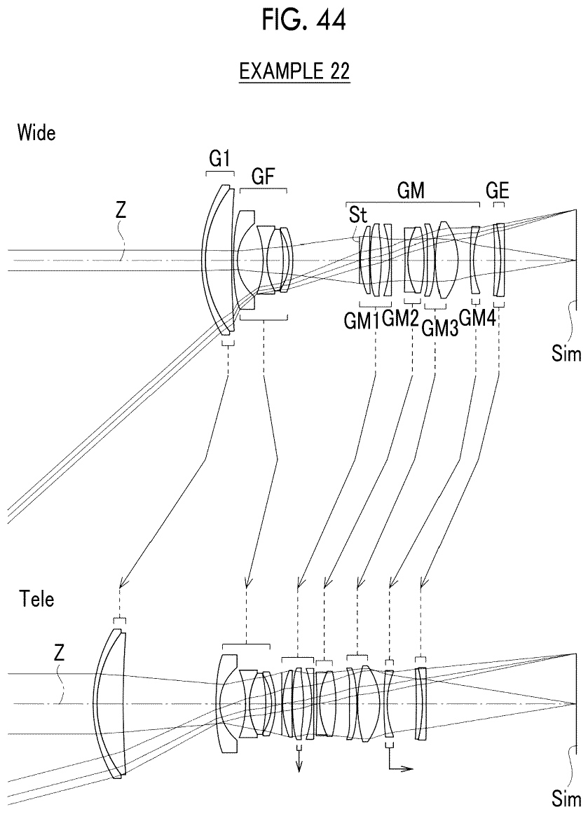

A configuration and a movement trajectory of a variable magnification optical system according to Example 22 are shown in FIG. 44. The variable magnification optical system according to Example 22 consists of, in order from the object side to the image side, a first lens group G1 having a positive refractive power, a front group GF, an intermediate group GM, and a final lens group GE having a positive refractive power. The front group GF consists of one lens group having a negative refractive power. The intermediate group GM consists of, in order from the object side to the image side, four lens groups including a first intermediate lens group GM1 having a positive refractive power, a second intermediate lens group GM2 having a negative refractive power, a third intermediate lens group GM3 having a positive refractive power, and a fourth intermediate lens group GM4 having a negative refractive power.

During changing magnification from the wide angle end to the telephoto end, all lens groups move along the optical axis Z by changing the spacings between the adjacent lens groups. In addition, the first intermediate lens group GM1, the third intermediate lens group GM3, and the final lens group GE move on the same trajectory during changing magnification from the wide angle end to the telephoto end. The focusing group consists of the fourth intermediate lens group GM4. During focusing from the infinite distance object to the nearest object, the focusing group moves to the image side. The anti-vibration group consists of a second lens from the object side in the first intermediate lens group GM1.

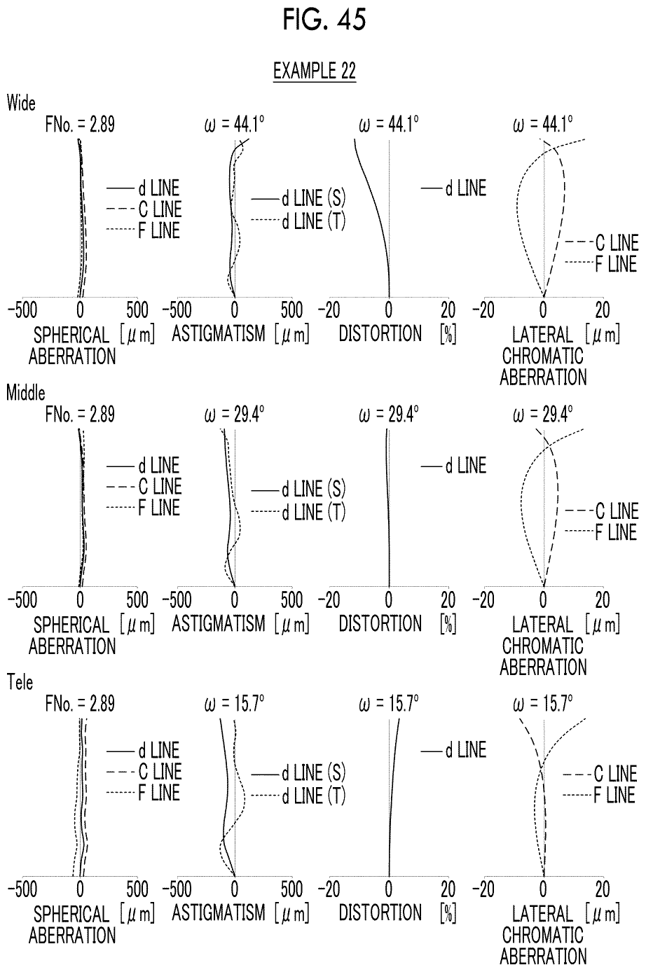

For the variable magnification optical system according to Example 22, basic lens data is shown in Table 64, specifications and variable surface spacings are shown in Table 65, aspherical coefficients are shown in Table 66, and each aberration diagram is shown in FIG. 45.

TABLE 64
Example 22

| Sn | R | D | Nd | νd | Material | ED |
|---|---|---|---|---|---|---|
| 1 | 44.0175 | 1.0000 | 1.62004 | 36.26 | S-TIM2.OHARA | 42.16 |
| 2 | 34.8372 | 6.8619 | 1.58913 | 61.13 | S-BAL35.OHARA | 40.00 |
| 3 | 295.7266 | DD[3] | | | | 39.28 |
| *4 | 108.8244 | 0.9998 | 1.85135 | 40.10 | M-TAFD305.HOYA | 27.68 |
| *5 | 14.3723 | 6.7474 | | | | 20.42 |
| 6 | −28.1979 | 1.0068 | 1.77250 | 49.60 | S-LAH66.OHARA | 19.06 |
| 7 | 19.2157 | 4.2639 | 2.00266 | 31.67 | N200.GLASS | 17.24 |
| 8 | −41.8712 | 1.5231 | | | | 16.61 |
| 9 | −16.0817 | 1.0000 | 1.88300 | 39.22 | H-ZLAF68N.CDGM | 16.40 |
| 10 | −26.0890 | DD[10] | | | | 16.99 |
| 11(St) | ∞ | 0.2499 | | | | 17.62 |
| 12 | 26.9775 | 2.3636 | 2.00266 | 31.67 | N200.GLASS | 18.85 |
| 13 | 259.4721 | 0.2000 | | | | 18.78 |
| *14 | 75.0391 | 2.8703 | 1.53409 | 55.87 | plastic | 20.25 |
| *15 | −44.9556 | 2.1601 | | | | 19.77 |
| 16 | −34.4385 | 0.4954 | 2.00266 | 31.67 | N200.GLASS | 17.49 |
| 17 | −4932.9905 | DD[17] | | | | 17.58 |
| 18 | −207.6319 | 0.7372 | 1.84666 | 23.78 | S-TIH53W.OHARA | 17.65 |
| 19 | 21.7510 | 4.2512 | 1.49700 | 81.54 | S-FPL51.OHARA | 17.92 |
| 20 | −45.1338 | DD[20] | | | | 18.40 |
| *21 | 398.8608 | 1.9179 | 1.53409 | 55.87 | plastic | 19.61 |
| *22 | −47.4797 | 0.1931 | | | | 20.20 |
| 23 | 42.7425 | 5.7867 | 1.49700 | 81.54 | S-FPL51.OHARA | 21.20 |
| 24 | −19.7649 | DD[24] | | | | 21.45 |
| 25 | 100.6744 | 0.8751 | 1.72916 | 54.68 | S-LAL18.OHARA | 18.77 |
| 26 | 26.0280 | DD[26] | | | | 18.00 |
| 27 | −173.1888 | 1.5643 | 2.16217 | 21.24 | N216.GLASS | 19.71 |
| 28 | −48.1282 | 1.0068 | 1.80400 | 46.53 | S-LAH65VS.OHARA | 19.93 |
| 29 | −606.8639 | DD[29] | | | | 20.41 |

TABLE 65
Example 22

| | Wide | Middle | Tele |
|---|---|---|---|
| Zr | 1.0 | 1.5 | 3.0 |
| f | 16.57 | 25.44 | 49.04 |
| Bf | 18.79 | 24.16 | 39.14 |
| FNo. | 2.89 | 2.89 | 2.89 |
| 2ω[°] | 88.2 | 58.8 | 31.4 |
| DD[3] | 0.490 | 10.051 | 24.157 |
| DD[10] | 17.442 | 8.465 | 1.672 |
| DD[17] | 3.556 | 2.330 | 0.836 |
| DD[20] | 0.846 | 2.072 | 3.566 |
| DD[24] | 3.181 | 4.357 | 1.081 |
| DD[26] | 5.532 | 4.357 | 7.632 |
| DD[29] | 18.790 | 24.155 | 39.140 |

TABLE 66
Example 22

| Sn | 4 | 5 | 14 | 15 |
|---|---|---|---|---|
| KA | −2.8630754E+01 | −8.3814449E−01 | 3.8351333E−01 | 5.7375961E−01 |
| A3 | −1.1933912E−06 | −5.2373266E−06 | 3.8619383E−06 | 5.3541194E−06 |
| A4 | 1.1599650E−04 | 1.4206040E−04 | −4.2781583E−05 | 6.0072604E−05 |
| A5 | −1.3409752E−05 | 1.4071139E−05 | 6.6478619E−05 | −2.6955040E−05 |
| A6 | −1.9865705E−06 | −8.5146408E−06 | −3.2058692E−05 | 1.5629748E−05 |
| A7 | 3.4621214E−07 | 2.9173902E−07 | 8.3751410E−06 | −5.3243854E−06 |
| A8 | 5.5283083E−08 | 3.4697351E−07 | −1.2678113E−06 | 1.1408571E−06 |
| A9 | −1.3671575E−08 | −6.1718338E−08 | 1.2119449E−07 | −1.6312490E−07 |
| A10 | 5.5025056E−10 | 3.5406366E−09 | −1.0426293E−08 | 1.5795829E−08 |
| A11 | 5.4236158E−11 | −2.2593309E−10 | 1.0201400E−09 | −8.8779651E−10 |
| A12 | −2.4863335E−12 | 5.0105064E−11 | −3.8299068E−11 | −6.4446459E−13 |
| A13 | −3.5056292E−13 | −1.8231396E−12 | −5.7518236E−12 | 3.4396821E−12 |
| A14 | 1.8728682E−14 | −3.8631335E−13 | 4.3418240E−13 | −2.7325407E−14 |
| A15 | 9.2195419E−16 | 1.1833760E−14 | 2.7758793E−14 | −1.8896338E−14 |
| A16 | −5.9161460E−17 | 2.1336564E−15 | −2.5182177E−15 | 5.6797767E−16 |
| A17 | −9.8784910E−19 | −3.1458188E−17 | −5.3036110E−17 | 3.9484583E−17 |
| A18 | 7.2396669E−20 | −5.2584358E−18 | 5.4442735E−18 | −1.6048699E−18 |

| Sn | 21 | 22 |
|---|---|---|
| KA | 1.2816686E+03 | 1.3106208E+00 |
| A3 | −2.3653039E−07 | 4.5801959E−07 |
| A4 | 4.3369849E−05 | 2.5424323E−05 |
| A5 | −9.9007697E−05 | −4.2089292E−06 |
| A6 | 5.5791493E−05 | 6.2486953E−07 |
| A7 | −1.7146866E−05 | 2.3452605E−07 |
| A8 | 3.0523525E−06 | −1.3573518E−07 |
| A9 | −3.2671396E−07 | 1.6407613E−08 |
| A10 | 2.0923270E−08 | 3.6488674E−10 |
| A11 | −8.2160730E−10 | −1.3450966E−10 |
| A12 | 2.1778108E−11 | −9.5386336E−12 |
| A13 | −5.2855955E−17 | 1.8742266E−12 |
| A14 | −3.9942145E−14 | 1.4549346E−14 |
| A15 | 1.0775053E−16 | −9.0910836E−15 |
| A16 | 7.2894605E−17 | 1.0321658E−16 |
| A17 | 0.0000000E+00 | 1.7147443E−17 |
| A18 | 0.0000000E+00 | −3.8255920E−19 |

### Example 23

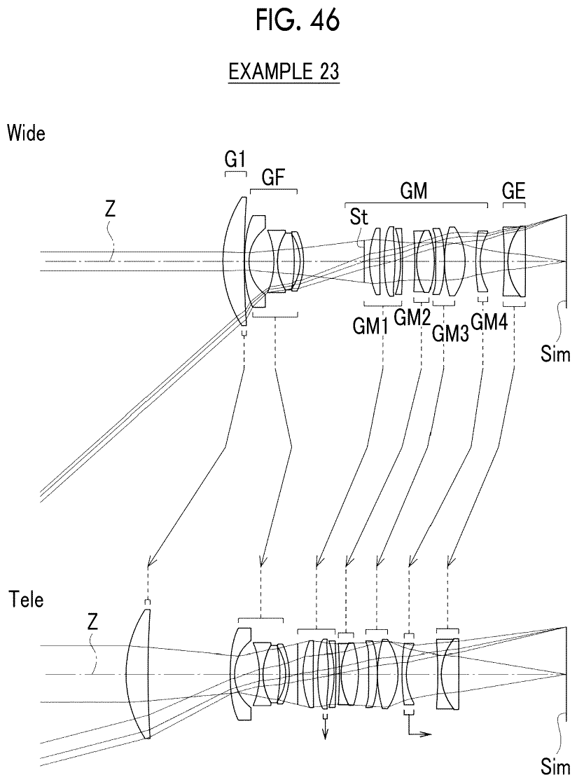

A configuration and a movement trajectory of a variable magnification optical system according to Example 23 are shown in FIG. 46. The variable magnification optical system according to Example 23 consists of, in order from the object side to the image side, a first lens group G1 having a positive refractive power, a front group GF, an intermediate group GM, and a final lens group GE having a negative refractive power. The front group GF consists of one lens group having a negative refractive power. The intermediate group GM consists of, in order from the object side to the image side, four lens groups including a first intermediate lens group GM1 having a positive refractive power, a second intermediate lens group GM2 having a negative refractive power, a third intermediate lens group GM3 having a positive refractive power, and a fourth intermediate lens group GM4 having a negative refractive power.

During changing magnification from the wide angle end to the telephoto end, all lens groups move along the optical axis Z by changing the spacings between the adjacent lens groups. In addition, the first intermediate lens group GM1, the third intermediate lens group GM3, and the final lens group GE move on the same trajectory during changing magnification from the wide angle end to the telephoto end. The focusing group consists of the fourth intermediate lens group GM4. During focusing from the infinite distance object to the nearest object, the focusing group moves to the image side. The anti-vibration group consists of a second lens from the object side in the first intermediate lens group GM1.

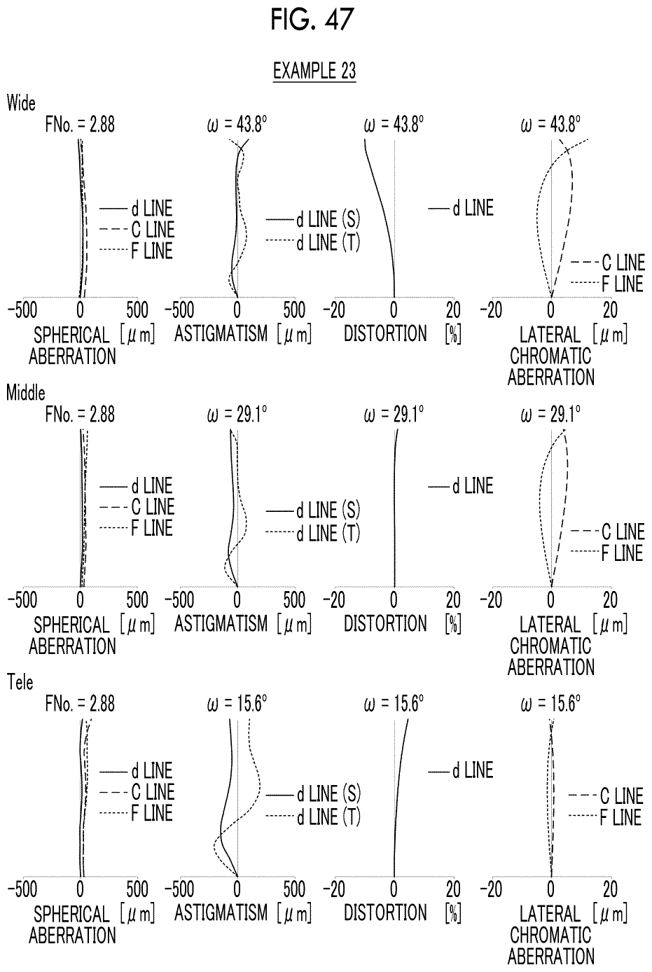

For the variable magnification optical system according to Example 23, basic lens data is shown in Table 67, specifications and variable surface spacings are shown in Table 68, aspherical coefficients are shown in Table 69, and each aberration diagram is shown in FIG. 47.

TABLE 67
Example 23

| Sn | R | D | Nd | νd | Material | ED |
|---|---|---|---|---|---|---|
| 1 | 38.0192 | 6.0503 | 1.49700 | 81.54 | S-FPL51.OHARA | 39.00 |
| 2 | 307.8547 | DD[2] | | | | 38.21 |
| *3 | 91.7475 | 1.2422 | 1.85135 | 40.10 | M-TAFD305.HOYA | 27.77 |
| *4 | 14.7819 | 7.0240 | | | | 20.20 |
| 5 | −26.0128 | 1.0068 | 1.77250 | 49.60 | S-LAH66.OHARA | 18.95 |
| 6 | 17.7289 | 4.7538 | 2.00266 | 31.67 | N200.GLASS | 17.25 |
| 7 | −47.8843 | 1.6526 | | | | 16.50 |
| 8 | −15.7317 | 1.0000 | 1.88300 | 39.22 | H-ZLAF68N.CDGM | 16.40 |
| 9 | −22.7542 | DD[9] | | | | 17.23 |
| 10(St) | ∞ | 1.5217 | | | | 18.33 |
| 11 | 28.6059 | 2.8705 | 2.00266 | 31.67 | N200.GLASS | 20.15 |
| 12 | 457.7086 | 1.2814 | | | | 20.00 |
| *13 | 59.2214 | 3.0390 | 1.53409 | 55.87 | plastic | 21.03 |
| *14 | −53.2298 | 1.6022 | | | | 20.33 |
| 15 | −34.8380 | 0.5000 | 2.00266 | 31.67 | N200.GLASS | 18.32 |
| 16 | −211.0278 | DD[16] | | | | 18.35 |
| 17 | −137.3349 | 0.5000 | 1.84666 | 23.78 | S-TIH53W.OHARA | 18.31 |
| 18 | 21.1686 | 4.8649 | 1.49700 | 81.54 | S-FPL51.OHARA | 18.43 |
| 19 | −33.3991 | DD[19] | | | | 18.83 |
| *20 | 392.0984 | 2.4370 | 1.53409 | 55.87 | plastic | 19.33 |
| *21 | −49.0334 | 0.0498 | | | | 20.03 |
| 22 | 38.8043 | 5.8065 | 1.49700 | 81.54 | S-FPL51.OHARA | 20.60 |
| 23 | −19.8486 | DD[23] | | | | 20.87 |
| 24 | 65.8366 | 1.2502 | 1.72916 | 54.68 | S-LAL18.OHARA | 18.44 |
| 25 | 19.0376 | DD[25] | | | | 17.40 |
| 26 | −131.8859 | 1.0068 | 1.80100 | 34.97 | S-LAM66.OHARA | 19.24 |
| 27 | 17.4494 | 4.9778 | 1.80809 | 22.76 | S-NPH1W.OHARA | 20.93 |
| 28 | −630.2377 | DD[28] | | | | 21.40 |

TABLE 68
Example 23

| | Wide | Middle | Tele |
|---|---|---|---|
| Zr | 1.0 | 1.5 | 3.0 |
| f | 16.46 | 25.28 | 48.73 |
| Bf | 11.55 | 16.00 | 30.36 |
| FNo. | 2.88 | 2.88 | 2.88 |
| 2ω[°] | 87.6 | 58.2 | 31.2 |
| DD[2] | 0.099 | 10.062 | 23.249 |
| DD[9] | 17.110 | 8.000 | 2.381 |
| DD[16] | 3.506 | 2.476 | 0.984 |
| DD[19] | 0.398 | 1.428 | 2.920 |
| DD[23] | 3.031 | 4.123 | 1.112 |
| DD[25] | 6.815 | 5.723 | 8.734 |
| DD[28] | 11.554 | 15.995 | 30.361 |

TABLE 69
Example 23

| Sn | 3 | 4 | 13 | 14 |
|---|---|---|---|---|
| KA | −2.1738761E+01 | −1.7259772E−01 | 5.6990570E−01 | 9.1163682E−01 |
| A3 | 2.1795412E−17 | 8.4078033E−19 | −4.4121697E−17 | −5.4959831E−17 |
| A4 | 1.4646033E−04 | 1.4931217E−04 | −3.3144729E−05 | 8.1979454E−05 |
| A5 | −2.6016018E−06 | 2.8031201E−05 | 5.9209730E−05 | −3.8670788E−05 |
| A6 | −3.5586805E−06 | −9.4038231E−06 | −3.1343725E−05 | 1.5730778E−05 |
| A7 | 1.8209759E−07 | −2.2021188E−07 | 8.6570488E−06 | −4.6020221E−06 |
| A8 | 7.9664658E−08 | 3.9187225E−07 | −1.3102633E−06 | 1.0843372E−06 |
| A9 | −1.2153464E−08 | −5.1400810E−08 | 1.1507631E−07 | −1.8488472E−07 |
| A10 | 3.3204037E−10 | 2.1758750E−09 | −9.3278627E−09 | 1.8166008E−08 |
| A11 | 4.5580730E−11 | −3.3870148E−10 | 1.0965369E−09 | −5.3297304E−10 |
| A12 | −1.3117105E−12 | 7.2514839E−11 | −5.3291951E−11 | −4.5068890E−11 |
| A13 | −3.2032688E−13 | −1.2102419E−12 | −6.3066862E−12 | 2.4153894E−13 |
| A14 | 1.4995922E−14 | −5.8466893E−13 | 5.4613676E−13 | 4.0384702E−13 |
| A15 | 8.6289439E−16 | 1.0659527E−14 | 2.9945419E−14 | −3.9092856E−15 |
| A16 | −5.2866312E−17 | 3.0404253E−15 | −2.9517059E−15 | −1.5458898E−15 |
| A17 | −9.3827346E−19 | −3.2265447E−17 | −5.6670674E−17 | 1.0981894E−17 |
| A18 | 6.8323076E−20 | −6.9608917E−18 | 6.1276109E−18 | 2.5392265E−18 |

| Sn | 20 | 21 |
|---|---|---|
| KA | 1.2860115E+03 | 1.6361974E+00 |
| A3 | 2.3725252E−16 | 6.0128793E−18 |
| A4 | 3.1410393E−05 | −2.2335560E−06 |
| A5 | −1.0738263E−04 | −1.5231808E−06 |
| A6 | 5.6822612E−05 | 3.6312771E−07 |
| A7 | −1.6960430E−05 | 1.4516419E−07 |
| A8 | 3.0142827E−06 | −1.1286907E−07 |
| A9 | −3.2902296E−07 | 1.7314945E−08 |
| A10 | 2.1590794E−08 | −1.7397094E−10 |
| A11 | −8.0591630E−10 | −1.3067070E−10 |
| A12 | 1.5737348E−11 | −2.6676950E−12 |
| A13 | −5.4388350E−14 | 1.7404646E−12 |
| A14 | −1.2501828E−14 | −3.4449968E−14 |
| A15 | 1.8195291E−16 | −8.2058239E−15 |
| A16 | 2.3320837E−17 | 2.8499525E−16 |
| A17 | 0.0000000E+00 | 1.5217587E−17 |
| A18 | 0.0000000E+00 | −6.5408415E−19 |

### Example 24

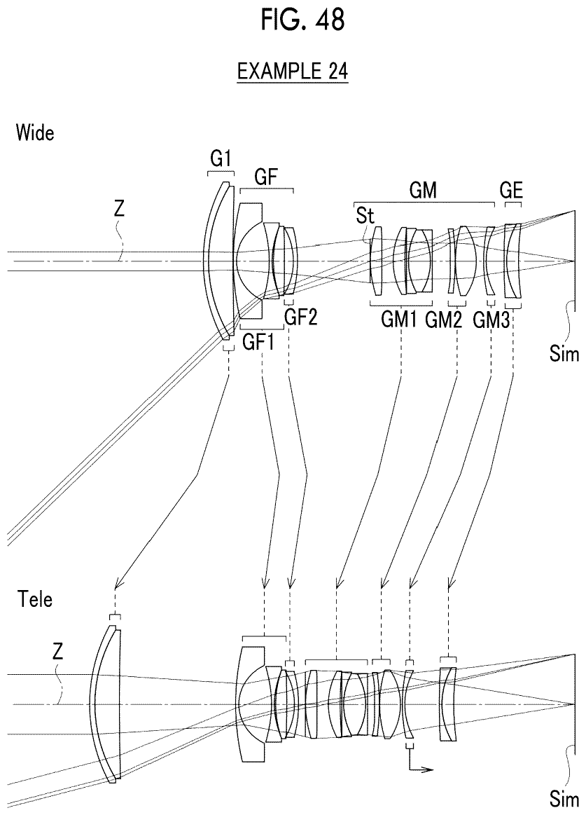

A configuration and a movement trajectory of a variable magnification optical system according to Example 24 are shown in FIG. 48. The variable magnification optical system according to Example 24 consists of, in order from the object side to the image side, a first lens group G1 having a positive refractive power, a front group GF, an intermediate group GM, and a final lens group GE having a negative refractive power. The front group GF consists of two lens groups including the first front side lens group GF1 having a negative refractive power and the second front side lens group GF2 having a negative refractive power. The intermediate group GM consists of, in order from the object side to the image side, three lens groups including a first intermediate lens group GM1 having a positive refractive power, a second intermediate lens group GM2 having a positive refractive power, and a third intermediate lens group GM3 having a negative refractive power.

During changing magnification from the wide angle end to the telephoto end, all lens groups move along the optical axis Z by changing the spacings between the adjacent lens groups. In addition, the first intermediate lens group GM1 and the final lens group GE move on the same trajectory during changing magnification from the wide angle end to the telephoto end. A focusing group consists of the third intermediate lens group GM3. During focusing from the infinite distance object to the nearest object, the focusing group moves to the image side.

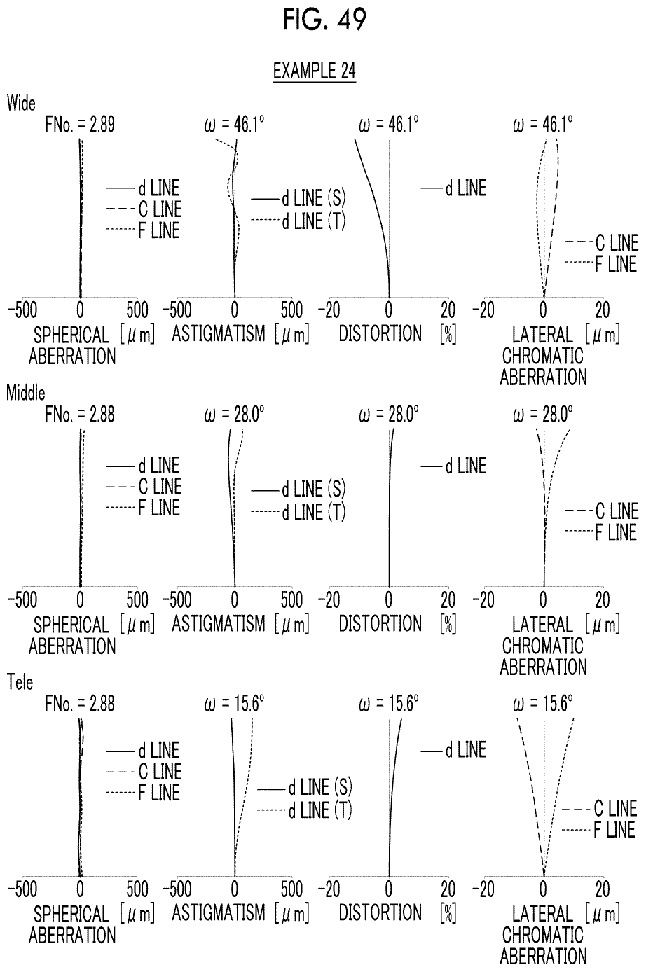

For the variable magnification optical system according to Example 24, basic lens data is shown in Table 70, specifications and variable surface spacings are shown in Table 71, aspherical coefficients are shown in Table 72, and each aberration diagram is shown in FIG. 49.

TABLE 70
Example 24

| Sn | R | D | Nd | νd | Material | ED |
|---|---|---|---|---|---|---|
| 1 | 49.8998 | 1.3670 | 1.80809 | 22.76 | S-NPH1W.OHARA | 44.44 |
| 2 | 43.2435 | 6.4212 | 1.48749 | 70.24 | S-FSL5.OHARA | 42.00 |
| 3 | 731.5661 | DD[3] | | | | 41.31 |
| 4 | 75.0536 | 0.8377 | 1.58913 | 61.13 | S-BAL35.OHARA | 32.49 |
| 5 | 12.3937 | 8.5816 | | | | 21.89 |
| *6 | −29.9417 | 0.7301 | 1.51633 | 64.06 | L-BSL7.OHARA | 21.33 |
| *7 | 25.3318 | 0.3598 | | | | 19.39 |
| 8 | 31.1771 | 2.8937 | 2.00330 | 28.27 | S-LAH79.OHARA | 19.37 |
| 9 | −259.2447 | DD[9] | | | | 18.77 |
| 10 | −19.4375 | 1.0754 | 1.48749 | 70.24 | S-FSL5.OHARA | 18.61 |
| 11 | −37.5284 | DD[11] | | | | 18.00 |
| 12(St) | ∞ | 0.0498 | | | | 18.27 |
| *13 | 30.5192 | 2.9922 | 1.85135 | 40.10 | M-TAFD305.HOYA | 19.07 |
| *14 | 1683.9141 | 2.9877 | | | | 19.16 |
| 15 | 20.6458 | 3.0826 | 1.60300 | 65.44 | S-PHM53.OHARA | 18.77 |
| 16 | 107.7267 | 0.4235 | | | | 18.27 |
| 17 | 7256.1178 | 0.4987 | 1.72047 | 34.71 | S-NBH8.OHARA | 18.25 |
| 18 | 19.6234 | 5.7619 | 1.43875 | 94.66 | S-FPL55.OHARA | 17.42 |
| 19 | −18.0821 | 0.4989 | 1.85025 | 30.05 | S-NBH57.OHARA | 17.13 |
| 20 | −2199.4275 | DD[20] | | | | 17.42 |
| *21 | 305.5455 | 1.2709 | 1.53409 | 55.87 | plastic | 17.66 |
| *22 | −73.2097 | 0.0912 | | | | 18.01 |
| 23 | 34.9198 | 5.4404 | 1.58913 | 61.13 | S-BAL35.OHARA | 18.80 |
| 24 | −18.6618 | DD[24] | | | | 19.38 |
| 25 | 48.1542 | 0.6569 | 1.90525 | 35.04 | S-LAH93.OHARA | 19.03 |
| 26 | 20.6557 | DD[26] | | | | 18.61 |
| 27 | 190.2364 | 0.6954 | 1.80100 | 34.97 | S-LAM66.OHARA | 19.91 |
| 28 | 22.1172 | 3.0994 | 1.92286 | 18.90 | S-NPH2.OHARA | 20.59 |
| 29 | 80.5214 | DD[29] | | | | 20.76 |

TABLE 71
Example 24

| | Wide | Middle | Tele |
|---|---|---|---|
| Zr | 1.0 | 1.7 | 3.2 |
| f | 15.47 | 26.35 | 48.74 |
| Bf | 14.81 | 20.95 | 31.79 |
| FNo. | 2.89 | 2.88 | 2.88 |
| 2ω[°] | 92.2 | 56.0 | 31.2 |
| DD[3] | 0.093 | 12.897 | 30.344 |
| DD[9] | 2.330 | 2.566 | 2.013 |
| DD[11] | 19.056 | 8.118 | 1.799 |
| DD[20] | 4.575 | 2.887 | 1.820 |
| DD[24] | 1.945 | 1.707 | 0.492 |
| DD[26] | 4.692 | 6.618 | 8.900 |
| DD[29] | 14.808 | 20.948 | 31.788 |

TABLE 72
Example 24

| Sn | 6 | 7 |
|---|---|---|
| KA | −1.3662052E+00 | −1.8022893E+00 |
| A3 | −5.2302145E−06 | −4.1970296E−06 |
| A4 | 2.1216929E−04 | 1.8785371E−04 |
| A5 | −2.6079029E−05 | −1.3300045E−05 |
| A6 | −3.1431599E−06 | −8.5949594E−06 |
| A7 | 2.8894917E−07 | 1.9715915E−06 |
| A8 | 2.0022296E−07 | −1.5544319E−07 |
| A9 | −4.6078927E−08 | 7.3513826E−10 |
| A10 | 4.2654866E−09 | 6.9008867E−10 |
| A11 | −1.8984898E−10 | −4.9748084E−11 |
| A12 | 3.3840498E−12 | 1.3405553E−12 |
| Sn | 13 | 14 |
| KA | 1.0000000E+00 | 1.0000000E+00 |
| A4 | −2.0900591E−06 | −5.5377617E−06 |
| A6 | −8.7301031E−08 | −8.6483121E−08 |
| A8 | −1.9596390E−10 | −8.0647401E−10 |
| A10 | −6.0009067E−12 | −1.5664243E−12 |
| Sn | 21 | 22 |
| KA | 1.0000000E+00 | 1.0000000E+00 |
| A4 | −1.0984296E−04 | 1.8226790E−06 |
| A6 | −3.7119066E−07 | −4.5033723E−07 |
| A8 | −4.6855907E−09 | 3.0263611E−09 |
| A10 | 4.8541188E−11 | −1.6687900E−11 |
| A12 | 1.0075638E−12 | 9.5212862E−13 |
| A14 | 2.6965984E−14 | 2.3026388E−14 |
| A16 | −5.5633761E−16 | −4.5715409E−16 |
| A18 | 2.4288796E−18 | 1.9468641E−18 |

Tables 73 to 76 show corresponding values of Conditional Expressions (1) to (5), (7) to (18), and (21) to (25) of the variable magnification optical systems of Examples 1 to 24. In addition, Table 77 shows corresponding values of Conditional Expressions (19) and (20) of “N200.GLASS” and “N216.GLASS” used in Examples. Preferred ranges of the conditional expressions may be set by using the corresponding values shown in Tables 73 to 77 as the upper limits or the lower limits of the conditional expressions.

TABLE 73

| Expression | | | | | | | |
|---|---|---|---|---|---|---|---|
| No. | | Example 1 | Example 2 | Example 3 | Example 4 | Example 5 | Example 6 |
| (1) | (−fF)/f1 | 0.1699 | 0.1666 | 0.1582 | 0.1680 | 0.1435 | 0.1950 |
| (2) | fM1/f1 | 0.2006 | 0.2011 | 0.2033 | 0.2255 | 0.3296 | 0.2491 |
| (3) | fw/f1 | 0.1626 | 0.1595 | 0.1646 | 0.1818 | 0.1295 | 0.2187 |
| (4) | fw/(−fF) | 0.9573 | 0.9573 | 1.0405 | 1.0821 | 0.9024 | 1.1219 |
| (5) | fw/(−fMn) | 0.4551 | 0.4223 | 0.3742 | 0.3688 | 0.3748 | 0.4819 |
| (7) | (−fF)/(−fMn) | 0.4754 | 0.4411 | 0.3596 | 0.3408 | 0.4153 | 0.4295 |
| (8) | ft/fw | 2.7994 | 2.8007 | 2.7998 | 2.7994 | 3.1507 | 2.6995 |
| (9) | (−fF)/fM1 | 0.8470 | 0.8287 | 0.7781 | 0.7453 | 0.4353 | 0.7826 |
| (10) | fw/fE | 0.0240 | 0.0249 | −0.1038 | −0.0837 | −0.0149 | −0.2585 |
| (11) | fM1/fM2p | — | — | — | — | — | — |
| (12) | fM2p/fM3p | — | — | — | — | — | — |
| (13) | fM2p/(−fM3n) | — | — | — | — | — | — |
| (14) | fM1/(−fM2n) | 0.5612 | 0.5322 | 0.4622 | 0.4572 | 0.9539 | 0.5489 |
| (15) | (−fM2n)/fM3p | — | — | — | — | — | — |
| (16) | (−fM2n)/(−fM3n) | — | — | — | — | — | — |
| (17) | \|fIS/ft\| | — | — | — | — | — | 0.7817 |
| (18) | (−fMn)/f1 | 0.3574 | 0.3778 | 0.4398 | 0.4931 | 0.3455 | 0.4539 |
| (21) | νdfoc | 31.67 | 31.67 | 31.67 | 31.67 | 35.04 | 52.32 |
| (22) | ωw | 44.3 | 44.3 | 44.3 | 44.3 | 46.2 | 40.9 |
| (23) | \|ffocmax/fw\| | 2.1974 | 2.3682 | 2.6726 | 2.7118 | 2.6684 | 2.0750 |
| (24) | NdM + 0.01 × νdM | 2.09279 | 2.09279 | 2.09279 | 2.09279 | 2.09279 | — |
| (25) | νdM | 55.87 | 55.87 | 55.87 | 55.87 | 55.87 | — |

TABLE 74

| Expression | | | | | | | |
|---|---|---|---|---|---|---|---|
| No. | | Example 7 | Example 8 | Example 9 | Example 10 | Example 11 | Example 12 |
| (1) | (−fF)/f1 | 0.1524 | 0.1498 | 0.1443 | 0.1457 | 0.1560 | 0.1519 |
| (2) | fM1/f1 | 0.3945 | 0.3482 | 0.3336 | 0.3665 | 0.3991 | 0.3289 |
| (3) | fw/f1 | 0.1510 | 0.1397 | 0.1329 | 0.1375 | 0.1488 | 0.1332 |
| (4) | fw/(−fF) | 0.9904 | 0.9327 | 0.9212 | 0.9440 | 0.9536 | 0.8771 |
| (5) | fw/(−fMn) | 0.3412 | 0.3666 | 0.3953 | 0.3866 | 0.3472 | 0.4246 |
| (7) | (−fF)/(−fMn) | 0.3445 | 0.3931 | 0.4291 | 0.4095 | 0.3641 | 0.4841 |
| (8) | ft/fw | 3.0000 | 3.1506 | 3.1498 | 3.1494 | 2.9994 | 3.1491 |
| (9) | (−fF)/fM1 | 0.3864 | 0.4303 | 0.4326 | 0.3974 | 0.3909 | 0.4618 |
| (10) | fw/fE | 0.0239 | 0.0091 | 0.0436 | 0.0654 | −0.0339 | −0.0672 |
| (11) | fM1/fM2p | 2.2736 | 2.0429 | 2.0505 | 2.2514 | 2.4019 | 2.0724 |
| (12) | fM2p/fM3p | — | — | — | — | — | — |
| (13) | fM2p/(−fM3n) | 0.3922 | 0.4472 | 0.4838 | 0.4577 | 0.3877 | 0.5058 |
| (14) | fM1/(−fM2n) | — | — | — | — | — | — |
| (15) | (−fM2n)/fM3p | — | — | — | — | — | — |
| (16) | (−fM2n)/(−fM3n) | — | — | — | — | — | — |
| (17) | \|fIS/ft\| | — | — | — | — | — | — |
| (18) | (−fMn)/f1 | 0.4424 | 0.3812 | 0.3362 | 0.3557 | 0.4286 | 0.3138 |
| (21) | νdfoc | 35.04 | 35.04 | 35.04 | 35.04 | 35.04 | 35.04 |
| (22) | ωw | 45.5 | 46.3 | 46.1 | 46.4 | 44.9 | 46.5 |
| (23) | \|ffocmax/fw\| | 2.9308 | 2.7275 | 2.5297 | 2.5867 | 2.8805 | 2.3552 |
| (24) | NdM + 0.01 × νdM | 2.09279 | 2.09279 | 2.09279 | 2.09279 | 2.09279 | 2.09279 |
| (25) | νdM | 55.87 | 55.87 | 55.87 | 55.87 | 55.87 | 55.87 |

TABLE 75

| Expression | | | | | | | |
|---|---|---|---|---|---|---|---|
| No. | | Example 13 | Example 14 | Example 15 | Example 16 | Example 17 | Example 18 |
| (1) | (−fF)/f1 | 0.1422 | 0.1824 | 0.1862 | 0.1734 | 0.1732 | 0.1829 |
| (2) | fM1/f1 | 0.3161 | 0.2280 | 0.2345 | 0.4386 | 0.4491 | 0.4175 |
| (3) | fw/f1 | 0.1268 | 0.1951 | 0.1965 | 0.1763 | 0.1793 | 0.1799 |
| (4) | fw/(−fF) | 0.8918 | 1.0695 | 1.0552 | 1.0166 | 1.0352 | 0.9836 |
| (5) | fw/(−fMn) | 0.3756 | 0.3237 | 0.2671 | 0.4308 | 0.4209 | 0.4332 |
| (7) | (−fF)/(−fMn) | 0.4212 | 0.3026 | 0.2532 | 0.4238 | 0.4066 | 0.4404 |
| (8) | ft/fw | 3.1505 | 2.9507 | 2.9505 | 2.9589 | 2.9607 | 2.9197 |
| (9) | (−fF)/fM1 | 0.4497 | 0.7999 | 0.7943 | 0.3955 | 0.3856 | 0.4380 |
| (10) | fw/fE | −0.0573 | 0.1546 | 0.1369 | 0.0122 | 0.0130 | −0.0345 |
| (11) | fM1/fM2p | 2.0863 | — | — | 0.2338 | 0.2498 | 0.1511 |
| (12) | fM2p/fM3p | — | — | — | 7.0718 | 6.9007 | 10.6848 |
| (13) | fM2p/(−fM3n) | 0.4489 | — | — | — | — | — |
| (14) | fM1/(−fM2n) | — | 0.2958 | 0.3647 | — | — | — |
| (15) | (−fM2n)/fM3p | — | — | — | — | — | — |
| (16) | (−fM2n)/(−fM3n) | — | 1.2789 | 0.8739 | — | — | — |
| (17) | \|fIS/ft\| | — | 0.4411 | 0.4530 | 1.2079 | 1.1228 | 1.2002 |
| (18) | (−fMn)/f1 | 0.3375 | 0.6028 | 0.7357 | 0.4093 | 0.4259 | 0.4152 |
| (21) | νdfoc | 35.04 | 60.08 | 60.08 | 54.68 | 54.68 | 54.68 |
| (22) | ωw | 46.2 | 42.2 | 42.1 | 45.2 | 43.2 | 44.1 |
| (23) | \|ffocmax/fw\| | 2.6622 | 3.0897 | 3.7434 | 2.3211 | 2.3758 | 2.3085 |
| (24) | NdM + 0.01 × νdM | 2.09279 | 2.10466 | 2.10466 | 2.09279 | 2.09279 | 2.09279 |
| (25) | νdM | 55.87 | 56.03 | 56.03 | 55.87 | 55.87 | 55.87 |

TABLE 76

| Expression | | | | | | | |
|---|---|---|---|---|---|---|---|
| No. | | Example 19 | Example 20 | Example 21 | Example 22 | Example 23 | Example 24 |
| (1) | (−fF)/f1 | 0.1722 | 0.1807 | 0.1768 | 0.1727 | 0.1850 | 0.1426 |
| (2) | fM1/f1 | 0.4321 | 0.3914 | 0.3896 | 0.3981 | 0.3669 | 0.3292 |
| (3) | fw/f1 | 0.1724 | 0.2011 | 0.1982 | 0.1880 | 0.1900 | 0.1275 |
| (4) | fw/(−fF) | 1.0012 | 1.1130 | 1.1209 | 1.0885 | 1.0270 | 0.8936 |
| (5) | fw/(−fMn) | 0.4124 | 0.4210 | 0.4108 | 0.3425 | 0.4431 | 0.3828 |
| (7) | (−fF)/(−fMn) | 0.4119 | 0.3782 | 0.3665 | 0.3146 | 0.4314 | 0.4284 |
| (8) | ft/fw | 2.9598 | 2.9600 | 2.9600 | 2.9596 | 2.9605 | 3.1506 |
| (9) | (−fF)/fM1 | 0.3985 | 0.4616 | 0.4540 | 0.4339 | 0.5043 | 0.4333 |
| (10) | fw/fE | −0.0123 | 0.0198 | 0.0198 | 0.0348 | −0.0717 | −0.0240 |
| (11) | fM1/fM2p | 0.2334 | — | — | — | — | 2.1804 |
| (12) | fM2p/fM3p | 7.1306 | — | — | — | — | — |
| (13) | fM2p/(−fM3n) | — | — | — | — | — | — |
| (14) | fM1/(−fM2n) | — | 0.2348 | 0.2936 | 0.2989 | 0.2132 | 0.9887 |
| (15) | (−fM2n)/fM3p | — | 6.2318 | 5.1761 | 5.4986 | 7.0886 | — |
| (16) | (−fM2n)/(−fM3n) | — | — | — | — | — | — |
| (17) | \|fIS/ft\| | 1.2177 | 1.0914 | 1.1144 | 1.0824 | 1.0873 | — |
| (18) | (−fMn)/f1 | 0.4180 | 0.4777 | 0.4825 | 0.5489 | 0.4288 | 0.3330 |
| (21) | νdfoc | 54.68 | 54.68 | 54.68 | 54.68 | 54.68 | 35.04 |
| (22) | ωw | 45.5 | 43.8 | 44.2 | 44.1 | 43.8 | 46.1 |
| (23) | \|ffocmax/fw\| | 2.4247 | 2.3754 | 2.4340 | 2.9198 | 2.2569 | 2.6126 |
| (24) | NdM + 0.01 × νdM | 2.09279 | 2.09279 | 2.09279 | 2.09279 | 2.09279 | — |
| (25) | νdM | 55.87 | 55.87 | 55.87 | 55.87 | 55.87 | — |

TABLE 77

| Expression | | | |
|---|---|---|---|
| No. | | N200.GLASS | N216.GLASS |
| (19) | Nd + 0.01425 × νd | 2.454 | 2.465 |
| (20) | νd | 31.67 | 21.24 |

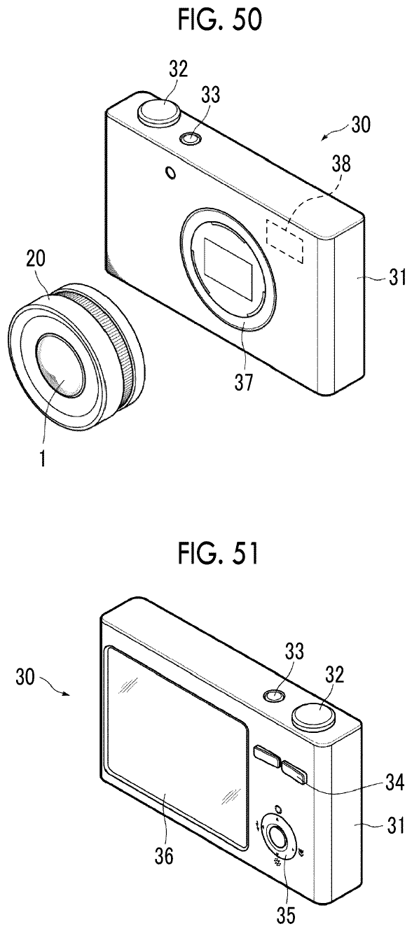

Next, an imaging apparatus according to the embodiment of the present disclosure will be described. FIGS. 50 and 51 are external views of a camera 30 that is the imaging apparatus according to one embodiment of the present disclosure. FIG. 50 shows a perspective view of the camera 30 viewed from the front surface side, and FIG. 51 shows a perspective view of the camera 30 viewed from the rear surface side. The camera 30 is a so-called mirrorless type digital camera in which an interchangeable lens 20 can be attachably and detachably mounted. The interchangeable lens 20 includes a variable magnification optical system 1 according to one embodiment of the present disclosure accommodated in a lens barrel.

The camera 30 comprises a camera body 31. A shutter button 32 and a power button 33 are provided on an upper surface of the camera body 31. Further, an operation unit 34, an operation unit 35, and a display unit 36 are provided on a rear surface of the camera body 31. The display unit 36 is able to display a captured image and an image within an angle of view before imaging.

An imaging aperture on which light from an imaging target is incident is provided at a center portion of a front surface of the camera body 31. A mount 37 is provided at a position corresponding to the imaging aperture, and the interchangeable lens 20 is mounted on the camera body 31 via the mount 37.

An imaging element 38 is provided inside the camera body 31. The imaging element 38 outputs an imaging signal corresponding to the subject image formed by the interchangeable lens 20. As the imaging element 38, for example, a charge-coupled device (CCD) or a complementary-metal-oxide semiconductor (CMOS) is used. A signal processing circuit (not shown), a recording medium (not shown), and the like are provided in the camera body 31. The signal processing circuit generates the image by processing the imaging signal output from the imaging element 38. The recording medium is used for recording the generated image. In the camera 30, a still image or a moving image can be captured by pressing the shutter button 32, and the image data obtained through imaging is recorded on the recording medium.

The technique of the present disclosure has been described above using the embodiment and examples. However, the technique of the present disclosure is not limited to the embodiment and examples described above, and may be modified in various ways. For example, the curvature radius, the surface spacing, the refractive index, the Abbe number, the aspherical coefficient, and the like of each lens are not limited to the values shown in each example, and may take other values.

In addition, the imaging apparatus according to the embodiment of the present disclosure is not limited to the above-described example and may take various forms such as a camera other than a mirrorless type, a film camera, a video camera, and a security camera.

The following supplementary notes are further disclosed with respect to the embodiment and the examples described above.

### Supplementary Note 1

A variable magnification optical system consisting of, in order from a position closest to an object side to an image side, a first lens group having a positive refractive power, a front group consisting of two or fewer lens groups having a negative refractive power, an intermediate group including a plurality of lens groups, and a final lens group,
in which a lens group closest to the object side in the intermediate group is a first intermediate lens group having a positive refractive power,
the intermediate group includes an aperture stop,
during changing magnification, all spacings between adjacent lens groups change, and
in a case where
   a focal length of the front group in a state where an infinite distance object is in focus at a wide angle end is denoted by fF, and
   a focal length of the first lens group is denoted by f1,

Conditional Expression (1) is satisfied, which is represented by 0.04<(−fF)/f1<0.4 (1).

### Supplementary Note 2

The variable magnification optical system according to Supplementary Note 1,
in which in a case where a focal length of the first intermediate lens group is denoted by fM1,

Conditional Expression (2) is satisfied, which is represented by 0.1<fM1/f1<0.8 (2).

### Supplementary Note 3

The variable magnification optical system according to Supplementary Note 1 or 2,
in which in a case where a focal length of the variable magnification optical system in a state where the infinite distance object is in focus at the wide angle end is denoted by fw,

Conditional Expression (3) is satisfied, which is represented by 0.05<fw/f1<0.5 (3).

### Supplementary Note 4

The variable magnification optical system according to any one of Supplementary Notes 1 to 3,
in which in a case where a focal length of the variable magnification optical system in a state where the infinite distance object is in focus at the wide angle end is denoted by fw,

Conditional Expression (4) is satisfied, which is represented by 0.4<fw/(−fF)<2 (4).

### Supplementary Note 5

The variable magnification optical system according to any one of Supplementary Notes 1 to 4,
in which the intermediate group includes at least one lens group having a negative refractive power, and
in a case where
   a focal length of the variable magnification optical system in a state where the infinite distance object is in focus at the wide angle end is denoted by fw, and
   a focal length of a lens group closest to the image side among lens groups having a negative refractive power included in the intermediate group, is denoted by fMn,

Conditional Expression (5) is satisfied, which is represented by 0.05<fw/(−fMn)<1.5 (5).

### Supplementary Note 6

The variable magnification optical system according to any one of Supplementary Notes 1 to 5,
in which the number of lenses included in the variable magnification optical system is 13 or more and 17 or less.

### Supplementary Note 7

The variable magnification optical system according to any one of Supplementary Notes 1 to 6,
in which in a case where a refractive index of a positive lens of the first lens group at a d line is denoted by Nd1p,

Conditional Expression (6) is satisfied, which is represented by 1.4<Nd1p<1.62 (6),
by all positive lenses of the first lens group.

### Supplementary Note 8

The variable magnification optical system according to any one of Supplementary Notes 1 to 7,
in which the intermediate group includes at least one lens group having a negative refractive power, and
in a case where a focal length of a lens group closest to the image side among lens groups having a negative refractive power included in the intermediate group is denoted by fMn,

Conditional Expression (7) is satisfied, which is represented by 0.1<(−fF)/(−fMn)<2 (7).

### Supplementary Note 9

The variable magnification optical system according to any one of Supplementary Notes 1 to 8,
in which in a case where
   a focal length of the variable magnification optical system in a state where the infinite distance object is in focus at a telephoto end is denoted by ft, and
   a focal length of the variable magnification optical system in a state where the infinite distance object is in focus at the wide angle end is denoted by fw,

Conditional Expression (8) is satisfied, which is represented by 2<ft/fw<20 (8).

### Supplementary Note 10

The variable magnification optical system according to any one of Supplementary Notes 1 to 9,
in which in a case where a focal length of the first intermediate lens group is denoted by fM1,

Conditional Expression (9) is satisfied, which is represented by 0.05<(−fF)/fM1<2 (9).

### Supplementary Note 11

The variable magnification optical system according to any one of Supplementary Notes 1 to 10,
in which in a case where
   a focal length of the variable magnification optical system in a state where the infinite distance object is in focus at the wide angle end is denoted by fw, and
   a focal length of the final lens group is denoted by fE,

Conditional Expression (10) is satisfied, which is represented by −1.5<fw/fE<1.5 (10).

### Supplementary Note 12

The variable magnification optical system according to any one of Supplementary Notes 1 to 11,
in which at least one lens group included in the intermediate group and the final lens group move along the same trajectory along the optical axis during changing magnification from the wide angle end to a telephoto end, and
the lens groups moving along the same trajectory are not arranged adjacent to each other.

### Supplementary Note 13

The variable magnification optical system according to Supplementary Note 12,
in which two lens groups included in the intermediate group and the final lens group move along the same trajectory along the optical axis during changing magnification from the wide angle end to the telephoto end, and
the lens groups moving along the same trajectory are not arranged adjacent to each other.

### Supplementary Note 14

The variable magnification optical system according to any one of Supplementary Notes 1 to 13,
in which a second intermediate lens group having a positive refractive power is arranged adjacent to the image side of the first intermediate lens group in the intermediate group, and
in a case where
   a focal length of the first intermediate lens group is denoted by fM1, and
   a focal length of the second intermediate lens group is denoted by fM2p,

Conditional Expression (11) is satisfied, which is represented by 0.1<fM1/fM2p<4 (11).

### Supplementary Note 15

The variable magnification optical system according to Supplementary Note 14,
in which a third intermediate lens group having a positive refractive power is arranged adjacent to the image side of the second intermediate lens group in the intermediate group, and
in a case where
   a focal length of the second intermediate lens group is denoted by fM2p, and
   a focal length of the third intermediate lens group is denoted by fM3p,

Conditional Expression (12) is satisfied, which is represented by 1<fM2p/fM3p<15 (12).

### Supplementary Note 16

The variable magnification optical system according to Supplementary Note 14,
in which a third intermediate lens group having a negative refractive power is arranged adjacent to the image side of the second intermediate lens group in the intermediate group, and
in a case where
   the focal length of the second intermediate lens group is denoted by fM2p, and
   a focal length of the third intermediate lens group is denoted by fM3n,

Conditional Expression (13) is satisfied, which is represented by 0.1<fM2p/(−fM3n)<1 (13).

### Supplementary Note 17

The variable magnification optical system according to any one of Supplementary Notes 1 to 13,
in which a second intermediate lens group having a negative refractive power is arranged adjacent to the image side of the first intermediate lens group in the intermediate group, and
in a case where
   a focal length of the first intermediate lens group is denoted by fM1, and
   a focal length of the second intermediate lens group is denoted by fM2n,

Conditional Expression (14) is satisfied, which is represented by 0.1<fM1/(−fM2n)<2 (14).

### Supplementary Note 18

The variable magnification optical system according to Supplementary Note 17,
in which a third intermediate lens group having a positive refractive power is arranged adjacent to the image side of the second intermediate lens group in the intermediate group, and
in a case where
   the focal length of the second intermediate lens group is denoted by fM2n, and
   a focal length of the third intermediate lens group is denoted by fM3p,

Conditional Expression (15) is satisfied, which is represented by 1<(−fM2n)/fM3p<15 (15).

### Supplementary Note 19

The variable magnification optical system according to Supplementary Note 17,
in which a third intermediate lens group having a negative refractive power is arranged adjacent to the image side of the second intermediate lens group in the intermediate group, and
in a case where
   the focal length of the second intermediate lens group is denoted by fM2n, and
   a focal length of the third intermediate lens group is denoted by fM3n,

Conditional Expression (16) is satisfied, which is represented by 0.3<(−fM2n)/(−fM3n)<3 (16).

### Supplementary Note 20

An imaging apparatus comprising: the variable magnification optical system according to any one of Supplementary Notes 1 to 19.

What is claimed is:

1. A variable magnification optical system consisting of, in order from a position closest to an object side to an image side, a first lens group having a positive refractive power, a front group consisting of two or fewer lens groups having a negative refractive power, an intermediate group including a plurality of lens groups, and a final lens group,
wherein a lens group closest to the object side in the intermediate group is a first intermediate lens group having a positive refractive power,
the intermediate group includes an aperture stop,
during changing magnification, all spacings between adjacent lens groups change, and
in a case where
a focal length of the front group in a state where an infinite distance object is in focus at a wide angle end is denoted by fF, and
a focal length of the first lens group is denoted by f1,
Conditional Expression (1) is satisfied, which is represented by 0.04<(−fF)/f1<0.4 (1).

2. The variable magnification optical system according to claim 1,
wherein in a case where a focal length of the first intermediate lens group is denoted by fM1,
Conditional Expression (2) is satisfied, which is represented by 0.1<fM1/f1<0.8 (2).

3. The variable magnification optical system according to claim 1,
wherein in a case where a focal length of the variable magnification optical system in a state where the infinite distance object is in focus at the wide angle end is denoted by fw,
Conditional Expression (3) is satisfied, which is represented by 0.05<fw/f1<0.5 (3).

4. The variable magnification optical system according to claim 1,
wherein in a case where a focal length of the variable magnification optical system in a state where the infinite distance object is in focus at the wide angle end is denoted by fw,
Conditional Expression (4) is satisfied, which is represented by 0.4<fw/(−fF)<2 (4).

5. The variable magnification optical system according to claim 1,
wherein the intermediate group includes at least one lens group having a negative refractive power, and
in a case where
a focal length of the variable magnification optical system in a state where the infinite distance object is in focus at the wide angle end is denoted by fw, and
a focal length of a lens group closest to the image side among lens groups having a negative refractive power included in the intermediate group is denoted by fMn,
Conditional Expression (5) is satisfied, which is represented by 0.05<fw/(−fMn)<1.5 (5).

6. The variable magnification optical system according to claim 1,
wherein the number of lenses included in the variable magnification optical system is 13 or more and 17 or less.

7. The variable magnification optical system according to claim 1,
wherein in a case where a refractive index of a positive lens of the first lens group at a d line is denoted by Nd1p,
Conditional Expression (6) is satisfied, which is represented by 1.4<Nd1p<1.62 (6),
by all positive lenses of the first lens group.

8. The variable magnification optical system according to claim 1,
wherein the intermediate group includes at least one lens group having a negative refractive power, and
in a case where a focal length of a lens group closest to the image side among lens groups having a negative refractive power included in the intermediate group is denoted by fMn,
Conditional Expression (7) is satisfied, which is represented by 0.1<(−fF)/(−fMn)<2 (7).

9. The variable magnification optical system according to claim 1,
wherein in a case where
a focal length of the variable magnification optical system in a state where the infinite distance object is in focus at a telephoto end is denoted by ft, and
a focal length of the variable magnification optical system in a state where the infinite distance object is in focus at the wide angle end is denoted by fw,
Conditional Expression (8) is satisfied, which is represented by 2<ft/fw<20 (8).

10. The variable magnification optical system according to claim 1,
wherein in a case where a focal length of the first intermediate lens group is denoted by fM1,
Conditional Expression (9) is satisfied, which is represented by 0.05<(−fF)/fM1<2 (9).

11. The variable magnification optical system according to claim 1,
wherein in a case where
a focal length of the variable magnification optical system in a state where the infinite distance object is in focus at the wide angle end is denoted by fw, and
a focal length of the final lens group is denoted by fE,
Conditional Expression (10) is satisfied, which is represented by −1.5<fw/fE<1.5 (10).

12. The variable magnification optical system according to claim 1,
wherein at least one lens group included in the intermediate group and the final lens group move along the same trajectory along the optical axis during changing magnification from the wide angle end to a telephoto end, and
the lens groups moving along the same trajectory are not arranged adjacent to each other.

13. The variable magnification optical system according to claim 12,
wherein two lens groups included in the intermediate group and the final lens group move along the same trajectory along the optical axis during changing magnification from the wide angle end to the telephoto end, and
the lens groups moving along the same trajectory are not arranged adjacent to each other.

14. The variable magnification optical system according to claim 1,
wherein a second intermediate lens group having a positive refractive power is arranged adjacent to the image side of the first intermediate lens group in the intermediate group, and
in a case where
a focal length of the first intermediate lens group is denoted by fM1, and
a focal length of the second intermediate lens group is denoted by fM2p,
Conditional Expression (11) is satisfied, which is represented by 0.1<fM1/fM2p<4 (11).

15. The variable magnification optical system according to claim 14,
wherein a third intermediate lens group having a positive refractive power is arranged adjacent to the image side of the second intermediate lens group in the intermediate group, and
in a case where a focal length of the third intermediate lens group is denoted by fM3p,
Conditional Expression (12) is satisfied, which is represented by 1<fM2p/fM3p<15 (12).

16. The variable magnification optical system according to claim 14,
wherein a third intermediate lens group having a negative refractive power is arranged adjacent to the image side of the second intermediate lens group in the intermediate group, and
in a case where a focal length of the third intermediate lens group is denoted by fM3n,
Conditional Expression (13) is satisfied, which is represented by 0.1<fM2p/(−fM3n)<1 (13).

17. The variable magnification optical system according to claim 1,
wherein a second intermediate lens group having a negative refractive power is arranged adjacent to the image side of the first intermediate lens group in the intermediate group, and
in a case where
a focal length of the first intermediate lens group is denoted by fM1, and
a focal length of the second intermediate lens group is denoted by fM2n,
Conditional Expression (14) is satisfied, which is represented by 0.1<fM1/(−fM2n)<2 (14).

18. The variable magnification optical system according to claim 17,
wherein a third intermediate lens group having a positive refractive power is arranged adjacent to the image side of the second intermediate lens group in the intermediate group, and
in a case where a focal length of the third intermediate lens group is denoted by fM3p,
Conditional Expression (15) is satisfied, which is represented by 1<(−fM2n)/fM3p<15 (15).

19. The variable magnification optical system according to claim 17,
wherein a third intermediate lens group having a negative refractive power is arranged adjacent to the image side of the second intermediate lens group in the intermediate group, and
in a case where a focal length of the third intermediate lens group is denoted by fM3n,
Conditional Expression (16) is satisfied, which is represented by 0.3<(−fM2n)/(−fM3n)<3 (16).

20. An imaging apparatus comprising: the variable magnification optical system according to claim 1.
